(19) United States
(12) Patent Application Publication
(10) Pub. No.: US 2015/0342193 A1
(43) Pub. Date: Dec. 3, 2015

(54) Herbicidal Composition

(71) Applicant: BASF SE, Ludwigshafen (DE)

(72) Inventors: Anja SIMON, Weinheim (DE); Ruediger REINGRUBER, Ludwigshafen (DE); Ulrich STEINBRENNER, Neustadt (DE); Klaus KREUZ, Denzlingen (DE); Johannes HUTZLER, Waldsee (DE); Liliana PARRA RAPADO, Offenburg (DE); Thomas SEITZ, Viernheim (DE); Richard Roger EVANS, Limburgerhof (DE)

(73) Assignee: BASF SE, Ludwigshafen (DE)

(21) Appl. No.: 14/654,896

(22) PCT Filed: Dec. 13, 2013
(86) PCT No.: PCT/EP2013/076464

§ 371 Date: Jun. 23, 2015

Related U.S. Application Data
(60) Provisional application No. 61/747,374, filed on Dec. 31, 2012.

(30) Foreign Application Priority Data
Dec. 31, 2012 (EP) 12199802.5
Jun. 12, 2013 (EP) 13171653.2

(51) Int. Cl. A01N 57/20; A01N 43/54; A01N 43/80; A01N 37/10; A01N 43/12; A01N 37/08

(52) U.S. Cl. CPC A01N 57/20; A01N 43/12; A01N 37/08; A01N 43/80; A01N 37/10; A01N 43/54

(57) ABSTRACT

Herbicidal compositions are provided comprising at least one comprising at least one compound of formula I

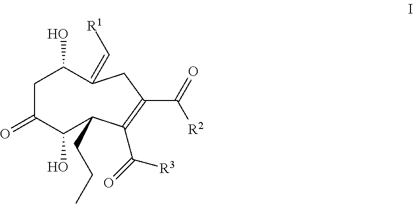

wherein R₁, R₂ and R₃ are as defined in the specification
and at least one further compound selected from herbicidally active compounds listed in the specification.

The invention relates to herbicidal compositions comprising at least one compound of formula I and at least one further compound selected from herbicidally active compounds.

In the case of crop protection compositions, it is desirable, in principle, to increase the specific activity of an active compound and the reliability of the effect. It is particularly desirable for the crop protection composition to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

With many highly effective herbicides, there is the problem that their compatibility with useful plants, in particular dicotyledonous crop plants, such as cotton, oilseed rape and graminaceous plants, such as barley, millet, corn, rice, wheat and sugar cane, is not always satisfactory, i.e. in addition to harmful plants, the crop plants, too, are damaged on a scale which cannot be tolerated. By reducing the application rates, the useful plants are spared; however, naturally, the extent of the control of harmful plants decreases, too.

Frequently, it is a problem that herbicides can only be applied within a narrow time frame in order to achieve the desired herbicidal action, which time frame may be unpredictably influenced by weather conditions.

It is known that special combinations of different specifically active herbicides result in enhanced activity of an herbicide component in the sense of a synergistic effect. In this manner, it is possible to reduce the application rates of herbicidally active compounds required for controlling the harmful plants.

Furthermore, it is known that in some cases joint application of specifically acting herbicides with organic active compounds, some of which may also have herbicidal activity, allows better crop plant compatibility to be achieved. In these cases, the active compounds act as antidotes or antagonists and are also referred to as safeners, since they reduce or even prevent damage to the crop plants.

Cornexistin (I.a1) and its corresponding dibasic acid (I.a2) are known from EP-A 0 290 193:

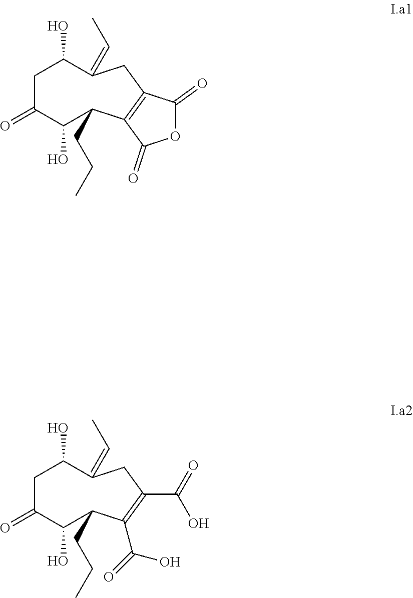 [SMILES: C/C=C1/CC2=C(C(=O)OC2=O)[C@H](CCC)[C@H](O)C(=O)C[C@@H]1O ; C/C=C1/C/C(C(=O)O)=C(/C(=O)O)[C@H](CCC)[C@H](O)C(=O)C[C@@H]1O]

Hydroxycornexistin (I.a3) and its corresponding dibasic acid (I.a4) are known from U.S. Pat. No. 5,424,278:

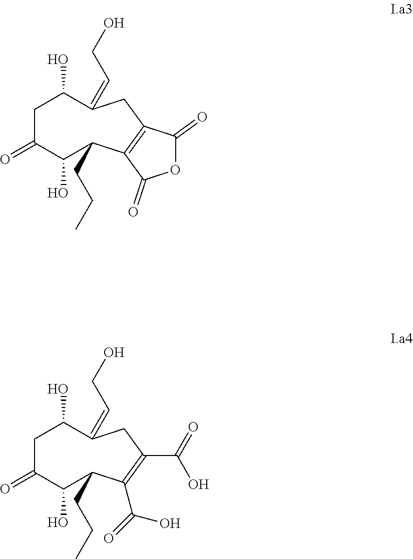 [SMILES: CCC[C@H]1C2=C(C/C(=C/CO)[C@@H](O)CC(=O)[C@H]1O)C(=O)OC2=O ; CCC[C@H]1/C(C(=O)O)=C(/C(=O)O)C/C(=C/CO)[C@@H](O)CC(=O)[C@H]1O]

The herbicidal activity of these compounds is also known from the cited references. JP-A 1990-256 602 discloses mixtures of cornexistin (I.a1) and its dibasic acid (I.a2) with certain herbicides.

Nevertheless, there is still room for improvement, e.g. regarding activity, scope of activity and compatibility with useful plants of the known herbicidal compositions.

It is an object of the present invention to provide herbicidal compositions which are highly active against unwanted harmful plants. At the same time, the compositions should have good compatibility with useful plants. In addition, the compositions according to the invention should have a broad spectrum of activity. A further object of the present invention is reducing the application rates of active ingredients.

This and further objects are achieved by the herbicidal compositions below.

Accordingly, in one aspect of the invention there is provided a herbicidal composition comprising:

A) at least one herbicidally active compound of formula I (herbicide A)

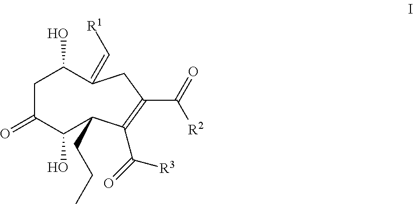

wherein
R¹ is CH₃ or CH₂OH and
R² and R³ together with the neighboring carbon atoms form a dihydro-2,5-dioxofuran ring
or
R² and R³ are OH;
   including agriculturally acceptable salts and derivatives thereof;
   and
B) at least one further active compound selected from herbicides of groups b1) to b15) (herbicide B):
b1) ACC lipid biosynthesis inhibitors;
b3) photosynthesis inhibitors PS I,
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cinmethylin, coumaron, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin (CAS 403640-27-7), methyl azide, methyl bromide, methyl-daimuron, methyl iodide, MSMA, oleic acid, oxaziclomefone, pelargonic acid, pyributicarb, quinoclamine, triaziflam and 6-chloro-3-(2-cyclopropyl-6-methylphenoxy)-4-pyridazinol (CAS 499223-49-3);
   including agriculturally acceptable salts and derivatives thereof.

The compositions according to the invention are suitable as herbicides as such or as appropriately formulated compositions (agrochemical compositions). As used herein, the term “agrochemical composition” refers to a composition comprising a pesticidally effective amount of at least one active ingredient and at least one auxiliary customary for agrochemical compositions.

The invention relates in particular to compositions in the form of herbicidally active agrochemical compositions comprising a herbicidally effective amount of A) at least one compound of formula I (herbicide A) and B) at least one further compound selected from the herbicides of groups b1) to b15) (herbicide B), as defined above, and also at least one liquid and/or solid carrier and/or one or more surfactants and, if desired, one or more further auxiliaries customary for agrochemical compositions.

The invention also relates to compositions in the form of an agrochemical composition, which is a 1-component composition comprising at least one herbicide A and at least one further active compound selected from the herbicides B, and at least one solid or liquid carrier and/or one or more surfactants and, if desired, one or more further auxiliaries customary for agrochemical compositions.

The invention also relates to compositions in the form of an agrochemical composition, which is a 2-component composition comprising a first component comprising at least one herbicide A, a solid or liquid carrier and/or one or more surfactants, and a second component comprising at least one herbicide B, a solid or liquid carrier and/or one or more surfactants, where additionally both components may also comprise further auxiliaries customary for agrochemical compositions.

Surprisingly, the compositions according to the invention comprising at least one herbicide A and at least one herbicide B have better herbicidal activity, i.e. better activity against harmful plants, than would have been expected based on the herbicidal activity observed for the individual compounds, or a broader activity spectrum. The herbicidal activity to be expected for mixtures based on the individual compound can be calculated using Colby's formula (see below). If the activity observed exceeds the expected additive activity of the individual compounds, synergism is said to be present.

Moreover, the time frame, within which the desired herbicidal action can be achieved, may be expanded by the compositions according to the invention comprising at least one herbicide A and at least one herbicide B and optionally a safener C as defined below. This allows a more flexibly timed application of the compositions according to the invention in comparison with the single compounds.

Safeners are chemical compounds which prevent or reduce damage on useful plants without having a major impact on the herbicidal action of the herbicidal active components towards unwanted plants. Safeners can be applied before sowings (e.g. seed treatments), on shoots or seedlings as well as in the pre-emergence or post-emergence treatment of useful plants and their habitat.

The compositions according to the invention comprising both at least one herbicide A and at least one safener C as defined below also have good herbicidal activity against harmful plants and better compatibility with useful plants.

Surprisingly, compositions according to the invention comprising at least one herbicide A at least one herbicide B and at least one safener C have better herbicidal activity, i.e. better activity against harmful plants, than would have been expected based on the herbicidal activity observed for the individual compounds, or a broader activity spectrum, and show better compatibility with useful plants than compositions comprising only one herbicide A and one herbicide B.

Therefore, in one embodiment of the present invention the compositions comprise at least one herbicide A, at least one herbicide B and at least one safener C.

Examples of suitable safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-methoxybenzoyl)-4-[(methylaminocarbonyl)amino]benzenesulfonamide (CAS 129531-12-0).

The safeners C, the herbicides A and the herbicides B can be applied simultaneously or in succession.

Furthermore, the invention relates to a herbicidal formulation comprising a herbicidally active amount of at least one composition according the present invention and at least one inert liquid and/or solid carrier and, if appropriate, at least one surface-active substance.

A process for the preparation of herbicidally active formulation mentioned above, which comprises mixing a herbicidally active amount of at least one herbicidal composition according to the present invention and at least one inert liquid and/or solid carrier and, if desired, at least one surface-active substance is also the subject of the present invention.

The invention furthermore relates to a method for controlling unwanted vegetation, in particular where crop plants are cultivated.

In particular, the invention relates to method for controlling unwanted vegetation which comprises allowing a herbicidally active amount of at least one herbicidal composition according to the present invention to act on plants, their environment or on seed.

The invention also relates to a method for the desiccation or defoliation of plants.

As used herein, the terms “undesirable vegetation” and “harmful plants” are synonyms.

The term “cornexistin” means the compound of formula (I.a1) as well as agriculturally acceptable salts thereof.

The term “dibasic acid of cornexistin” means the compound of formula (I.a2) as well as agriculturally acceptable salts thereof.

The term “hydroxycornexistin” means the compound of formula (I.a3) as well as agriculturally acceptable salts thereof.

The term “dibasic acid of hydroxycornexistin” means the compound of formula (I.a4) as well as agriculturally acceptable salts thereof.

The compounds of formulae (I.a1) to (I.a4) as described herein are capable of forming geometrical isomers, for example E/Z isomers. Accordingly, the terms “cornexistin”, “dibasic acid of cornexistin”, “hydroxycornexistin” and “dibasic acid of hydroxycornexistin” also encompass the pure E or Z isomers and mixtures thereof.

The term “agriculturally acceptable salts” is used herein to mean in general, the salts of those cations and the acid addition salts of those acids whose cations and anions, respectively, have no adverse effect on the herbicidal activity of the dibasic acid of cornexistin and the dibasic acid of hydroxycornexistin.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, heptylammonium, dodecylammonium, tetradecylammonium, tetramethylammonium, tetraethylammonium, tetrabutylammonium, 2 hydroxyethyl-ammonium (olamine salt), 2-(2-hydroxyeth-1-oxy)eth-1-ylammonium (diglycolamine salt), di(2-hydroxyeth-1-yl)-ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogen [symbol] phosphate, nitrate, bicarbonate, carbonate, hexafluorosilicate, hexafluorophosphate, benzoate and also the anions of C₁-C₄-alkanoic acids, preferably formate, acetate, propionate and butyrate.

If the herbicidal compounds B and/or D and/or safeners C as described herein are capable of forming geometrical isomers, for example E/Z isomers, it is possible to use both, the pure isomers and mixtures thereof, in the compositions according to the invention. If the herbicidal compounds B and/or D and/or safeners C as described herein have one or more centers of chirality and, as a consequence, are present as enantiomers or diastereomers, it is possible to use both, the pure enantiomers and diastereomers and their mixtures, in the compositions according to the invention. If the herbicidal compounds B and/or D and/or safeners C as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations and anions are the ones listed for the compounds of formula I.

Herbicidal compounds A, B and/or D and/or safeners C as described herein having a carboxyl, hydroxy and/or an amino group can be employed as such or in form of an agriculturally suitable salt as mentioned above or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

Further embodiments of the invention are evident from the claims, the description and the examples. It is to be understood that the features mentioned above and still to be illustrated below of the subject matter of the invention can be applied not only in the combination given in each particular case but also in other combinations, without leaving the scope of the invention.

The preferred embodiments of the invention mentioned herein below have to be understood as being preferred either independently from each other or in combination with one another.

Preferably, the active ingredient A is selected from the following herbicides A:
a1) cornexistin (I.a1),
a2) the dibasic acid of cornexistin (I.a2),
a3) hydroxycornexistin (I.a3),
a4) the dibasic acid of hydroxycornexistin (I.a4),
a5) mixtures of cornexistin (I.a1) and the dibasic acid of cornexistin (I.a2),
a6) mixtures of hydroxycornexistin (I.a3) and the dibasic acid of hydroxycornexistin (I.a4)
a7) mixtures of cornexistin (I.a1) and hydroxycornexistin (I.a3),
a8) mixtures of cornexistin (I.a1) and the dibasic acid of hydroxycornexistin (I.a4),
a9) mixtures of the dibasic acid of cornexistin (I.a2) and hydroxycornexistin (I.a3),
a10) mixtures of the dibasic acid of cornexistin (I.a2) and the dibasic acid of hydroxycornexistin (I.a4) and
a11) mixtures cornexistin (I.a1), the dibasic acid of cornexistin (I.a2), hydroxycornexistin (I.a3) and the dibasic acid of hydroxycornexistin (I.a4)
   including agriculturally acceptable salts and derivatives thereof.

Preferred are the compositions according to the present invention comprising at least one, preferably exactly one herbicide A and at least one herbicide B.

Further preferred are compositions according to the present invention comprising at least two, preferably exactly two herbicides A and at least one herbicide B.

In one preferred embodiment of the invention the compositions contain at least one inhibitor of the lipid biosynthesis (herbicide b1) through inhibition of acetylCoA carboxylase (hereinafter termed ACC herbicides). The ACC herbicides belong to the group A of the HRAC classification system.

According to a further embodiment of the invention the compositions contain at least one inhibitor of photosynthesis (herbicide b3) on diverting the electron transfer in photosystem I in plants (so-called PSI inhibitors, group D of HRAC classification) and thus on an inhibition of photosynthesis.

According to a further embodiment of the invention the compositions contain at least one inhibitor of protoporphyrinogen-IX-oxidase (herbicide b4). The herbicidal activity of these compounds is based on the inhibition of the protoporphyrinogen-IX-oxidase. These inhibitors belong to the group E of the HRAC classification system.

According to a further embodiment of the invention the compositions contain at least one bleacher-herbicide (herbicide b5). The herbicidal activity of these compounds is based on the inhibition of the carotenoid biosynthesis. These include compounds which inhibit carotenoid biosynthesis by inhibition of phytoene desaturase (so-called PDS inhibitors, group F1 of HRAC classification), compounds that inhibit the 4-hydroxyphenylpyruvate-dioxygenase (HPPD inhibitors, group F2 of HRAC classification), compounds that inhibit DOXsynthase (group F4 of HRAC class) and compounds which inhibit carotenoid biosynthesis by an unknown mode of action (bleacher-unknown target, group F3 of HRAC classification).

According to a further embodiment of the invention the compositions contain at least one EPSP synthase inhibitor (herbicide b6). The herbicidal activity of these compounds is based on the inhibition of enolpyruvyl shikimate 3-phosphate synthase, and thus on the inhibition of the amino acid biosynthesis in plants. These inhibitors belong to the group G of the HRAC classification system.

According to a further embodiment of the invention the compositions contain at least one glutamine synthetase inhibitor (herbicide b7). The herbicidal activity of these compounds is based on the inhibition of glutamine synthetase, and thus on the inhibition of the aminoacid biosynthesis in plants. These inhibitors belong to the group H of the HRAC classification system.

According to a further embodiment of the invention the compositions contain at least one DHP synthase inhibitor (herbicide b8). The herbicidal activity of these compounds is based on the inhibition of 7,8-dihydropteroate synthase. These inhibitors belong to the group I of the HRAC classification system.

According to a further embodiment of the invention the compositions contain at least one cellulose biosynthesis inhibitor (herbicide b11). The herbicidal activity of these compounds is based on the inhibition of the biosynthesis of cellulose and thus on the inhibition of the synthesis of cell walls in plants. These inhibitors belong to the group L of the HRAC classification system.

According to a further embodiment of the invention the compositions contain at least one decoupler herbicide (herbicide b12). The herbicidal activity of these compounds is based on the disruption of the cell membrane. These inhibitors belong to the group M of the HRAC classification system.

According to a further embodiment of the invention the compositions contain at least one auxinic herbicide (herbicide b13). These include compounds that mimic auxins, i.e. plant hormones, and affect the growth of the plants. These compounds belong to the group O of the HRAC classification system.

According to a further embodiment of the invention the compositions contain at least one auxin transport inhibitor (herbicide b14). The herbicidal activity of these compounds is based on the inhibition of the auxin transport in plants. These compounds belong to the group P of the HRAC classification system.

According to a further embodiment of the invention the compositions contain at least one other herbicide (herbicide b15) selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methiozolin (CAS 403640-27-7), methyl azide, methyl bromide, methyl-daimuron, methyl iodide, MSMA, oleic acid, oxaziclomefone, pelargonic acid, pyributicarb, quinoclamine, and 6-chloro-3-(2-cyclopropyl-6-methylphenoxy)-4-pyridazinol (CAS 499223-49-3). These compounds have an unknown mode of action and belong to the group Z of the HRAC classification system.

As to the given mechanisms of action and classification of the active compounds, see e.g. “HRAC, Classification of Herbicides According to Mode of Action”, (http://www.plantprotection.org/hrac/MOA.html).

Examples of herbicides B which can be used in combination with the herbicides A are:

b1) from the group of the ACC lipid biosynthesis inhibitors:
herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5).
b3) from the group of the PS I photosynthesis inhibitors:
e.g. diquat, diquat-dibromide, paraquat, paraquat-dichloride and paraquat-dimetilsulfate.
b4) from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, cinidon-ethyl, ethoxyfen-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7), 3-[7-fluoro-3-oxo-4-(prop-2-ynyl)-3,4-dihydro-2H-benzo[1,4]oxazin-6-yl]-1,5-dimethyl-6-thioxo[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione and (Z)-4-[2-Chloro-5-(4-chloro-5-difluoromethoxy-1-methyl-1H-pyrazol-3-yl)-4-fluoro-phenoxy]-3-methyl-but-2-enoic acid methyl ester;
b5) from the group of the bleacher herbicides:
PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine (CAS 180608-33-7), HPPD inhibitors: benzobicyclon, benzofenap, clomazone, isoxaflutole, mesotrione, pyrasulfotole, pyrazolynate, pyrazoxyfen, sulcotrione, tefuryltrione, tembotrione, topramezone and bicyclopyrone, bleacher, unknown target: aclonifen, amitrole and flumeturon;
b6) from the group of the EPSP synthase inhibitors:
glyphosate, glyphosate-isopropylammonium, glyposate-potassium and glyphosate-trimesium (sulfosate);
b7) from the group of the glutamine synthase inhibitors:
bilanaphos (bialaphos), bilanaphos-sodium, glufosinate, glufosinate-P and glufosinate-ammonium;
b8) from the group of the DHP synthase inhibitors: asulam;
b11) from the group of the cellulose biosynthesis inhibitors:
chlorthiamid, dichlobenil, flupoxam, indaziflam, isoxaben, triaziflam, triazolocarboxamide and 1-cyclohexyl-5-pentafluorphenyloxy-1⁴-[1,2,4,6]thiatriazin-3-ylamine;
b12) from the group of the decoupler herbicides:
dinoseb, dinoterb and DNOC and its salts;
b13) from the group of the auxinic herbicides:
2,4-D and its salts and esters such as clacyfos, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyr-meptyl, halauxifen and its salts and esters (CAS 943832-60-8); MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters and triclopyr and its salts and esters;
b14) from the group of the auxin transport inhibitors: diflufenzopyr, diflufenzopyr-sodium, naptalam and naptalam-sodium;
b15) from the group of the other herbicides: bromobutide, chlorflurenol, chlorflurenol-methyl, cinmethylin, cumyluron, cyclopyrimorate (CAS 499223-49-3) and its salts and esters, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine and 6-Chloro-3-(2-cyclopropyl-6-methylphenoxy)-pyrazin-2-ol (CAS 499223-49-3).

Preferred herbicides B that can be used in combination with herbicides A according to the invention are:

b1) from the group of the ACC lipid biosynthesis inhibitors:
clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5);
b3) from the group of the PS I photosynthesis inhibitors:
diquat, diquat-dibromide, paraquat and paraquat-dichloride, paraquat dimetilsulfate;
b4) from the group of the protoporphyrinogen-IX oxidase inhibitors: acifluorfen-sodium, bencarbazone, benzfendizone, butafenacil, carfentrazone-ethyl, cinidon-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7), 3-[7-fluoro-3-oxo-4-(prop-2-ynyl)-3,4-dihydro-2H-benzo[1,4]oxazin-6-yl]-1,5-dimethyl-6-thioxo[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
b5) from the group of the bleacher herbicides:
aclonifen, beflubutamid, benzobicyclon, clomazone, diflufenican, flurochloridone, flurtamone, isoxaflutole, mesotrione, norflurazon, picolinafen, pyrasulfotole, pyrazolynate, sulcotrione, tefuryltrione, tembotrione, topramezone, bicyclopyrone, 4-(3-trifluoromethylphenoxy)-2-(4-trifluoromethylphenyl)pyrimidine (CAS 180608-33-7), amitrole and flumeturon;
b6) from the group of the EPSP synthase inhibitors:
glyphosate, glyphosate-isopropylammonium, glyphosate-potassium and glyphosate-trimesium (sulfosate);
b7) from the group of the glutamine synthase inhibitors:
glufosinate, glufosinate-P, glufosinate-ammonium;
b8) from the group of the DHP synthase inhibitors: asulam;
b11) from the group of the cellulose biosynthesis inhibitors: dichlobenil, flupoxam, indaziflam, isoxaben, triaziflam and 1-Cyclohexyl-5-pentafluorphenyloxy-1⁴-[1,2,4,6]thiatriazin-3-ylamine;
b12) from the group of the decoupler herbicides: dinoseb;
b13) from the group of the auxinic herbicides:
2,4-D and its salts and esters, aminocyclopyrachlor and its salts and esters, aminopyralid and its salts such as aminopyralid-tris(2-hydroxypropyl)ammonium and its esters, clopyralid and its salts and esters, dicamba and its salts and esters, dichlorprop-P and its salts and esters, fluroxypyr-meptyl, halauxifen and its salts and esters (CAS 943832-60-8), MCPA and its salts and esters, MCPB and its salts and esters, mecoprop-P and its salts and esters, picloram and its salts and esters, quinclorac, quinmerac and triclopyr and its salts and esters;
b14) from the group of the auxin transport inhibitors: diflufenzopyr and diflufenzopyr-sodium;
b15) from the group of the other herbicides: bromobutide, cinmethylin, cumyluron, cyclopyrimorate (CAS 499223-49-3) and its salts and esters, dalapon, difenzoquat, difenzoquat-metilsulfate, DSMA, dymron (=daimuron), flamprop, flamprop-isopropyl, flamprop-methyl, flamprop-M-isopropyl, flamprop-M-methyl, indanofan, metam, methylbromide, MSMA, oxaziclomefone, pelargonic acid and pyributicarb.

Particularly preferred herbicides B that can be used in combination with herbicides A are:

b1) from the group of the ACC lipid biosynthesis inhibitors: clodinafop-propargyl, cycloxydim, cyhalofop-butyl, fenoxaprop-P-ethyl, pinoxaden, profoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5);
b3) from the group of the PS I photosynthesis inhibitors: paraquat and paraquat-dichloride;
b4) from the group of the protoporphyrinogen-IX oxidase inhibitors: carfentrazone-ethyl, flumioxazin, lactofen, oxadiargyl, oxyfluorfen, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione and 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
b5) from the group of the bleacher herbicides: clomazone, diflufenican, flurochloridone, isoxaflutole, mesotrione, norflurazone, picolinafen, sulcotrione, tefuryltrione, tembotrione, topramezone, benzobicyclone, bicyclopyrone, amitrole and flumeturon;
b6) from the group of the EPSP synthase inhibitors: glyphosate, glyphosate-isopropylammonium and glyphosate-trimesium (sulfosate);
b7) from the group of the glutamine synthase inhibitors: glufosinate, glufosinate-P and glufosinate-ammonium;
b8) from the group of the DHP synthase inhibitors: asulam;
b11) from the group of the cellulose biosynthesis inhibitors: indaziflam, isoxaben, triaziflam and triazolocarboxamide;
b12) from the group of the decoupler herbicides: dinoseb;
b13) from the group of the auxinic herbicides: 2,4-D and its salts and esters such as clacyfos, and aminocyclopyrachlor and its salts and esters, aminopyralid and its salts and its esters, clopyralid and its salts and esters, dicamba and its salts and esters, fluroxypyr-meptyl, MCPA, quinclorac and quinmerac;
b14) from the group of the auxin transport inhibitors: diflufenzopyr and diflufenzopyr-sodium,
b15) from the group of the other herbicides: dymron (=daimuron), indanofan, oxaziclomefone and pelargonic acid.

Most preferred herbicides B that can be used in combination with herbicides A are given in table 1 below:

TABLE 1

| | Herbicide B |
|---|---|
| B.1 | clethodim |
| B.2 | clodinafop-propargyl |
| B.3 | cycloxydim |
| B.4 | pinoxaden |
| B.5 | sethodydim |
| B.6 | paraquat |
| B.7 | carfentrazone-ethyl |
| B.8 | flumioxazin |
| B.9 | lactofen |
| B.10 | oxadiargyl |
| B.11 | oxyflurofen |
| B.12 | saflufenacil |
| B.13 | sulfentrazone |
| B.14 | 1,5-dimethyl-6-thioxo-3-(2,2,7- |
| | trifluoro-3-oxo-4-(prop-2-ynyl)- |
| | 3,4-dihydro-2H- |
| | benzo[b][1,4]oxazin-6-yl)-1,3,5- |
| | triazinane-2,4-dione |
| B.15 | benzobicylone |
| B.16 | bicyclopyrone |
| B.17 | clomazone |
| B.18 | difufenican |
| B.19 | isoxaflutole |
| B.20 | mesotrione |
| B.21 | norflurazon |
| B.22 | picolinafen |
| B.23 | sulcotrione |
| B.24 | tembotrione |
| B.25 | topramezone |
| B.26 | glyphosate |
| B.27 | glufosinate |
| B.28 | indaziflam |
| B.29 | isoxaben |
| B.30 | dinoseb |
| B.31 | 2,4D |
| B.32 | dicamba |
| B.33 | fluroxypyr |
| B.34 | MCPA |
| B.35 | quinmerac |
| B.36 | quinclorac |
| B.37 | diflufenzopyr |
| B.38 | daimuron |
| B.39 | pelargonic acid |

Any of the herbicides B.1 to B.39 having a carboxylic, amino and/or hydroxyl group are to be understood as to be employed as such and/or in form of agriculturally acceptable salts thereof and/or in form of agriculturally acceptable esters or amides thereof.

According to a preferred embodiment of the invention, the composition comprises at least one, preferably exactly one herbicide B.

According to another preferred embodiment of the invention, the composition comprises at least two, preferably exactly two herbicides B different from each other.

According to another preferred embodiment of the invention, the composition comprises at least three, preferably exactly three herbicides B different from each other.

According to another preferred embodiment of the invention, the composition comprises at least one, preferably exactly one herbicide A and at least one, preferably exactly one, herbicide B.

According to another preferred embodiment of the invention, the composition comprises at least one, preferably exactly one herbicide A and at least two, preferably exactly two, herbicides B different from each other.

According to another preferred embodiment of the invention, the composition comprises at least one, preferably exactly one herbicide A and at least three, preferably exactly three, herbicides B different from each other.

According to one preferred embodiment of the invention, the composition comprises at least one herbicide B selected from compounds of groups b1), b3), b4), b5), b6), b7), b8), b11), b12), b13), b14) and b15), preferably selected from compounds of groups b1), b3), b4), b5), b6), b7), b8), b11), b12), b13), b14) or b15).

According to another preferred embodiment of the invention, the composition comprises at least one, preferably exactly one herbicide A, preferably selected from a1), a2), a3), a4), a5), a6), a7), a8), a9), a10) and a1), most preferably selected from a1), a2), a3), a4), a5), a6), a7), a8), a9), a10) or a11), and at least one, preferably exactly one herbicide B selected from the compounds of group b1), in particular selected from clethodim (B.1), clodinafop-propargyl (B.2), cycloxydim (B.3), pinoxaden (B.4) and sethodydim (B.5).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b3), in particular paraquat and agriculturally acceptable salts thereof (B.6).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b4), in particular selected from carfentrazone-ethyl (B.7), flumioxazin (B.8), lactofen (B.9), oxadiargyl (B.10), oxyflurofen (B.11), saflufenacil (B.12), sulfentrazone (B.13) and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) (B.14).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b5), preferably selected from benzobicyclone (B.15), bicyclopyrone (B.16), clomazone (B.17), diflufenican (B.18), isoxaflutole (B.19), mesotrione (B.20), norflurazon (B.21), picolinafen (B.22), sulcotrione (B.23), tembotrione (B.24), and topramezone (B.25), in particular selected from benzobicyclone (B.15), isoxaflutole (B.19), mesotrione (B.20) and topramezone (B.25).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b6), in particular glyphosate and agriculturally acceptable salts thereof (B.26).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b7), in particular glufosinate and agriculturally acceptable salts thereof (B.27).

According to another preferred embodiment of the invention, the composition comprises at least one, preferably exactly one herbicide A selected from a1), a2), a3), a4), a5), a6), a7), a8), a9), a10) and a1), most preferably selected from a1), a2), a3), a4), a5), a6), a7), a8), a9), a10) or a11), at least one, preferably exactly one herbicide B selected from the compounds of group b11), in particular selected from indaziflam (B.28) and isoxaben (B.29).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), at least one, preferably exactly one herbicide B selected from the compounds of group b12), in particular dinoseb (B.30).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b13), in particular from 2,4D and agriculturally acceptable salts thereof (B.31), dicamba and agriculturally acceptable salts thereof (B.32), fluroxypyr (B.33), MCPA and agriculturally acceptable salts thereof (B.34), quinmerac and agriculturally acceptable salts thereof (B.35) and quinclorac and agriculturally acceptable salts thereof (B.36).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b14), in particular diflufenzopyr and agriculturally acceptable salts thereof (B.37).

According to another preferred embodiment of the invention, the composition comprises at least one, preferably exactly one herbicide A selected from a1), a2), a3), a4), a5), a6), a7), a8), a9), a10) and a11), most preferably selected from a1), a2), a3), a4), a5), a6), a7), a8), a9), a10) or a11), and at least one, preferably exactly one herbicide B selected from the compounds of group b15), in particular selected from dymron (=daimuron) (B.38) and pelargonic acid and agriculturally acceptable salts thereof (B.39).

In another embodiment, compositions according to the invention comprise at least two herbicides B, whereby a first herbicide B is selected from the compounds of groups b1), b3), b4), b5), b8), b11), b12, b13), b14 and b15), preferably selected from the compounds of groups b1), b3), b4), b5), b8), b11), b12, b13), b14 or b15) and a second herbicide B is selected from the compounds of groups b6) and b7), preferably selected from the compounds of groups b6) or b7).

In another embodiment of the present invention the compositions according to the invention comprise at least one herbicide A selected from a1) to a11), at least one herbicide B and at least one safener C.

Examples of safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-methoxybenzoyl)-4-[(methylaminocarbonyl)amino]benzenesulfonamide (CAS 129531-12-0).

Preferred safeners C are benoxacor, cloquintocet, cyprosulfamide, dichlormid, fenchlorazole, fenclorim, flurazole, fluxofenim, furilazole, isoxadifen, mefenpyr, naphthalic anhydride, oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

Particularly preferred safeners C are benoxacor, cloquintocet, cyprosulfamide, dichlormid, fenchlorazole, fenclorim, furilazole, isoxadifen, mefenpyr, naphthalic anhydride, oxabetrinil, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

Most preferred safeners C are listed in table 2 below:

TABLE 2

| | Safener C |
|---|---|
| C.1 | benoxacor |
| C.2 | cloquintocet |
| C.3 | cyprosulfamide |
| C.4 | dichlormid |
| C.5 | fenchlorazole |
| C.6 | fenclorim |
| C.7 | furilazole |
| C.8 | isoxadifen |
| C.9 | mefenpyr |
| C.10 | 4-(dichloroacetyl)-1-oxa-4-azaspiro[4.5]decane |
| | (MON4660, CAS 71526-07-3) |
| C.11 | 2,2,5-trimethyl-3-(dichloroacetyl)-1,3-oxazolidine |
| | (R-29148, CAS 52836-31-4) |

Any of the safeners C.1 to C.11 having a carboxylic, amino and/or hydroxyl group are to be understood as to be employed as such and/or in form of agriculturally acceptable salts thereof.

According to one preferred embodiment of the invention, the composition comprises at least one, preferably exactly one herbicide B, and at least one, preferably exactly one, safener C.

According to another preferred embodiment of the invention, the composition comprises at least two, preferably exactly two herbicides B different from each other, and at least one, preferably exactly one, safener C.

According to another preferred embodiment of the invention, the composition comprises at least three, preferably exactly three herbicides B different from each other, and at least one, preferably exactly one, safener C.

According to another preferred embodiment of the invention, the composition comprises as active compounds at least one, preferably exactly one herbicide A, preferably selected from a1), a2), a3), a4), a5), a6), a7), a8), a9), a10) and a11), most preferably selected from a1), a2), a3), a4), a5), a6), a7), a8), a9), a10) or a11), at least one, preferably exactly one, herbicide B, and at least one, preferably exactly one safener C.

According to another preferred embodiment of the invention, the composition comprises as active compounds at least one, preferably exactly one herbicide A, preferably selected from a1), a2), a3), a4), a5), a6), a7), a8), a9), a10) and a11), most preferably selected from a1), a2), a3), a4), a5), a6), a7), a8), a9), a10) or a11), least two, preferably exactly two herbicides B different from each other, and at least one, preferably exactly one, safener C.

According to another preferred embodiment of the invention, the composition comprises as active compounds at least one, preferably exactly one herbicide A, preferably selected from a1), a2), a3), a4), a5), a6), a7), a8), a9), a10) and a1), most preferably selected from a1), a2), a3), a4), a5), a6), a7), a8), a9), a10) or a11), at least three, preferably exactly three herbicides B different from each other, and at least one, preferably exactly one, safener C.

According to another preferred embodiment of the invention, the composition comprises as active compounds at least one, preferably exactly one herbicide A, preferably selected from a1), a2), a3), a4), a5), a6), a7), a8), a9), a10) and a11), most preferably selected from a1), a2), a3), a4), a5), a6), a7), a8), a9), a10) or a11), at least one, preferably exactly one herbicide B, optionally, at least one, preferably exactly one, safener C, and at least one, preferably exactly one further herbicide D, which is different from herbicides A, B and C.

Suitable herbicides D are herbicides from the group of

d1) ALS inhibitors:
sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron,
imidazolinones such as imazamethabenz, imazamethabenz-methyl, imazamox, imazapic, imazapyr, imazaquin and imazethapyr,
triazolopyrimidine herbicides and sulfonanilides such as cloransulam, cloransulam-methyl, diclosulam, flumetsulam, florasulam, metosulam, penoxsulam, pyrimisulfan and pyroxsulam,
pyrimidinylbenzoates such as bispyribac, bispyribac-sodium, pyribenzoxim, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5) and N-(4-bromophenyl)-2-[(4,6-dimethoxy-2-pyrimidinyl)oxy]benzenemethanamine (CAS 420138-01-8),
sulfonylaminocarbonyl-triazolinone herbicides such as flucarbazone, flucarbazone-sodium, propoxycarbazone, propoxycarbazone-sodium, thiencarbazone and thiencarbazone-methyl and triafamone;
   d2) PS II photosynthesis inhibitors:
triazolinones such as amicarbazone,
triazines and methylthiotriazines such as ametryn, atrazine, chlorotriazine, cyanazine, desmetryn, dimethametryn, prometon, prometryne, propazine, simazine, simetryne, terbumeton, terbuthylazine, terbutryn and trietazine,
triazinones und triazindiones, such as hexazinone, metamitron und metribuzin,
pyridazinones such as chloridazone,
aryl urea such as chlorobromuron, chlorotoluron, chloroxuron, dimefuron, diuron, ethidimuron, fluometuron, fenuron, isoproturon, isouron, linuron, methabenzthiazuron, metobenzuron, metoxuron, monolinuron, neburon, siduron, tebuthiuron and thiadiazuron,
phenyl carbamates such as desmedipham, karbutilat, phenmedipham and phenmediphamethyl,
nitrile herbicides such as bromofenoxim, bromoxynil and its salts and esters, ioxynil and its salts and esters,
uraciles such as bromacil, lenacil and terbacil,
phenyl-pyridazines such as pyridate and pyridafol,
amides such as pentanochlor and propanil and
bentazone and bentazone-sodium.
   d3) VLCFA inhibitors:
chloroacetamides such as acetochlor, alachlor, butachlor, dimethachlor, dimethenamid, dimethenamid-P, metazachlor, metolachlor, metolachlor-S, pethoxamid, pretilachlor, propachlor, propisochlor and thenylchlor,
oxyacetanilides such as flufenacet and mefenacet,
acetamides such as diphenamid, naproanilide and napropamide,
tetrazolinones such as fentrazamide,
other herbicides such as anilofos, cafenstrole, fenoxasulfone, ipfencarbazone, piperophos, pyroxasulfone and
isoxazoline compounds of the formulae VI.1, VI.2, VI.3, VI.4, VI.5, VI.6, VI.7, VI.8 and VI.9

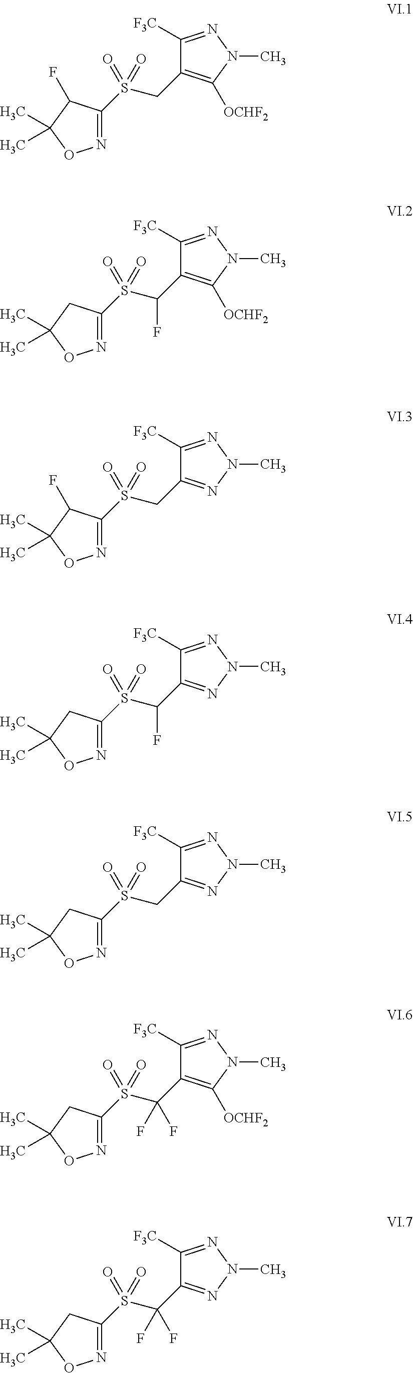

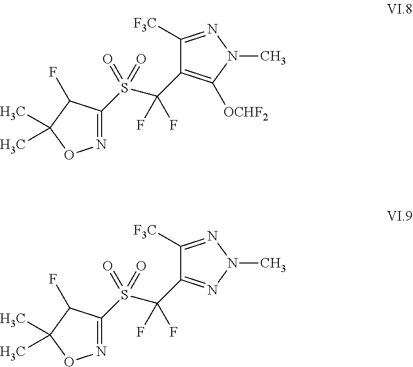

the isoxazoline compounds of the formula VI are known in the art, e.g. from WO 2006/024820, WO 2006/037945, WO 2007/071900 and WO 2007/096576;
among the VLCFA inhibitors, preference is given to chloroacetamides.
d4) mitosis inhibitors:
compounds of group K1:
dinitroanilines such as benfluralin, butralin, dinitramine, ethalfluralin, fluchloralin, oryzalin, pendimethalin, prodiamine and trifluralin,
phosphoramidates such as amiprophos, amiprophos-methyl and butamiphos,
benzoic acid herbicides such as chlorthal and chlorthal-dimethyl,
pyridines such as dithiopyr and thiazopyr,
benzamides such as propyzamide and tebutam;
compounds of group K2: chlorpropham, propham, carbetamide and flamprop-m, among these, compounds of group K1, in particular dinitroanilines are preferred;

Preferred herbicides D are selected from:

d1) ALS inhibitors:
amidosulfuron, azimsulfuron, bensulfuron-methyl, bispyribac-sodium, chlorimuron-ethyl, chlorsulfuron, cloransulam-methyl, cyclosulfamuron, diclosulam, ethametsulfuron-methyl, ethoxysulfuron, flazasulfuron, florasulam, flucarbazone-sodium, flucetosulfuron, flumetsulam, flupyrsulfuron-methyl-sodium, foramsulfuron, halosulfuron-methyl, imazamethabenz-methyl, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, metosulam, metsulfuron-methyl, nicosulfuron, orthosulfamuron, oxasulfuron, penoxsulam, primisulfuron-methyl, propoxycarbazon-sodium, propyrisulfuron, prosulfuron, pyrazosulfuron-ethyl, pyribenzoxim, pyrimisulfan, pyriftalid, pyriminobac-methyl, pyrithiobac-sodium, pyroxsulam, rimsulfuron, sulfometuron-methyl, sulfosulfuron, thiencarbazone-methyl, thifensulfuron-methyl, triasulfuron, tribenuron-methyl, trifloxysulfuron, triflusulfuron-methyl, tritosulfuron and triafamone;
d2) PS II photosynthesis inhibitors:
ametryn, amicarbazone, atrazine, bentazone, bentazone-sodium, bromoxynil and its salts and esters, chloridazone, chlorotoluron, cyanazine, desmedipham, diuron, fluometuron, hexazinone, ioxynil and its salts and esters, isoproturon, lenacil, linuron, metamitron, methabenzthiazuron, metribuzin, phenmedipham, propanil, pyridate, simazine, terbutryn, terbuthylazine and thidiazuron;
d3) VLCFA inhibitors:
acetochlor, alachlor, anilofos, butachlor, cafenstrole, dimethenamid, dimethenamid-P, fentrazamide, flufenacet, mefenacet, metazachlor, metolachlor, S-metolachlor, naproanilide, napropamide, pretilachlor, fenoxasulfone, ipfencarbazone, pyroxasulfone thenylchlor and isoxazolinecompounds of the formulae VI.1, VI.2, VI.3, VI.4, VI.5, VI.6, VI.7, VI.8 and VI.9 as mentioned above;
d4) mitosis inhibitors:
benfluralin, dithiopyr, ethalfluralin, oryzalin, pendimethalin, thiazopyr and trifluralin.
Particularly preferred herbicides D are selected from:
d1) ALS inhibitors: bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyribenzoxim, pyriftalid, pyroxsulam, rimsulfuron, sulfosulfuron, thiencarbazon-methyl, tritosulfuron and triafamone;
d2) PS II photosynthesis inhibitors: ametryn, atrazine, bentazone, bentazone-sodium, bromoxynil and its salts and esters, diuron, fluometuron, hexazinone, isoproturon, linuron, metribuzin, propanil, terbutryn and terbuthylazine;
d3) VLCFA inhibitors: acetochlor, cafenstrole, dimethenamid-P, fentrazamide, flufenacet, mefenacet, metazachlor, metolachlor, S-metolachlor, fenoxasulfone, ipfencarbazone and pyroxasulfone; likewise, preference is given to isoxazoline compounds of the formulae VI.1, VI.2, VI.3, VI.4, VI.5, VI.6, VI.7, VI.8 and VI.9 as mentioned above;
d4) mitosis inhibitors: pendimethalin and trifluralin.

Most preferred herbicides D are listed in table 3 below:

TABLE 3

| | Herbicide D |
|---|---|
| D.1 | nicosulfuron |
| D.2 | tritosulfuron |
| D.3 | atrazine |
| D.4 | diuron |
| D.5 | metribuzin |
| D.6 | simazine |
| D.7 | terbutylazine |
| D.8 | acetochlor |
| D.9 | dimethenamid-P |
| D.10 | s-metolachlor |
| D.11 | pretilachlor |
| D.12 | pendimenthalin |
| D.13 | bispyribac-sodium |
| D.14 | imazapyr |
| D.15 | imazethapyr |
| D.16 | pyribenzoxim |
| D.17 | pyriftalid |
| D.18 | bentazone |
| D.19 | bromoxynil |
| D.20 | pyroxasulfone |

Any of the herbicides D.1 to D.20 having a carboxylic, amino and/or hydroxyl group are to be understood as to be employed as such and/or in form of agriculturally acceptable salts thereof and/or in form of agriculturally acceptable esters or amides thereof.

Preferred are compositions of the invention where the herbicide B is selected from the compounds of group b4), preferably selected from carfentrazone-ethyl (B.7), flumioxazin (B.8), lactofen (B.9), oxadiargyl (B.10), oxyflurofen (B.11), saflufenacil (B.12), sulfentrazone (B.13) and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) (B.14), in particular selected from saflufenacil (B.12) and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) (B.14), and the herbicide D is selected from ALS inhibitors d1), preferably selected from imazapyr and agriculturally acceptable salts thereof (D14), imazetapyr and agriculturally acceptable salts thereof (D15), pyribenzoxim (D16) and pyriftalid (D17); or the herbicide D is selected from PS II photosynthesis inhibitors d2), preferably selected from atrazine (D.3), diuron (D.4), metribuzin (D.5), simazine (D.6), terbutylazine (D7), bentazone and agriculturally acceptable salts thereof (D18) and bromoxynil and agriculturally acceptable salts thereof (D19), in particular selected from atrazine (D.3), simazine (D.6), terbutylazine (D7), bentazone and agriculturally acceptable salts thereof (D18) and bromoxynil and agriculturally acceptable salts thereof (D19); or the herbicide D is selected from VLCFA inhibitors d3), preferably pyroxasulfone (D20).

Also preferred are the compositions of the invention comprising the first herbicide B selected from compounds of group b4) and the herbicide D selected from the compounds of groups d1), d2) or d3) as defined above, which compositions further comprise the second herbicide B selected from compounds of group b6), preferably glyphosate and agriculturally acceptable salts thereof (B.26) or from the compounds of group b7), preferably glufosinate and agriculturally acceptable salts thereof (B.27).

Further preferred are compositions of the invention where the herbicide B is selected from the compounds of group b5), preferably selected from benzobicyclone (B.15), bicyclopyrone (B.16), clomazone (B.17), diflufenican (B.18), isoxaflutole (B.19), mesotrione (B.20), norflurazone (B.21), picolinafen (B.22), sulcotrione (B.23), tembotrione (B.24) and topramezone (B.25), in particular selected from benzobicyclone (B.15), isoxaflutole (B.19), mesotrione (B.20) and topramezone (B.25); and the herbicide D is selected from ALS inhibitors d1), preferably selected from imazapyr and agriculturally acceptable salts thereof (D14), imazetapyr and agriculturally acceptable salts thereof (D15), pyribenzoxim (D16) and pyriftalid (D17); or the herbicide D is selected from PS II photosynthesis inhibitors d2), preferably selected from atrazine (D.3), diuron (D.4), metribuzin (D.5), simazine (D.6), terbutylazine (D.7), bentazone and agriculturally acceptable salts thereof (D18) and bromoxynil and agriculturally acceptable salts thereof (D19); or the herbicide D is selected from VLCFA inhibitors d3), preferably selected from acetochlor (D.8), dimethenamid-p (D.9), s-metolachlor (D.10), pretilachlor (D.11) and pyroxasulfone (D20).

Also preferred are the compositions of the invention comprising the first herbicide B selected from the compounds of group b5) and the herbicide D selected from the compounds of groups d1), d2) or d3) as defined above, which compositions further comprise the second herbicide B selected from the compounds of group b6), preferably glyphosate and agriculturally acceptable salts thereof (B.26) or selected from compounds of group b7), preferably glufosinate and agriculturally acceptable salts thereof (B.27).

Further preferred are compositions of the invention where the herbicide B is selected from the compounds of group b6), preferably glyphosate and agriculturally acceptable salts thereof (B.26), and the herbicide D is selected from ALS inhibitors d1), preferably selected from nicosulfuron (D.1), tritosulfuron (D.2), bispyribac-sodium (D13), imazapyr (D14), imazetapyr (D15), pyribenzoxim (D16) and pyriftalid (D17); or the herbicide D is selected from PS II photosynthesis inhibitors d2), preferably selected from atrazine (D.3), diuron (D4), metribuzin (D.5), simazine (D.6), terbutylazine (D.7), bentazone and agriculturally acceptable salts thereof (D18) and bromoxynil and agriculturally acceptable salts thereof (D19); or the herbicide D is selected from VLCFA inhibitors d3), preferably selected from acetochlor (D.8), dimethenamid-p (D.9), s-metolachlor (D.10), pretilachlor (D.11) and pyroxasulfone (D20); or the herbicide D is selected from the compounds of group d4), preferably pendimenthalin (D.12).

Further preferred are compositions of the invention, where the herbicide B is selected from the compounds of group b7), preferably from glufosinate and agriculturally acceptable salts thereof (B.27), and the herbicide D is selected from ALS inhibitors d1), preferably selected from nicosulfuron (D.1), tritosulfuron (D.2), bispyribac-sodium (D13), imazapyr and agriculturally acceptable salts thereof (D14), imazetapyr and agriculturally acceptable salts thereof (D15), pyribenzoxim (D16) and pyriftalid (D17); or the herbicide D is selected from PS II photosynthesis inhibitors d2), preferably selected from atrazine (D.3), diuron (D4), metribuzin (D.5), simazine (D.6), terbutylazine (D.7), bentazone and agriculturally acceptable salts thereof (D18) and bromoxynil and agriculturally acceptable salts thereof (D19); or the herbicide D is selected from VLCFA inhibitors d3), preferably selected from acetochlor (D.8), dimethenamid-p (D.9), s-metolachlor (D.10), pretilachlor (D.11) and pyroxasulfone (D20); or the herbicide D is selected from compounds of group d4), preferably pendimenthalin (D.12).

Further preferred are compositions of the invention where the herbicide B is selected from the compounds of group b13), preferably from 2,4D and agriculturally acceptable salts thereof (B.31) and agriculturally acceptable salts thereof, dicamba and agriculturally acceptable salts thereof (B.32), fluroxypyr (B.33), MCPA (B.34), quinmerac and agriculturally acceptable salts thereof (B.35) and quinclorac and agriculturally acceptable salts thereof (B.36), in particular 2,4D (B.31) and agriculturally acceptable salts thereof and dicamba and agriculturally acceptable salts thereof (B.32), and the herbicide D is selected from ALS inhibitors d1), preferably from nicosulfuron (D.1), tritosulfuron (D.2), bispyribac-sodium (D13), imazapyr (D14), imazetapyr (D15), pyribenzoxim (D16) or pyriftalid (D17); or the herbicide D is selected from VLCFA inhibitors d3), preferably from acetochlor (D.8), dimethenamid-p (D.9), s-metolachlor (D.10), pretilachlor (D.11) and pyroxasulfone (D20).

Also preferred are the compositions of the present invention comprising a first herbicide B selected from compounds of group b13) and a herbicide D selected from compounds of groups d1) or d3) as defined above, which compositions further comprise a second herbicide B selected from compounds group b6), preferably from glyphosate (B.26) and agriculturally acceptable salts thereof or from compounds of group b7), preferably from glufosinate (B.27) and agriculturally acceptable salts thereof.

Further preferred are compositions of the invention where the herbicide B is selected from compounds of group b14), preferably diflufenzopyr and agriculturally acceptable salts thereof (B.37), and the herbicide D is selected from ALS inhibitors d1), preferably from nicosulfuron (D.1), tritosulfuron (D.2), bispyribac-sodium (D13), imazapyr and agriculturally acceptable salts thereof (D14), imazetapyr and agriculturally acceptable salts thereof (D15), pyribenzoxim (D16) or pyriftalid (D17); or the herbicide D is selected from VLCFA inhibitors d3), preferably from acetochlor (D.8), dimethenamid-p (D.9), s-metolachlor (D.10), pretilachlor (D.11) and pyroxasulfone (D20).

Also preferred are the compositions of the present invention comprising a first herbicide B selected from compounds of group b14) and a herbicide D selected from compounds of group d1) or d3) as defined above, which further comprise a second herbicide B selected from compounds of group b6), preferably from glyphosate and agriculturally acceptable salts thereof (B.26) or from compounds of group b7), preferably glufosinate and agriculturally acceptable salts thereof (B.27).

The herbicides B of groups b1) to b15), herbicides D of groups d1) to d4) and the safeners C are known herbicides and safeners, see, for example, The Pesticide Manual, British Crop Protection Council, 16^{th} edition, 2012; The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this compound was only assigned to one mechanism of action.

Herbicides B and D and safener C having a carboxyl group can be employed in the form of the acid, in the form of an agriculturally suitable salt as mentioned above or else in the form of an agriculturally acceptable derivative in the compositions according to the invention.
In the case of dicamba, suitable salts include those, where the counterion is an agriculturally acceptable cation. For example, suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.
Suitable salts of 2,4-D are 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium. Examples of suitable esters of 2,4-D are 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl and clacyfos.
Suitable salts of 2,4-DB are for example 2,4-DB-sodium, 2,4-DB-potassium and 2,4-DB-dimethylammonium. Suitable esters of 2,4-DB are for example 2,4-DB-butyl and 2,4-DB-isoctyl.
Suitable salts of dichlorprop are for example dichlorprop-potassium and dichlorprop-dimethylammonium. Examples of suitable esters of dichlorprop are dichlorprop-butotyl and dichlorprop-isoctyl.
Suitable salts and esters of MCPA include MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium and MCPA-trolamine.
A suitable salt of MCPB is MCPB sodium. A suitable ester of MCPB is MCPB-ethyl. Suitable salts of clopyralid are clopyralid-potassium, clopyralid-olamine and clopyralid-tris-(2-hydroxypropyl)ammonium. Example of suitable esters of clopyralid is clopyralid-methyl.
Examples of a suitable ester of fluroxypyr are fluroxypyr-meptyl and fluroxypyr-2-butoxy-1-methylethyl, wherein fluroxypyr-meptyl is preferred.
Suitable salts of picloram are picloram-dimethylammonium, picloram-potassium, picloram-triisopropanolammonium, picloram-triisopropylammonium and picloram-trolamine. A suitable ester of picloram is picloram-isoctyl.
A suitable salt of triclopyr is triclopyr-triethylammonium. Suitable esters of triclopyr are for example triclopyr-ethyl and triclopyr-butotyl.
Suitable salts and esters of chloramben include chloramben-ammonium, chloramben-diolamine, chloramben-methyl, chloramben-methylammonium and chloramben-sodium. Suitable salts and esters of 2,3,6-TBA include 2,3,6-TBA-dimethylammonium, 2,3,6-TBA-lithium, 2,3,6-TBA-potassium and 2,3,6-TBA-sodium.
Suitable salts and esters of aminopyralid include aminopyralid-potassium and aminopyralid-tris(2-hydroxypropyl)ammonium.
Suitable salts of glyphosate are for example glyphosate-ammonium, glyphosate-diammonium, glyphosate-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).
A suitable salt of glufosinate is for example glufosinate-ammonium.
A suitable salt of glufosinate-P is for example glufosinate-P-ammonium.
Suitable salts and esters of bromoxynil are for example bromoxynil-butyrate, bromoxynil-heptanoate, bromoxynil-octanoate, bromoxynil-potassium and bromoxynil-sodium.
Suitable salts and esters of ioxynil are for example ioxynil-octanoate, ioxynil-potassium and ioxynil-sodium.
Suitable salts and esters of mecoprop include mecoprop-butotyl, mecoprop-dimethylammonium, mecoprop-diolamine, mecoprop-ethadyl, mecoprop-2-ethylhexyl, mecoprop-isoctyl, mecoprop-methyl, mecoprop-potassium, mecoprop-sodium and mecoprop-trolamine.
Suitable salts of mecoprop-P are for example mecoprop-P-butotyl, mecoprop-P-dimethylammonium, mecoprop-P-2-ethylhexyl, mecoprop-P-isobutyl, mecoprop-P-potassium and mecoprop-P-sodium.
A suitable salt of diflufenzopyr is for example diflufenzopyr-sodium.
A suitable salt of naptalam is for example naptalam-sodium.
Suitable salts and esters of aminocyclopyrachlor are for example aminocyclopyrachlor-dimethylammonium, aminocyclopyrachlor-methyl, aminocyclopyrachlor-triisopropanolammonium, aminocyclopyrachlor-sodium and aminocyclopyrachlor-potassium.
A suitable salt of quinclorac is for example quinclorac-dimethylammonium.
A suitable salt of quinmerac is for example quinclorac-dimethylammonium.
A suitable salt of imazamox is for example imazamox-ammonium.
Suitable salts of imazapic are for example imazapic-ammonium and imazapic-isopropylammonium.
Suitable salts of imazapyr are for example imazapyr-ammonium and imazapyr-isopropylammonium.
A suitable salt of imazaquin is for example imazaquin-ammonium.
Suitable salts of imazethapyr are for example imazethapyr-ammonium and imazethapyr-isopropylammonium.
A suitable salt of topramezone is for example topramezone-sodium.

Here and below, the term “binary compositions” includes compositions comprising one or more, for example 1, 2 or 3, herbicides A and either one or more, for example 1, 2 or 3, herbicides B. Correspondingly, the term “ternary compositions” includes compositions comprising one or more, for example 1, 2 or 3, herbicides A, for example 1, 2 or 3, herbicides B and at least one herbicide D.

Further preferred embodiments relate to compositions which correspond to the binary and ternary compositions mentioned above and additionally comprise a safener C, in particular selected from the group consisting of benoxacor (C.1), cloquintocet (C.2), cyprosulfamide (C.3), dichlormid (C.4), fenchlorazole (C.5), fenclorim (C.6), furilazole (C.7), isoxadifen (C.8), mefenpyr (C.9), 4-(dichloroacetyl)-1-oxa-4-azaspiro[4.5]decane (MON4660, CAS 71526-07-3) (C.10) and 2,2,5-trimethyl-3-(dichloroacetyl)-1,3-oxazolidine (R-29148, CAS 52836-31-4) (C.11).

In binary compositions comprising at least one herbicide A and at least one herbicide B, the weight ratio of A:B is generally in the range of from 1:1000 to 1000:1, preferably in the range of from 1:500 to 500:1, in particular in the range of from 1:250 to 250:1 and particularly preferably in the range of from 1:75 to 75:1.

In compositions comprising both at least one herbicide A, at least one herbicide B and at least one safener C, the weight ratio A:B is generally in the range of from 1:1000 to 1000:1, preferably in the range of from 1:500 to 500:1, in particular in the range of from 1:250 to 250:1 and particularly preferably in the range of from 1:75 to 75:1; the weight ratio A:C is generally in the range of from 1:1000 to 1000:1, preferably in the range of from 1:500 to 500:1, in particular in the range of from 1:250 to 250:1 and particularly preferably in the range of from 1:75 to 75:1; and the weight ratio B:C is generally in the range of from 1:1000 to 1000:1, preferably in the range of from 1:500 to 500:1, in particular in the range of from 1:250 to 250:1 and particularly preferably in the range of from 1:75 to 75:1. The weight ratio (A+B):C is preferably in the range of from 1:500 to 500:1, in particular in the range of from 1:250 to 250:1 and particularly preferably in the range of from 1:75 to 75:1.

In ternary compositions comprising at least one herbicide A, at least one herbicide B, and a herbicide D, the weight ratios A:B, A:D and B:D in each case are generally in the range of from 1:1000 to 1000:1, preferably in the range of from 1:500 to 500:1, in particular in the range of from 1:250 to 250:1 and particularly preferably in the range of from 1:75 to 75:1. The weight ratio (A+B):D is preferably in the range of from 1:500 to 500:1, in particular in the range of from 1:250 to 250:1 and particularly preferably in the range of from 1:75 to 75:1. In compositions comprising at least one herbicide A, at least one herbicide B, a herbicide D and at least one safener C, the weight ratios A:B, A:C, A:D, B:C, B:D and C:D in each case are generally in the range of from 1:1000 to 1000:1, preferably in the range of from 1:500 to 500:1, in particular in the range of from 1:250 to 250:1 and particularly preferably in the range of from 1:75 to 75:1. The weight ratio (A+B):C and (A+B):D in each case is preferably in the range of from 1:500 to 500:1, in particular in the range of from 1:250 to 250:1 and particularly preferably in the range of from 1:75 to 75:1. The weight ratio (A+B+D):C is preferably in the range of from 1:250 to 250:1 and particularly preferably in the range of from 1:75 to 75:1.

Particularly preferred are the following compositions of the invention listed in Tables A0 to K11:

TABLE A0

| Composition | | | |
|---|---|---|---|
| No. | Herbicide A | Herbicide B | Herbicide D |
| a1.1 | a1) | B.1 | — |
| a1.2 | a1) | B.2 | — |
| a1.3 | a1) | B.3 | — |
| a1.4 | a1) | B.4 | — |
| a1.5 | a1) | B.5 | — |
| a1.6 | a1) | B.6 | — |
| a1.7 | a1) | B.7 | — |
| a1.8 | a1) | B.8 | — |
| a1.9 | a1) | B.9 | — |
| a1.10 | a1) | B.10 | — |
| a1.11 | a1) | B.11 | — |
| a1.12 | a1) | B.12 | — |
| a1.13 | a1) | B.13 | — |
| a1.14 | a1) | B.14 | — |
| a1.15 | a1) | B.15 | — |
| a1.16 | a1) | B.16 | — |
| a1.17 | a1) | B.17 | — |
| a1.18 | a1) | B.18 | — |
| a1.19 | a1) | B.19 | — |
| a1.20 | a1) | B.20 | — |
| a1.21 | a1) | B.21 | — |
| a1.22 | a1) | B.22 | — |
| a1.23 | a1) | B.23 | — |
| a1.24 | a1) | B.24 | — |
| a1.25 | a1) | B.25 | — |
| a1.26 | a1) | B.26 | — |
| a1.27 | a1) | B.27 | — |
| a1.28 | a1) | B.28 | — |
| a1.29 | a1) | B.29 | — |
| a1.30 | a1) | B.30 | — |
| a1.31 | a1) | B.31 | — |
| a1.32 | a1) | B.32 | — |
| a1.33 | a1) | B.33 | — |
| a1.34 | a1) | B.34 | — |
| a1.35 | a1) | B.35 | — |
| a1.36 | a1) | B.36 | — |
| a1.37 | a1) | B.37 | — |
| a1.38 | a1) | B.38 | — |
| a1.39 | a1) | B.39 | — |
| a1.40 | a1) | B.1 | D.1 |
| a1.41 | a1) | B.2 | D.1 |
| a1.42 | a1) | B.3 | D.1 |
| a1.43 | a1) | B.4 | D.1 |
| a1.44 | a1) | B.5 | D.1 |
| a1.45 | a1) | B.6 | D.1 |
| a1.46 | a1) | B.7 | D.1 |
| a1.47 | a1) | B.8 | D.1 |
| a1.48 | a1) | B.9 | D.1 |
| a1.49 | a1) | B.10 | D.1 |
| a1.50 | a1) | B.11 | D.1 |
| a1.51 | a1) | B.12 | D.1 |
| a1.52 | a1) | B.13 | D.1 |
| a1.53 | a1) | B.14 | D.1 |
| a1.54 | a1) | B.15 | D.1 |
| a1.55 | a1) | B.16 | D.1 |
| a1.56 | a1) | B.17 | D.1 |
| a1.57 | a1) | B.18 | D.1 |
| a1.58 | a1) | B.19 | D.1 |
| a1.59 | a1) | B.20 | D.1 |
| a1.60 | a1) | B.21 | D.1 |
| a1.61 | a1) | B.22 | D.1 |
| a1.62 | a1) | B.23 | D.1 |
| a1.63 | a1) | B.24 | D.1 |
| a1.64 | a1) | B.25 | D.1 |
| a1.65 | a1) | B.26 | D.1 |
| a1.66 | a1) | B.27 | D.1 |
| a1.67 | a1) | B.28 | D.1 |
| a1.68 | a1) | B.29 | D.1 |
| a1.69 | a1) | B.30 | D.1 |
| a1.70 | a1) | B.31 | D.1 |
| a1.71 | a1) | B.32 | D.1 |
| a1.72 | a1) | B.33 | D.1 |
| a1.73 | a1) | B.34 | D.1 |
| a1.74 | a1) | B.35 | D.1 |
| a1.75 | a1) | B.36 | D.1 |
| a1.76 | a1) | B.37 | D.1 |
| a1.77 | a1) | B.38 | D.1 |
| a1.78 | a1) | B.39 | D.1 |
| a1.79 | a1) | B.1 | D.2 |
| a1.80 | a1) | B.2 | D.2 |
| a1.81 | a1) | B.3 | D.2 |
| a1.82 | a1) | B.4 | D.2 |
| a1.83 | a1) | B.5 | D.2 |
| a1.84 | a1) | B.6 | D.2 |
| a1.85 | a1) | B.7 | D.2 |
| a1.86 | a1) | B.8 | D.2 |
| a1.87 | a1) | B.9 | D.2 |
| a1.88 | a1) | B.10 | D.2 |
| a1.89 | a1) | B.11 | D.2 |
| a1.90 | a1) | B.12 | D.2 |
| a1.91 | a1) | B.13 | D.2 |
| a1.92 | a1) | B.14 | D.2 |
| a1.93 | a1) | B.15 | D.2 |
| a1.94 | a1) | B.16 | D.2 |
| a1.95 | a1) | B.17 | D.2 |
| a1.96 | a1) | B.18 | D.2 |
| a1.97 | a1) | B.19 | D.2 |
| a1.98 | a1) | B.20 | D.2 |
| a1.99 | a1) | B.21 | D.2 |
| a1.100 | a1) | B.22 | D.2 |
| a1.101 | a1) | B.23 | D.2 |
| a1.102 | a1) | B.24 | D.2 |
| a1.103 | a1) | B.25 | D.2 |
| a1.104 | a1) | B.26 | D.2 |
| a1.105 | a1) | B.27 | D.2 |
| a1.106 | a1) | B.28 | D.2 |
| a1.107 | a1) | B.29 | D.2 |
| a1.108 | a1) | B.30 | D.2 |
| a1.109 | a1) | B.31 | D.2 |
| a1.110 | a1) | B.32 | D.2 |
| a1.111 | a1) | B.33 | D.2 |
| a1.112 | a1) | B.34 | D.2 |
| a1.113 | a1) | B.35 | D.2 |
| a1.114 | a1) | B.36 | D.2 |
| a1.115 | a1) | B.37 | D.2 |
| a1.116 | a1) | B.38 | D.2 |
| a1.117 | a1) | B.39 | D.2 |
| a1.118 | a1) | B.1 | D.3 |
| a1.119 | a1) | B.2 | D.3 |
| a1.120 | a1) | B.3 | D.3 |
| a1.121 | a1) | B.4 | D.3 |
| a1.122 | a1) | B.5 | D.3 |
| a1.123 | a1) | B.6 | D.3 |
| a1.124 | a1) | B.7 | D.3 |
| a1.125 | a1) | B.8 | D.3 |
| a1.126 | a1) | B.9 | D.3 |
| a1.127 | a1) | B.10 | D.3 |
| a1.128 | a1) | B.11 | D.3 |
| a1.129 | a1) | B.12 | D.3 |
| a1.130 | a1) | B.13 | D.3 |
| a1.131 | a1) | B.14 | D.3 |
| a1.132 | a1) | B.15 | D.3 |
| a1.133 | a1) | B.16 | D.3 |
| a1.134 | a1) | B.17 | D.3 |
| a1.135 | a1) | B.18 | D.3 |
| a1.136 | a1) | B.19 | D.3 |
| a1.137 | a1) | B.20 | D.3 |
| a1.138 | a1) | B.21 | D.3 |
| a1.139 | a1) | B.22 | D.3 |
| a1.140 | a1) | B.23 | D.3 |
| a1.141 | a1) | B.24 | D.3 |
| a1.142 | a1) | B.25 | D.3 |
| a1.143 | a1) | B.26 | D.3 |
| a1.144 | a1) | B.27 | D.3 |
| a1.145 | a1) | B.28 | D.3 |
| a1.146 | a1) | B.29 | D.3 |
| a1.147 | a1) | B.30 | D.3 |
| a1.148 | a1) | B.31 | D.3 |
| a1.149 | a1) | B.32 | D.3 |
| a1.150 | a1) | B.33 | D.3 |
| a1.151 | a1) | B.34 | D.3 |
| a1.152 | a1) | B.35 | D.3 |
| a1.153 | a1) | B.36 | D.3 |
| a1.154 | a1) | B.37 | D.3 |
| a1.155 | a1) | B.38 | D.3 |
| a1.156 | a1) | B.39 | D.3 |
| a1.157 | a1) | B.1 | D.4 |
| a1.158 | a1) | B.2 | D.4 |
| a1.159 | a1) | B.3 | D.4 |
| a1.160 | a1) | B.4 | D.4 |
| a1.161 | a1) | B.5 | D.4 |
| a1.162 | a1) | B.6 | D.4 |
| a1.163 | a1) | B.7 | D.4 |
| a1.164 | a1) | B.8 | D.4 |
| a1.165 | a1) | B.9 | D.4 |
| a1.166 | a1) | B.10 | D.4 |
| a1.167 | a1) | B.11 | D.4 |
| a1.168 | a1) | B.12 | D.4 |
| a1.169 | a1) | B.13 | D.4 |
| a1.170 | a1) | B.14 | D.4 |
| a1.171 | a1) | B.15 | D.4 |
| a1.172 | a1) | B.16 | D.4 |
| a1.173 | a1) | B.17 | D.4 |
| a1.174 | a1) | B.18 | D.4 |
| a1.175 | a1) | B.19 | D.4 |
| a1.176 | a1) | B.20 | D.4 |
| a1.177 | a1) | B.21 | D.4 |
| a1.178 | a1) | B.22 | D.4 |
| a1.179 | a1) | B.23 | D.4 |
| a1.180 | a1) | B.24 | D.4 |
| a1.181 | a1) | B.25 | D.4 |
| a1.182 | a1) | B.26 | D.4 |
| a1.183 | a1) | B.27 | D.4 |
| a1.184 | a1) | B.28 | D.4 |
| a1.185 | a1) | B.29 | D.4 |
| a1.186 | a1) | B.30 | D.4 |
| a1.187 | a1) | B.31 | D.4 |
| a1.188 | a1) | B.32 | D.4 |
| a1.189 | a1) | B.33 | D.4 |
| a1.190 | a1) | B.34 | D.4 |
| a1.191 | a1) | B.35 | D.4 |
| a1.192 | a1) | B.36 | D.4 |
| a1.193 | a1) | B.37 | D.4 |
| a1.194 | a1) | B.38 | D.4 |
| a1.195 | a1) | B.39 | D.4 |
| a1.196 | a1) | B.1 | D.5 |
| a1.197 | a1) | B.2 | D.5 |
| a1.198 | a1) | B.3 | D.5 |
| a1.199 | a1) | B.4 | D.5 |
| a1.200 | a1) | B.5 | D.5 |
| a1.201 | a1) | B.6 | D.5 |
| a1.202 | a1) | B.7 | D.5 |
| a1.203 | a1) | B.8 | D.5 |
| a1.204 | a1) | B.9 | D.5 |
| a1.205 | a1) | B.10 | D.5 |
| a1.206 | a1) | B.11 | D.5 |
| a1.207 | a1) | B.12 | D.5 |
| a1.208 | a1) | B.13 | D.5 |
| a1.209 | a1) | B.14 | D.5 |
| a1.210 | a1) | B.15 | D.5 |
| a1.211 | a1) | B.16 | D.5 |
| a1.212 | a1) | B.17 | D.5 |
| a1.213 | a1) | B.18 | D.5 |
| a1.214 | a1) | B.19 | D.5 |
| a1.215 | a1) | B.20 | D.5 |
| a1.216 | a1) | B.21 | D.5 |
| a1.217 | a1) | B.22 | D.5 |
| a1.218 | a1) | B.23 | D.5 |
| a1.219 | a1) | B.24 | D.5 |
| a1.220 | a1) | B.25 | D.5 |
| a1.221 | a1) | B.26 | D.5 |
| a1.222 | a1) | B.27 | D.5 |
| a1.223 | a1) | B.28 | D.5 |
| a1.224 | a1) | B.29 | D.5 |
| a1.225 | a1) | B.30 | D.5 |
| a1.226 | a1) | B.31 | D.5 |
| a1.227 | a1) | B.32 | D.5 |
| a1.228 | a1) | B.33 | D.5 |
| a1.229 | a1) | B.34 | D.5 |
| a1.230 | a1) | B.35 | D.5 |
| a1.231 | a1) | B.36 | D.5 |
| a1.232 | a1) | B.37 | D.5 |
| a1.233 | a1) | B.38 | D.5 |
| a1.234 | a1) | B.39 | D.5 |
| a1.235 | a1) | B.1 | D.6 |
| a1.236 | a1) | B.2 | D.6 |
| a1.237 | a1) | B.3 | D.6 |
| a1.238 | a1) | B.4 | D.6 |
| a1.239 | a1) | B.5 | D.6 |
| a1.240 | a1) | B.6 | D.6 |
| a1.241 | a1) | B.7 | D.6 |
| a1.242 | a1) | B.8 | D.6 |
| a1.243 | a1) | B.9 | D.6 |
| a1.244 | a1) | B.10 | D.6 |
| a1.245 | a1) | B.11 | D.6 |
| a1.246 | a1) | B.12 | D.6 |
| a1.247 | a1) | B.13 | D.6 |
| a1.248 | a1) | B.14 | D.6 |
| a1.249 | a1) | B.15 | D.6 |
| a1.250 | a1) | B.16 | D.6 |
| a1.251 | a1) | B.17 | D.6 |
| a1.252 | a1) | B.18 | D.6 |
| a1.253 | a1) | B.19 | D.6 |
| a1.254 | a1) | B.20 | D.6 |
| a1.255 | a1) | B.21 | D.6 |
| a1.256 | a1) | B.22 | D.6 |
| a1.257 | a1) | B.23 | D.6 |
| a1.258 | a1) | B.24 | D.6 |
| a1.259 | a1) | B.25 | D.6 |
| a1.260 | a1) | B.26 | D.6 |
| a1.261 | a1) | B.27 | D.6 |
| a1.262 | a1) | B.28 | D.6 |
| a1.263 | a1) | B.29 | D.6 |
| a1.264 | a1) | B.30 | D.6 |
| a1.265 | a1) | B.31 | D.6 |
| a1.266 | a1) | B.32 | D.6 |
| a1.267 | a1) | B.33 | D.6 |
| a1.268 | a1) | B.34 | D.6 |
| a1.269 | a1) | B.35 | D.6 |
| a1.270 | a1) | B.36 | D.6 |
| a1.271 | a1) | B.37 | D.6 |
| a1.272 | a1) | B.38 | D.6 |
| a1.273 | a1) | B.39 | D.6 |
| a1.274 | a1) | B.1 | D.7 |
| a1.275 | a1) | B.2 | D.7 |
| a1.276 | a1) | B.3 | D.7 |
| a1.277 | a1) | B.4 | D.7 |
| a1.278 | a1) | B.5 | D.7 |
| a1.279 | a1) | B.6 | D.7 |
| a1.280 | a1) | B.7 | D.7 |
| a1.281 | a1) | B.8 | D.7 |
| a1.282 | a1) | B.9 | D.7 |
| a1.283 | a1) | B.10 | D.7 |
| a1.284 | a1) | B.11 | D.7 |
| a1.285 | a1) | B.12 | D.7 |
| a1.286 | a1) | B.13 | D.7 |
| a1.287 | a1) | B.14 | D.7 |
| a1.288 | a1) | B.15 | D.7 |
| a1.289 | a1) | B.16 | D.7 |
| a1.290 | a1) | B.17 | D.7 |
| a1.291 | a1) | B.18 | D.7 |
| a1.292 | a1) | B.19 | D.7 |
| a1.293 | a1) | B.20 | D.7 |
| a1.294 | a1) | B.21 | D.7 |
| a1.295 | a1) | B.22 | D.7 |
| a1.296 | a1) | B.23 | D.7 |
| a1.297 | a1) | B.24 | D.7 |
| a1.298 | a1) | B.25 | D.7 |
| a1.299 | a1) | B.26 | D.7 |
| a1.300 | a1) | B.27 | D.7 |
| a1.301 | a1) | B.28 | D.7 |
| a1.302 | a1) | B.29 | D.7 |
| a1.303 | a1) | B.30 | D.7 |
| a1.304 | a1) | B.31 | D.7 |
| a1.305 | a1) | B.32 | D.7 |
| a1.306 | a1) | B.33 | D.7 |
| a1.307 | a1) | B.34 | D.7 |
| a1.308 | a1) | B.35 | D.7 |
| a1.309 | a1) | B.36 | D.7 |
| a1.310 | a1) | B.37 | D.7 |
| a1.311 | a1) | B.38 | D.7 |
| a1.312 | a1) | B.39 | D.7 |
| a1.313 | a1) | B.1 | D.8 |
| a1.314 | a1) | B.2 | D.8 |
| a1.315 | a1) | B.3 | D.8 |
| a1.316 | a1) | B.4 | D.8 |
| a1.317 | a1) | B.5 | D.8 |
| a1.318 | a1) | B.6 | D.8 |
| a1.319 | a1) | B.7 | D.8 |
| a1.320 | a1) | B.8 | D.8 |
| a1.321 | a1) | B.9 | D.8 |
| a1.322 | a1) | B.10 | D.8 |
| a1.323 | a1) | B.11 | D.8 |
| a1.324 | a1) | B.12 | D.8 |
| a1.325 | a1) | B.13 | D.8 |
| a1.326 | a1) | B.14 | D.8 |
| a1.327 | a1) | B.15 | D.8 |
| a1.328 | a1) | B.16 | D.8 |
| a1.329 | a1) | B.17 | D.8 |
| a1.330 | a1) | B.18 | D.8 |
| a1.331 | a1) | B.19 | D.8 |
| a1.332 | a1) | B.20 | D.8 |
| a1.333 | a1) | B.21 | D.8 |
| a1.334 | a1) | B.22 | D.8 |
| a1.335 | a1) | B.23 | D.8 |
| a1.336 | a1) | B.24 | D.8 |
| a1.337 | a1) | B.25 | D.8 |
| a1.338 | a1) | B.26 | D.8 |
| a1.339 | a1) | B.27 | D.8 |
| a1.340 | a1) | B.28 | D.8 |
| a1.341 | a1) | B.29 | D.8 |
| a1.342 | a1) | B.30 | D.8 |
| a1.343 | a1) | B.31 | D.8 |
| a1.344 | a1) | B.32 | D.8 |
| a1.345 | a1) | B.33 | D.8 |
| a1.346 | a1) | B.34 | D.8 |
| a1.347 | a1) | B.35 | D.8 |
| a1.348 | a1) | B.36 | D.8 |
| a1.349 | a1) | B.37 | D.8 |
| a1.350 | a1) | B.38 | D.8 |
| a1.351 | a1) | B.39 | D.8 |
| a1.352 | a1) | B.1 | D.9 |
| a1.353 | a1) | B.2 | D.9 |
| a1.354 | a1) | B.3 | D.9 |
| a1.355 | a1) | B.4 | D.9 |
| a1.356 | a1) | B.5 | D.9 |
| a1.357 | a1) | B.6 | D.9 |
| a1.358 | a1) | B.7 | D.9 |
| a1.359 | a1) | B.8 | D.9 |
| a1.360 | a1) | B.9 | D.9 |
| a1.361 | a1) | B.10 | D.9 |
| a1.362 | a1) | B.11 | D.9 |
| a1.363 | a1) | B.12 | D.9 |
| a1.364 | a1) | B.13 | D.9 |
| a1.365 | a1) | B.14 | D.9 |
| a1.366 | a1) | B.15 | D.9 |
| a1.367 | a1) | B.16 | D.9 |
| a1.368 | a1) | B.17 | D.9 |
| a1.369 | a1) | B.18 | D.9 |
| a1.370 | a1) | B.19 | D.9 |
| a1.371 | a1) | B.20 | D.9 |
| a1.372 | a1) | B.21 | D.9 |
| a1.373 | a1) | B.22 | D.9 |
| a1.374 | a1) | B.23 | D.9 |
| a1.375 | a1) | B.24 | D.9 |
| a1.376 | a1) | B.25 | D.9 |
| a1.377 | a1) | B.26 | D.9 |
| a1.378 | a1) | B.27 | D.9 |
| a1.379 | a1) | B.28 | D.9 |
| a1.380 | a1) | B.29 | D.9 |
| a1.381 | a1) | B.30 | D.9 |
| a1.382 | a1) | B.31 | D.9 |
| a1.383 | a1) | B.32 | D.9 |
| a1.384 | a1) | B.33 | D.9 |
| a1.385 | a1) | B.34 | D.9 |
| a1.386 | a1) | B.35 | D.9 |
| a1.387 | a1) | B.36 | D.9 |
| a1.388 | a1) | B.37 | D.9 |
| a1.389 | a1) | B.38 | D.9 |
| a1.390 | a1) | B.39 | D.9 |
| a1.391 | a1) | B.1 | D.10 |
| a1.392 | a1) | B.2 | D.10 |
| a1.393 | a1) | B.3 | D.10 |
| a1.394 | a1) | B.4 | D.10 |
| a1.395 | a1) | B.5 | D.10 |
| a1.396 | a1) | B.6 | D.10 |
| a1.397 | a1) | B.7 | D.10 |
| a1.398 | a1) | B.8 | D.10 |
| a1.399 | a1) | B.9 | D.10 |
| a1.400 | a1) | B.10 | D.10 |
| a1.401 | a1) | B.11 | D.10 |
| a1.402 | a1) | B.12 | D.10 |
| a1.403 | a1) | B.13 | D.10 |
| a1.404 | a1) | B.14 | D.10 |
| a1.405 | a1) | B.15 | D.10 |
| a1.406 | a1) | B.16 | D.10 |
| a1.407 | a1) | B.17 | D.10 |
| a1.408 | a1) | B.18 | D.10 |
| a1.409 | a1) | B.19 | D.10 |
| a1.410 | a1) | B.20 | D.10 |
| a1.411 | a1) | B.21 | D.10 |
| a1.412 | a1) | B.22 | D.10 |
| a1.413 | a1) | B.23 | D.10 |
| a1.414 | a1) | B.24 | D.10 |
| a1.415 | a1) | B.25 | D.10 |
| a1.416 | a1) | B.26 | D.10 |
| a1.417 | a1) | B.27 | D.10 |
| a1.418 | a1) | B.28 | D.10 |
| a1.419 | a1) | B.29 | D.10 |
| a1.420 | a1) | B.30 | D.10 |
| a1.421 | a1) | B.31 | D.10 |
| a1.422 | a1) | B.32 | D.10 |
| a1.423 | a1) | B.33 | D.10 |
| a1.424 | a1) | B.34 | D.10 |
| a1.425 | a1) | B.35 | D.10 |
| a1.426 | a1) | B.36 | D.10 |
| a1.427 | a1) | B.37 | D.10 |
| a1.428 | a1) | B.38 | D.10 |
| a1.429 | a1) | B.39 | D.10 |
| a1.430 | a1) | B.1 | D.11 |
| a1.431 | a1) | B.2 | D.11 |
| a1.432 | a1) | B.3 | D.11 |
| a1.433 | a1) | B.4 | D.11 |
| a1.434 | a1) | B.5 | D.11 |
| a1.435 | a1) | B.6 | D.11 |
| a1.436 | a1) | B.7 | D.11 |
| a1.437 | a1) | B.8 | D.11 |
| a1.438 | a1) | B.9 | D.11 |
| a1.439 | a1) | B.10 | D.11 |
| a1.440 | a1) | B.11 | D.11 |
| a1.441 | a1) | B.12 | D.11 |
| a1.442 | a1) | B.13 | D.11 |
| a1.443 | a1) | B.14 | D.11 |
| a1.444 | a1) | B.15 | D.11 |
| a1.445 | a1) | B.16 | D.11 |
| a1.446 | a1) | B.17 | D.11 |
| a1.447 | a1) | B.18 | D.11 |
| a1.448 | a1) | B.19 | D.11 |
| a1.449 | a1) | B.20 | D.11 |
| a1.450 | a1) | B.21 | D.11 |
| a1.451 | a1) | B.22 | D.11 |
| a1.452 | a1) | B.23 | D.11 |
| a1.453 | a1) | B.24 | D.11 |
| a1.454 | a1) | B.25 | D.11 |
| a1.455 | a1) | B.26 | D.11 |
| a1.456 | a1) | B.27 | D.11 |
| a1.457 | a1) | B.28 | D.11 |
| a1.458 | a1) | B.29 | D.11 |
| a1.459 | a1) | B.30 | D.11 |
| a1.460 | a1) | B.31 | D.11 |
| a1.461 | a1) | B.32 | D.11 |
| a1.462 | a1) | B.33 | D.11 |
| a1.463 | a1) | B.34 | D.11 |
| a1.464 | a1) | B.35 | D.11 |
| a1.465 | a1) | B.36 | D.11 |
| a1.466 | a1) | B.37 | D.11 |
| a1.467 | a1) | B.38 | D.11 |
| a1.468 | a1) | B.39 | D.11 |
| a1.469 | a1) | B.1 | D.12 |
| a1.470 | a1) | B.2 | D.12 |
| a1.471 | a1) | B.3 | D.12 |
| a1.472 | a1) | B.4 | D.12 |
| a1.473 | a1) | B.5 | D.12 |
| a1.474 | a1) | B.6 | D.12 |
| a1.475 | a1) | B.7 | D.12 |
| a1.476 | a1) | B.8 | D.12 |
| a1.477 | a1) | B.9 | D.12 |
| a1.478 | a1) | B.10 | D.12 |
| a1.479 | a1) | B.11 | D.12 |
| a1.480 | a1) | B.12 | D.12 |
| a1.481 | a1) | B.13 | D.12 |
| a1.482 | a1) | B.14 | D.12 |
| a1.483 | a1) | B.15 | D.12 |
| a1.484 | a1) | B.16 | D.12 |
| a1.485 | a1) | B.17 | D.12 |
| a1.486 | a1) | B.18 | D.12 |
| a1.487 | a1) | B.19 | D.12 |
| a1.488 | a1) | B.20 | D.12 |
| a1.489 | a1) | B.21 | D.12 |
| a1.490 | a1) | B.22 | D.12 |
| a1.491 | a1) | B.23 | D.12 |
| a1.492 | a1) | B.24 | D.12 |
| a1.493 | a1) | B.25 | D.12 |
| a1.494 | a1) | B.26 | D.12 |
| a1.495 | a1) | B.27 | D.12 |
| a1.496 | a1) | B.28 | D.12 |
| a1.497 | a1) | B.29 | D.12 |
| a1.498 | a1) | B.30 | D.12 |
| a1.499 | a1) | B.31 | D.12 |
| a1.500 | a1) | B.32 | D.12 |
| a1.501 | a1) | B.33 | D.12 |
| a1.502 | a1) | B.34 | D.12 |
| a1.503 | a1) | B.35 | D.12 |
| a1.504 | a1) | B.36 | D.12 |
| a1.505 | a1) | B.37 | D.12 |
| a1.506 | a1) | B.38 | D.12 |
| a1.507 | a1) | B.39 | D.12 |
| a1.508 | a1) | B.1 | D.13 |
| a1.509 | a1) | B.2 | D.13 |
| a1.510 | a1) | B.3 | D.13 |
| a1.511 | a1) | B.4 | D.13 |
| a1.512 | a1) | B.5 | D.13 |
| a1.513 | a1) | B.6 | D.13 |
| a1.514 | a1) | B.7 | D.13 |
| a1.515 | a1) | B.8 | D.13 |
| a1.516 | a1) | B.9 | D.13 |
| a1.517 | a1) | B.10 | D.13 |
| a1.518 | a1) | B.11 | D.13 |
| a1.519 | a1) | B.12 | D.13 |
| a1.520 | a1) | B.13 | D.13 |
| a1.521 | a1) | B.14 | D.13 |
| a1.522 | a1) | B.15 | D.13 |
| a1.523 | a1) | B.16 | D.13 |
| a1.524 | a1) | B.17 | D.13 |
| a1.525 | a1) | B.18 | D.13 |
| a1.526 | a1) | B.19 | D.13 |
| a1.527 | a1) | B.20 | D.13 |
| a1.528 | a1) | B.21 | D.13 |
| a1.529 | a1) | B.22 | D.13 |
| a1.530 | a1) | B.23 | D.13 |
| a1.531 | a1) | B.24 | D.13 |
| a1.532 | a1) | B.25 | D.13 |
| a1.533 | a1) | B.26 | D.13 |
| a1.534 | a1) | B.27 | D.13 |
| a1.535 | a1) | B.28 | D.13 |
| a1.536 | a1) | B.29 | D.13 |
| a1.537 | a1) | B.30 | D.13 |
| a1.538 | a1) | B.31 | D.13 |
| a1.539 | a1) | B.32 | D.13 |
| a1.540 | a1) | B.33 | D.13 |
| a1.541 | a1) | B.34 | D.13 |
| a1.542 | a1) | B.35 | D.13 |
| a1.543 | a1) | B.36 | D.13 |
| a1.544 | a1) | B.37 | D.13 |
| a1.545 | a1) | B.38 | D.13 |
| a1.546 | a1) | B.39 | D.13 |
| a1.547 | a1) | B.1 | D.14 |
| a1.548 | a1) | B.2 | D.14 |
| a1.549 | a1) | B.3 | D.14 |
| a1.550 | a1) | B.4 | D.14 |
| a1.551 | a1) | B.5 | D.14 |
| a1.552 | a1) | B.6 | D.14 |
| a1.553 | a1) | B.7 | D.14 |
| a1.554 | a1) | B.8 | D.14 |
| a1.555 | a1) | B.9 | D.14 |
| a1.556 | a1) | B.10 | D.14 |
| a1.557 | a1) | B.11 | D.14 |
| a1.558 | a1) | B.12 | D.14 |
| a1.559 | a1) | B.13 | D.14 |
| a1.560 | a1) | B.14 | D.14 |
| a1.561 | a1) | B.15 | D.14 |
| a1.562 | a1) | B.16 | D.14 |
| a1.563 | a1) | B.17 | D.14 |
| a1.564 | a1) | B.18 | D.14 |
| a1.565 | a1) | B.19 | D.14 |
| a1.566 | a1) | B.20 | D.14 |
| a1.567 | a1) | B.21 | D.14 |
| a1.568 | a1) | B.22 | D.14 |
| a1.569 | a1) | B.23 | D.14 |
| a1.570 | a1) | B.24 | D.14 |
| a1.571 | a1) | B.25 | D.14 |
| a1.572 | a1) | B.26 | D.14 |
| a1.573 | a1) | B.27 | D.14 |
| a1.574 | a1) | B.28 | D.14 |
| a1.575 | a1) | B.29 | D.14 |
| a1.576 | a1) | B.30 | D.14 |
| a1.577 | a1) | B.31 | D.14 |
| a1.578 | a1) | B.32 | D.14 |
| a1.579 | a1) | B.33 | D.14 |
| a1.580 | a1) | B.34 | D.14 |
| a1.581 | a1) | B.35 | D.14 |
| a1.582 | a1) | B.36 | D.14 |
| a1.583 | a1) | B.37 | D.14 |
| a1.584 | a1) | B.38 | D.14 |
| a1.585 | a1) | B.39 | D.14 |
| a1.586 | a1) | B.1 | D.15 |
| a1.587 | a1) | B.2 | D.15 |
| a1.588 | a1) | B.3 | D.15 |
| a1.589 | a1) | B.4 | D.15 |
| a1.590 | a1) | B.5 | D.15 |
| a1.591 | a1) | B.6 | D.15 |
| a1.592 | a1) | B.7 | D.15 |
| a1.593 | a1) | B.8 | D.15 |
| a1.594 | a1) | B.9 | D.15 |
| a1.595 | a1) | B.10 | D.15 |
| a1.596 | a1) | B.11 | D.15 |
| a1.597 | a1) | B.12 | D.15 |
| a1.598 | a1) | B.13 | D.15 |
| a1.599 | a1) | B.14 | D.15 |
| a1.600 | a1) | B.15 | D.15 |
| a1.601 | a1) | B.16 | D.15 |
| a1.602 | a1) | B.17 | D.15 |
| a1.603 | a1) | B.18 | D.15 |
| a1.604 | a1) | B.19 | D.15 |
| a1.605 | a1) | B.20 | D.15 |
| a1.606 | a1) | B.21 | D.15 |
| a1.607 | a1) | B.22 | D.15 |
| a1.608 | a1) | B.23 | D.15 |
| a1.609 | a1) | B.24 | D.15 |
| a1.610 | a1) | B.25 | D.15 |
| a1.611 | a1) | B.26 | D.15 |
| a1.612 | a1) | B.27 | D.15 |
| a1.613 | a1) | B.28 | D.15 |
| a1.614 | a1) | B.29 | D.15 |
| a1.615 | a1) | B.30 | D.15 |
| a1.616 | a1) | B.31 | D.15 |
| a1.617 | a1) | B.32 | D.15 |
| a1.618 | a1) | B.33 | D.15 |
| a1.619 | a1) | B.34 | D.15 |
| a1.620 | a1) | B.35 | D.15 |
| a1.621 | a1) | B.36 | D.15 |
| a1.622 | a1) | B.37 | D.15 |
| a1.623 | a1) | B.38 | D.15 |
| a1.624 | a1) | B.39 | D.15 |
| a1.625 | a1) | B.1 | D.16 |
| a1.626 | a1) | B.2 | D.16 |
| a1.627 | a1) | B.3 | D.16 |
| a1.628 | a1) | B.4 | D.16 |
| a1.629 | a1) | B.5 | D.16 |
| a1.630 | a1) | B.6 | D.16 |
| a1.631 | a1) | B.7 | D.16 |
| a1.632 | a1) | B.8 | D.16 |
| a1.633 | a1) | B.9 | D.16 |
| a1.634 | a1) | B.10 | D.16 |
| a1.635 | a1) | B.11 | D.16 |
| a1.636 | a1) | B.12 | D.16 |
| a1.637 | a1) | B.13 | D.16 |
| a1.638 | a1) | B.14 | D.16 |
| a1.639 | a1) | B.15 | D.16 |
| a1.640 | a1) | B.16 | D.16 |
| a1.641 | a1) | B.17 | D.16 |
| a1.642 | a1) | B.18 | D.16 |
| a1.643 | a1) | B.19 | D.16 |
| a1.644 | a1) | B.20 | D.16 |
| a1.645 | a1) | B.21 | D.16 |
| a1.646 | a1) | B.22 | D.16 |
| a1.647 | a1) | B.23 | D.16 |
| a1.648 | a1) | B.24 | D.16 |
| a1.649 | a1) | B.25 | D.16 |
| a1.650 | a1) | B.26 | D.16 |
| a1.651 | a1) | B.27 | D.16 |
| a1.652 | a1) | B.28 | D.16 |
| a1.653 | a1) | B.29 | D.16 |
| a1.654 | a1) | B.30 | D.16 |
| a1.655 | a1) | B.31 | D.16 |
| a1.656 | a1) | B.32 | D.16 |
| a1.657 | a1) | B.33 | D.16 |
| a1.658 | a1) | B.34 | D.16 |
| a1.659 | a1) | B.35 | D.16 |
| a1.660 | a1) | B.36 | D.16 |
| a1.661 | a1) | B.37 | D.16 |
| a1.662 | a1) | B.38 | D.16 |
| a1.663 | a1) | B.39 | D.16 |
| a1.664 | a1) | B.1 | D.17 |
| a1.665 | a1) | B.2 | D.17 |
| a1.666 | a1) | B.3 | D.17 |
| a1.667 | a1) | B.4 | D.17 |
| a1.668 | a1) | B.5 | D.17 |
| a1.669 | a1) | B.6 | D.17 |
| a1.670 | a1) | B.7 | D.17 |
| a1.671 | a1) | B.8 | D.17 |
| a1.672 | a1) | B.9 | D.17 |
| a1.673 | a1) | B.10 | D.17 |
| a1.674 | a1) | B.11 | D.17 |
| a1.675 | a1) | B.12 | D.17 |
| a1.676 | a1) | B.13 | D.17 |
| a1.677 | a1) | B.14 | D.17 |
| a1.678 | a1) | B.15 | D.17 |
| a1.679 | a1) | B.16 | D.17 |
| a1.680 | a1) | B.17 | D.17 |
| a1.681 | a1) | B.18 | D.17 |
| a1.682 | a1) | B.19 | D.17 |
| a1.683 | a1) | B.20 | D.17 |
| a1.684 | a1) | B.21 | D.17 |
| a1.685 | a1) | B.22 | D.17 |
| a1.686 | a1) | B.23 | D.17 |
| a1.687 | a1) | B.24 | D.17 |
| a1.688 | a1) | B.25 | D.17 |
| a1.689 | a1) | B.26 | D.17 |
| a1.690 | a1) | B.27 | D.17 |
| a1.691 | a1) | B.28 | D.17 |
| a1.692 | a1) | B.29 | D.17 |
| a1.693 | a1) | B.30 | D.17 |
| a1.694 | a1) | B.31 | D.17 |
| a1.695 | a1) | B.32 | D.17 |
| a1.696 | a1) | B.33 | D.17 |
| a1.697 | a1) | B.34 | D.17 |
| a1.698 | a1) | B.35 | D.17 |
| a1.699 | a1) | B.36 | D.17 |
| a1.700 | a1) | B.37 | D.17 |
| a1.701 | a1) | B.38 | D.17 |
| a1.702 | a1) | B.39 | D.17 |
| a1.703 | a1) | B.1 | D.18 |
| a1.704 | a1) | B.2 | D.18 |
| a1.705 | a1) | B.3 | D.18 |
| a1.706 | a1) | B.4 | D.18 |
| a1.707 | a1) | B.5 | D.18 |
| a1.708 | a1) | B.6 | D.18 |
| a1.709 | a1) | B.7 | D.18 |
| a1.710 | a1) | B.8 | D.18 |
| a1.711 | a1) | B.9 | D.18 |
| a1.712 | a1) | B.10 | D.18 |
| a1.713 | a1) | B.11 | D.18 |
| a1.714 | a1) | B.12 | D.18 |
| a1.715 | a1) | B.13 | D.18 |
| a1.716 | a1) | B.14 | D.18 |
| a1.717 | a1) | B.15 | D.18 |
| a1.718 | a1) | B.16 | D.18 |
| a1.719 | a1) | B.17 | D.18 |
| a1.720 | a1) | B.18 | D.18 |
| a1.721 | a1) | B.19 | D.18 |
| a1.722 | a1) | B.20 | D.18 |
| a1.723 | a1) | B.21 | D.18 |
| a1.724 | a1) | B.22 | D.18 |
| a1.725 | a1) | B.23 | D.18 |
| a1.726 | a1) | B.24 | D.18 |
| a1.727 | a1) | B.25 | D.18 |
| a1.728 | a1) | B.26 | D.18 |
| a1.729 | a1) | B.27 | D.18 |
| a1.730 | a1) | B.28 | D.18 |
| a1.731 | a1) | B.29 | D.18 |
| a1.732 | a1) | B.30 | D.18 |
| a1.733 | a1) | B.31 | D.18 |
| a1.734 | a1) | B.32 | D.18 |
| a1.735 | a1) | B.33 | D.18 |
| a1.736 | a1) | B.34 | D.18 |
| a1.737 | a1) | B.35 | D.18 |
| a1.738 | a1) | B.36 | D.18 |
| a1.739 | a1) | B.37 | D.18 |
| a1.740 | a1) | B.38 | D.18 |
| a1.741 | a1) | B.39 | D.18 |
| a1.742 | a1) | B.1 | D.19 |
| a1.743 | a1) | B.2 | D.19 |
| a1.744 | a1) | B.3 | D.19 |
| a1.745 | a1) | B.4 | D.19 |
| a1.746 | a1) | B.5 | D.19 |
| a1.747 | a1) | B.6 | D.19 |
| a1.748 | a1) | B.7 | D.19 |
| a1.749 | a1) | B.8 | D.19 |
| a1.750 | a1) | B.9 | D.19 |
| a1.751 | a1) | B.10 | D.19 |
| a1.752 | a1) | B.11 | D.19 |
| a1.753 | a1) | B.12 | D.19 |
| a1.754 | a1) | B.13 | D.19 |
| a1.755 | a1) | B.14 | D.19 |
| a1.756 | a1) | B.15 | D.19 |
| a1.757 | a1) | B.16 | D.19 |
| a1.758 | a1) | B.17 | D.19 |
| a1.759 | a1) | B.18 | D.19 |
| a1.760 | a1) | B.19 | D.19 |
| a1.761 | a1) | B.20 | D.19 |
| a1.762 | a1) | B.21 | D.19 |
| a1.763 | a1) | B.22 | D.19 |
| a1.764 | a1) | B.23 | D.19 |
| a1.765 | a1) | B.24 | D.19 |
| a1.766 | a1) | B.25 | D.19 |
| a1.767 | a1) | B.26 | D.19 |
| a1.768 | a1) | B.27 | D.19 |
| a1.769 | a1) | B.28 | D.19 |
| a1.770 | a1) | B.29 | D.19 |
| a1.771 | a1) | B.30 | D.19 |
| a1.772 | a1) | B.31 | D.19 |
| a1.773 | a1) | B.32 | D.19 |
| a1.774 | a1) | B.33 | D.19 |
| a1.775 | a1) | B.34 | D.19 |
| a1.776 | a1) | B.35 | D.19 |
| a1.777 | a1) | B.36 | D.19 |
| a1.778 | a1) | B.37 | D.19 |
| a1.779 | a1) | B.38 | D.19 |
| a1.780 | a1) | B.39 | D.19 |
| a1.781 | a1) | B.1 | D.20 |
| a1.782 | a1) | B.2 | D.20 |
| a1.783 | a1) | B.3 | D.20 |
| a1.784 | a1) | B.4 | D.20 |
| a1.785 | a1) | B.5 | D.20 |
| a1.786 | a1) | B.6 | D.20 |
| a1.787 | a1) | B.7 | D.20 |
| a1.788 | a1) | B.8 | D.20 |
| a1.789 | a1) | B.9 | D.20 |
| a1.790 | a1) | B.10 | D.20 |
| a1.791 | a1) | B.11 | D.20 |
| a1.792 | a1) | B.12 | D.20 |
| a1.793 | a1) | B.13 | D.20 |
| a1.794 | a1) | B.14 | D.20 |
| a1.795 | a1) | B.15 | D.20 |
| a1.796 | a1) | B.16 | D.20 |
| a1.797 | a1) | B.17 | D.20 |
| a1.798 | a1) | B.18 | D.20 |
| a1.799 | a1) | B.19 | D.20 |
| a1.800 | a1) | B.20 | D.20 |
| a1.801 | a1) | B.21 | D.20 |
| a1.802 | a1) | B.22 | D.20 |
| a1.803 | a1) | B.23 | D.20 |
| a1.804 | a1) | B.24 | D.20 |
| a1.805 | a1) | B.25 | D.20 |
| a1.806 | a1) | B.26 | D.20 |
| a1.807 | a1) | B.27 | D.20 |
| a1.808 | a1) | B.28 | D.20 |
| a1.809 | a1) | B.29 | D.20 |
| a1.810 | a1) | B.30 | D.20 |
| a1.811 | a1) | B.31 | D.20 |
| a1.812 | a1) | B.32 | D.20 |
| a1.813 | a1) | B.33 | D.20 |
| a1.814 | a1) | B.34 | D.20 |
| a1.815 | a1) | B.35 | D.20 |
| a1.816 | a1) | B.36 | D.20 |
| a1.817 | a1) | B.37 | D.20 |
| a1.818 | a1) | B.38 | D.20 |
| a1.819 | a1) | B.39 | D.20 |
| a1.820 | a1) | B.1 + B.26 | D.1 |
| a1.821 | a1) | B.2 + B.26 | D.1 |
| a1.822 | a1) | B.3 + B.26 | D.1 |
| a1.823 | a1) | B.4 + B.26 | D.1 |
| a1.824 | a1) | B.5 + B.26 | D.1 |
| a1.825 | a1) | B.6 + B.26 | D.1 |
| a1.826 | a1) | B.7 + B.26 | D.1 |
| a1.827 | a1) | B.8 + B.26 | D.1 |
| a1.828 | a1) | B.9 + B.26 | D.1 |
| a1.829 | a1) | B.10 + B.26 | D.1 |
| a1.830 | a1) | B.11 + B.26 | D.1 |
| a1.831 | a1) | B.12 + B.26 | D.1 |
| a1.832 | a1) | B.13 + B.26 | D.1 |
| a1.833 | a1) | B.14 + B.26 | D.1 |
| a1.834 | a1) | B.15 + B.26 | D.1 |
| a1.835 | a1) | B.16 + B.26 | D.1 |
| a1.836 | a1) | B.17 + B.26 | D.1 |
| a1.837 | a1) | B.18 + B.26 | D.1 |
| a1.838 | a1) | B.19 + B.26 | D.1 |
| a1.839 | a1) | B.20 + B.26 | D.1 |
| a1.840 | a1) | B.21 + B.26 | D.1 |
| a1.841 | a1) | B.22 + B.26 | D.1 |
| a1.842 | a1) | B.23 + B.26 | D.1 |
| a1.843 | a1) | B.24 + B.26 | D.1 |
| a1.844 | a1) | B.25 + B.26 | D.1 |
| a1.845 | a1) | B.27 + B.26 | D.1 |
| a1.846 | a1) | B.28 + B.26 | D.1 |
| a1.847 | a1) | B.29 + B.26 | D.1 |
| a1.848 | a1) | B.30 + B.26 | D.1 |
| a1.849 | a1) | B.31 + B.26 | D.1 |
| a1.850 | a1) | B.32 + B.26 | D.1 |
| a1.851 | a1) | B.33 + B.26 | D.1 |
| a1.852 | a1) | B.34 + B.26 | D.1 |
| a1.853 | a1) | B.35 + B.26 | D.1 |
| a1.854 | a1) | B.36 + B.26 | D.1 |
| a1.855 | a1) | B.37 + B.26 | D.1 |
| a1.856 | a1) | B.38 + B.26 | D.1 |
| a1.857 | a1) | B.39 + B.26 | D.1 |
| a1.858 | a1) | B.1 + B.26 | D.2 |
| a1.859 | a1) | B.2 + B.26 | D.2 |
| a1.860 | a1) | B.3 + B.26 | D.2 |
| a1.861 | a1) | B.4 + B.26 | D.2 |
| a1.862 | a1) | B.5 + B.26 | D.2 |
| a1.863 | a1) | B.6 + B.26 | D.2 |
| a1.864 | a1) | B.7 + B.26 | D.2 |
| a1.865 | a1) | B.8 + B.26 | D.2 |
| a1.866 | a1) | B.9 + B.26 | D.2 |
| a1.867 | a1) | B.10 + B.26 | D.2 |
| a1.868 | a1) | B.11 + B.26 | D.2 |
| a1.869 | a1) | B.12 + B.26 | D.2 |
| a1.870 | a1) | B.13 + B.26 | D.2 |
| a1.871 | a1) | B.14 + B.26 | D.2 |
| a1.872 | a1) | B.15 + B.26 | D.2 |
| a1.873 | a1) | B.16 + B.26 | D.2 |
| a1.874 | a1) | B.17 + B.26 | D.2 |
| a1.875 | a1) | B.18 + B.26 | D.2 |
| a1.876 | a1) | B.19 + B.26 | D.2 |
| a1.877 | a1) | B.20 + B.26 | D.2 |
| a1.878 | a1) | B.21 + B.26 | D.2 |
| a1.879 | a1) | B.22 + B.26 | D.2 |
| a1.880 | a1) | B.23 + B.26 | D.2 |
| a1.881 | a1) | B.24 + B.26 | D.2 |
| a1.882 | a1) | B.25 + B.26 | D.2 |
| a1.883 | a1) | B.27 + B.26 | D.2 |
| a1.884 | a1) | B.28 + B.26 | D.2 |
| a1.885 | a1) | B.29 + B.26 | D.2 |
| a1.886 | a1) | B.30 + B.26 | D.2 |
| a1.887 | a1) | B.31 + B.26 | D.2 |
| a1.888 | a1) | B.32 + B.26 | D.2 |
| a1.889 | a1) | B.33 + B.26 | D.2 |
| a1.890 | a1) | B.34 + B.26 | D.2 |
| a1.891 | a1) | B.35 + B.26 | D.2 |
| a1.892 | a1) | B.36 + B.26 | D.2 |
| a1.893 | a1) | B.37 + B.26 | D.2 |
| a1.894 | a1) | B.38 + B.26 | D.2 |
| a1.895 | a1) | B.39 + B.26 | D.2 |
| a1.896 | a1) | B.1 + B.26 | D.3 |
| a1.897 | a1) | B.2 + B.26 | D.3 |
| a1.898 | a1) | B.3 + B.26 | D.3 |
| a1.899 | a1) | B.4 + B.26 | D.3 |
| a1.900 | a1) | B.5 + B.26 | D.3 |
| a1.901 | a1) | B.6 + B.26 | D.3 |
| a1.902 | a1) | B.7 + B.26 | D.3 |
| a1.903 | a1) | B.8 + B.26 | D.3 |
| a1.904 | a1) | B.9 + B.26 | D.3 |
| a1.905 | a1) | B.10 + B.26 | D.3 |
| a1.906 | a1) | B.11 + B.26 | D.3 |
| a1.907 | a1) | B.12 + B.26 | D.3 |
| a1.908 | a1) | B.13 + B.26 | D.3 |
| a1.909 | a1) | B.14 + B.26 | D.3 |
| a1.910 | a1) | B.15 + B.26 | D.3 |
| a1.911 | a1) | B.16 + B.26 | D.3 |
| a1.912 | a1) | B.17 + B.26 | D.3 |
| a1.913 | a1) | B.18 + B.26 | D.3 |
| a1.914 | a1) | B.19 + B.26 | D.3 |
| a1.915 | a1) | B.20 + B.26 | D.3 |
| a1.916 | a1) | B.21 + B.26 | D.3 |
| a1.917 | a1) | B.22 + B.26 | D.3 |
| a1.918 | a1) | B.23 + B.26 | D.3 |
| a1.919 | a1) | B.24 + B.26 | D.3 |
| a1.920 | a1) | B.25 + B.26 | D.3 |
| a1.921 | a1) | B.27 + B.26 | D.3 |
| a1.922 | a1) | B.28 + B.26 | D.3 |
| a1.923 | a1) | B.29 + B.26 | D.3 |
| a1.924 | a1) | B.30 + B.26 | D.3 |
| a1.925 | a1) | B.31 + B.26 | D.3 |
| a1.926 | a1) | B.32 + B.26 | D.3 |
| a1.927 | a1) | B.33 + B.26 | D.3 |
| a1.928 | a1) | B.34 + B.26 | D.3 |
| a1.929 | a1) | B.35 + B.26 | D.3 |
| a1.930 | a1) | B.36 + B.26 | D.3 |
| a1.931 | a1) | B.37 + B.26 | D.3 |
| a1.932 | a1) | B.38 + B.26 | D.3 |
| a1.933 | a1) | B.39 + B.26 | D.3 |
| a1.934 | a1) | B.1 + B.26 | D.4 |
| a1.935 | a1) | B.2 + B.26 | D.4 |
| a1.936 | a1) | B.3 + B.26 | D.4 |
| a1.937 | a1) | B.4 + B.26 | D.4 |
| a1.938 | a1) | B.5 + B.26 | D.4 |
| a1.939 | a1) | B.6 + B.26 | D.4 |
| a1.940 | a1) | B.7 + B.26 | D.4 |
| a1.941 | a1) | B.8 + B.26 | D.4 |
| a1.942 | a1) | B.9 + B.26 | D.4 |
| a1.943 | a1) | B.10 + B.26 | D.4 |
| a1.944 | a1) | B.11 + B.26 | D.4 |
| a1.945 | a1) | B.12 + B.26 | D.4 |
| a1.946 | a1) | B.13 + B.26 | D.4 |
| a1.947 | a1) | B.14 + B.26 | D.4 |
| a1.948 | a1) | B.15 + B.26 | D.4 |
| a1.949 | a1) | B.16 + B.26 | D.4 |
| a1.950 | a1) | B.17 + B.26 | D.4 |
| a1.951 | a1) | B.18 + B.26 | D.4 |
| a1.952 | a1) | B.19 + B.26 | D.4 |
| a1.953 | a1) | B.20 + B.26 | D.4 |
| a1.954 | a1) | B.21 + B.26 | D.4 |
| a1.955 | a1) | B.22 + B.26 | D.4 |
| a1.956 | a1) | B.23 + B.26 | D.4 |
| a1.957 | a1) | B.24 + B.26 | D.4 |
| a1.958 | a1) | B.25 + B.26 | D.4 |
| a1.959 | a1) | B.27 + B.26 | D.4 |
| a1.960 | a1) | B.28 + B.26 | D.4 |
| a1.961 | a1) | B.29 + B.26 | D.4 |
| a1.962 | a1) | B.30 + B.26 | D.4 |
| a1.963 | a1) | B.31 + B.26 | D.4 |
| a1.964 | a1) | B.32 + B.26 | D.4 |
| a1.965 | a1) | B.33 + B.26 | D.4 |
| a1.966 | a1) | B.34 + B.26 | D.4 |
| a1.967 | a1) | B.35 + B.26 | D.4 |
| a1.968 | a1) | B.36 + B.26 | D.4 |
| a1.969 | a1) | B.37 + B.26 | D.4 |
| a1.970 | a1) | B.38 + B.26 | D.4 |
| a1.971 | a1) | B.39 + B.26 | D.4 |
| a1.972 | a1) | B.1 + B.26 | D.5 |
| a1.973 | a1) | B.2 + B.26 | D.5 |
| a1.974 | a1) | B.3 + B.26 | D.5 |
| a1.975 | a1) | B.4 + B.26 | D.5 |
| a1.976 | a1) | B.5 + B.26 | D.5 |
| a1.977 | a1) | B.6 + B.26 | D.5 |
| a1.978 | a1) | B.7 + B.26 | D.5 |
| a1.979 | a1) | B.8 + B.26 | D.5 |
| a1.980 | a1) | B.9 + B.26 | D.5 |
| a1.981 | a1) | B.10 + B.26 | D.5 |
| a1.982 | a1) | B.11 + B.26 | D.5 |
| a1.983 | a1) | B.12 + B.26 | D.5 |
| a1.984 | a1) | B.13 + B.26 | D.5 |
| a1.985 | a1) | B.14 + B.26 | D.5 |
| a1.986 | a1) | B.15 + B.26 | D.5 |
| a1.987 | a1) | B.16 + B.26 | D.5 |
| a1.988 | a1) | B.17 + B.26 | D.5 |
| a1.989 | a1) | B.18 + B.26 | D.5 |
| a1.990 | a1) | B.19 + B.26 | D.5 |
| a1.991 | a1) | B.20 + B.26 | D.5 |
| a1.992 | a1) | B.21 + B.26 | D.5 |
| a1.993 | a1) | B.22 + B.26 | D.5 |
| a1.994 | a1) | B.23 + B.26 | D.5 |
| a1.995 | a1) | B.24 + B.26 | D.5 |
| a1.996 | a1) | B.25 + B.26 | D.5 |
| a1.997 | a1) | B.27 + B.26 | D.5 |
| a1.998 | a1) | B.28 + B.26 | D.5 |
| a1.999 | a1) | B.29 + B.26 | D.5 |
| a1.1000 | a1) | B.30 + B.26 | D.5 |
| a1.1001 | a1) | B.31 + B.26 | D.5 |
| a1.1002 | a1) | B.32 + B.26 | D.5 |
| a1.1003 | a1) | B.33 + B.26 | D.5 |
| a1.1004 | a1) | B.34 + B.26 | D.5 |
| a1.1005 | a1) | B.35 + B.26 | D.5 |
| a1.1006 | a1) | B.36 + B.26 | D.5 |
| a1.1007 | a1) | B.37 + B.26 | D.5 |
| a1.1008 | a1) | B.38 + B.26 | D.5 |
| a1.1009 | a1) | B.39 + B.26 | D.5 |
| a1.1010 | a1) | B.1 + B.26 | D.6 |
| a1.1011 | a1) | B.2 + B.26 | D.6 |
| a1.1012 | a1) | B.3 + B.26 | D.6 |
| a1.1013 | a1) | B.4 + B.26 | D.6 |
| a1.1014 | a1) | B.5 + B.26 | D.6 |
| a1.1015 | a1) | B.6 + B.26 | D.6 |
| a1.1016 | a1) | B.7 + B.26 | D.6 |
| a1.1017 | a1) | B.8 + B.26 | D.6 |
| a1.1018 | a1) | B.9 + B.26 | D.6 |
| a1.1019 | a1) | B.10 + B.26 | D.6 |
| a1.1020 | a1) | B.11 + B.26 | D.6 |
| a1.1021 | a1) | B.12 + B.26 | D.6 |
| a1.1022 | a1) | B.13 + B.26 | D.6 |
| a1.1023 | a1) | B.14 + B.26 | D.6 |
| a1.1024 | a1) | B.15 + B.26 | D.6 |
| a1.1025 | a1) | B.16 + B.26 | D.6 |
| a1.1026 | a1) | B.17 + B.26 | D.6 |
| a1.1027 | a1) | B.18 + B.26 | D.6 |
| a1.1028 | a1) | B.19 + B.26 | D.6 |
| a1.1029 | a1) | B.20 + B.26 | D.6 |
| a1.1030 | a1) | B.21 + B.26 | D.6 |
| a1.1031 | a1) | B.22 + B.26 | D.6 |
| a1.1032 | a1) | B.23 + B.26 | D.6 |
| a1.1033 | a1) | B.24 + B.26 | D.6 |
| a1.1034 | a1) | B.25 + B.26 | D.6 |
| a1.1035 | a1) | B.27 + B.26 | D.6 |
| a1.1036 | a1) | B.28 + B.26 | D.6 |
| a1.1037 | a1) | B.29 + B.26 | D.6 |
| a1.1038 | a1) | B.30 + B.26 | D.6 |
| a1.1039 | a1) | B.31 + B.26 | D.6 |
| a1.1040 | a1) | B.32 + B.26 | D.6 |
| a1.1041 | a1) | B.33 + B.26 | D.6 |
| a1.1042 | a1) | B.34 + B.26 | D.6 |
| a1.1043 | a1) | B.35 + B.26 | D.6 |
| a1.1044 | a1) | B.36 + B.26 | D.6 |
| a1.1045 | a1) | B.37 + B.26 | D.6 |
| a1.1046 | a1) | B.38 + B.26 | D.6 |
| a1.1047 | a1) | B.39 + B.26 | D.6 |
| a1.1048 | a1) | B.1 + B.26 | D.7 |
| a1.1049 | a1) | B.2 + B.26 | D.7 |
| a1.1050 | a1) | B.3 + B.26 | D.7 |
| a1.1051 | a1) | B.4 + B.26 | D.7 |
| a1.1052 | a1) | B.5 + B.26 | D.7 |
| a1.1053 | a1) | B.6 + B.26 | D.7 |
| a1.1054 | a1) | B.7 + B.26 | D.7 |
| a1.1055 | a1) | B.8 + B.26 | D.7 |
| a1.1056 | a1) | B.9 + B.26 | D.7 |
| a1.1057 | a1) | B.10 + B.26 | D.7 |
| a1.1058 | a1) | B.11 + B.26 | D.7 |
| a1.1059 | a1) | B.12 + B.26 | D.7 |
| a1.1060 | a1) | B.13 + B.26 | D.7 |
| a1.1061 | a1) | B.14 + B.26 | D.7 |
| a1.1062 | a1) | B.15 + B.26 | D.7 |
| a1.1063 | a1) | B.16 + B.26 | D.7 |
| a1.1064 | a1) | B.17 + B.26 | D.7 |
| a1.1065 | a1) | B.18 + B.26 | D.7 |
| a1.1066 | a1) | B.19 + B.26 | D.7 |
| a1.1067 | a1) | B.20 + B.26 | D.7 |
| a1.1068 | a1) | B.21 + B.26 | D.7 |
| a1.1069 | a1) | B.22 + B.26 | D.7 |
| a1.1070 | a1) | B.23 + B.26 | D.7 |
| a1.1071 | a1) | B.24 + B.26 | D.7 |
| a1.1072 | a1) | B.25 + B.26 | D.7 |
| a1.1073 | a1) | B.27 + B.26 | D.7 |
| a1.1074 | a1) | B.28 + B.26 | D.7 |
| a1.1075 | a1) | B.29 + B.26 | D.7 |
| a1.1076 | a1) | B.30 + B.26 | D.7 |
| a1.1077 | a1) | B.31 + B.26 | D.7 |
| a1.1078 | a1) | B.32 + B.26 | D.7 |
| a1.1079 | a1) | B.33 + B.26 | D.7 |
| a1.1080 | a1) | B.34 + B.26 | D.7 |
| a1.1081 | a1) | B.35 + B.26 | D.7 |
| a1.1082 | a1) | B.36 + B.26 | D.7 |
| a1.1083 | a1) | B.37 + B.26 | D.7 |
| a1.1084 | a1) | B.38 + B.26 | D.7 |
| a1.1085 | a1) | B.39 + B.26 | D.7 |
| a1.1086 | a1) | B.1 + B.26 | D.8 |
| a1.1087 | a1) | B.2 + B.26 | D.8 |
| a1.1088 | a1) | B.3 + B.26 | D.8 |
| a1.1089 | a1) | B.4 + B.26 | D.8 |
| a1.1090 | a1) | B.5 + B.26 | D.8 |
| a1.1091 | a1) | B.6 + B.26 | D.8 |
| a1.1092 | a1) | B.7 + B.26 | D.8 |
| a1.1093 | a1) | B.8 + B.26 | D.8 |
| a1.1094 | a1) | B.9 + B.26 | D.8 |
| a1.1095 | a1) | B.10 + B.26 | D.8 |
| a1.1096 | a1) | B.11 + B.26 | D.8 |
| a1.1097 | a1) | B.12 + B.26 | D.8 |
| a1.1098 | a1) | B.13 + B.26 | D.8 |
| a1.1099 | a1) | B.14 + B.26 | D.8 |
| a1.1100 | a1) | B.15 + B.26 | D.8 |
| a1.1101 | a1) | B.16 + B.26 | D.8 |
| a1.1102 | a1) | B.17 + B.26 | D.8 |
| a1.1103 | a1) | B.18 + B.26 | D.8 |
| a1.1104 | a1) | B.19 + B.26 | D.8 |
| a1.1105 | a1) | B.20 + B.26 | D.8 |
| a1.1106 | a1) | B.21 + B.26 | D.8 |
| a1.1107 | a1) | B.22 + B.26 | D.8 |
| a1.1108 | a1) | B.23 + B.26 | D.8 |
| a1.1109 | a1) | B.24 + B.26 | D.8 |
| a1.1110 | a1) | B.25 + B.26 | D.8 |
| a1.1111 | a1) | B.27 + B.26 | D.8 |
| a1.1112 | a1) | B.28 + B.26 | D.8 |
| a1.1113 | a1) | B.29 + B.26 | D.8 |
| a1.1114 | a1) | B.30 + B.26 | D.8 |
| a1.1115 | a1) | B.31 + B.26 | D.8 |
| a1.1116 | a1) | B.32 + B.26 | D.8 |
| a1.1117 | a1) | B.33 + B.26 | D.8 |
| a1.1118 | a1) | B.34 + B.26 | D.8 |
| a1.1119 | a1) | B.35 + B.26 | D.8 |
| a1.1120 | a1) | B.36 + B.26 | D.8 |
| a1.1121 | a1) | B.37 + B.26 | D.8 |
| a1.1122 | a1) | B.38 + B.26 | D.8 |
| a1.1123 | a1) | B.39 + B.26 | D.8 |
| a1.1124 | a1) | B.1 + B.26 | D.9 |
| a1.1125 | a1) | B.2 + B.26 | D.9 |
| a1.1126 | a1) | B.3 + B.26 | D.9 |
| a1.1127 | a1) | B.4 + B.26 | D.9 |
| a1.1128 | a1) | B.5 + B.26 | D.9 |
| a1.1129 | a1) | B.6 + B.26 | D.9 |
| a1.1130 | a1) | B.7 + B.26 | D.9 |
| a1.1131 | a1) | B.8 + B.26 | D.9 |
| a1.1132 | a1) | B.9 + B.26 | D.9 |
| a1.1133 | a1) | B.10 + B.26 | D.9 |
| a1.1134 | a1) | B.11 + B.26 | D.9 |
| a1.1135 | a1) | B.12 + B.26 | D.9 |
| a1.1136 | a1) | B.13 + B.26 | D.9 |
| a1.1137 | a1) | B.14 + B.26 | D.9 |
| a1.1138 | a1) | B.15 + B.26 | D.9 |
| a1.1139 | a1) | B.16 + B.26 | D.9 |
| a1.1140 | a1) | B.17 + B.26 | D.9 |
| a1.1141 | a1) | B.18 + B.26 | D.9 |
| a1.1142 | a1) | B.19 + B.26 | D.9 |
| a1.1143 | a1) | B.20 + B.26 | D.9 |
| a1.1144 | a1) | B.21 + B.26 | D.9 |
| a1.1145 | a1) | B.22 + B.26 | D.9 |
| a1.1146 | a1) | B.23 + B.26 | D.9 |
| a1.1147 | a1) | B.24 + B.26 | D.9 |
| a1.1148 | a1) | B.25 + B.26 | D.9 |
| a1.1149 | a1) | B.27 + B.26 | D.9 |
| a1.1150 | a1) | B.28 + B.26 | D.9 |
| a1.1151 | a1) | B.29 + B.26 | D.9 |
| a1.1152 | a1) | B.30 + B.26 | D.9 |
| a1.1153 | a1) | B.31 + B.26 | D.9 |
| a1.1154 | a1) | B.32 + B.26 | D.9 |
| a1.1155 | a1) | B.33 + B.26 | D.9 |
| a1.1156 | a1) | B.34 + B.26 | D.9 |
| a1.1157 | a1) | B.35 + B.26 | D.9 |
| a1.1158 | a1) | B.36 + B.26 | D.9 |
| a1.1159 | a1) | B.37 + B.26 | D.9 |
| a1.1160 | a1) | B.38 + B.26 | D.9 |
| a1.1161 | a1) | B.39 + B.26 | D.9 |
| a1.1162 | a1) | B.1 + B.26 | D.10 |
| a1.1163 | a1) | B.2 + B.26 | D.10 |
| a1.1164 | a1) | B.3 + B.26 | D.10 |
| a1.1165 | a1) | B.4 + B.26 | D.10 |
| a1.1166 | a1) | B.5 + B.26 | D.10 |
| a1.1167 | a1) | B.6 + B.26 | D.10 |
| a1.1168 | a1) | B.7 + B.26 | D.10 |
| a1.1169 | a1) | B.8 + B.26 | D.10 |
| a1.1170 | a1) | B.9 + B.26 | D.10 |
| a1.1171 | a1) | B.10 + B.26 | D.10 |
| a1.1172 | a1) | B.11 + B.26 | D.10 |
| a1.1173 | a1) | B.12 + B.26 | D.10 |
| a1.1174 | a1) | B.13 + B.26 | D.10 |
| a1.1175 | a1) | B.14 + B.26 | D.10 |
| a1.1176 | a1) | B.15 + B.26 | D.10 |
| a1.1177 | a1) | B.16 + B.26 | D.10 |
| a1.1178 | a1) | B.17 + B.26 | D.10 |
| a1.1179 | a1) | B.18 + B.26 | D.10 |
| a1.1180 | a1) | B.19 + B.26 | D.10 |
| a1.1181 | a1) | B.20 + B.26 | D.10 |
| a1.1182 | a1) | B.21 + B.26 | D.10 |
| a1.1183 | a1) | B.22 + B.26 | D.10 |
| a1.1184 | a1) | B.23 + B.26 | D.10 |
| a1.1185 | a1) | B.24 + B.26 | D.10 |
| a1.1186 | a1) | B.25 + B.26 | D.10 |
| a1.1187 | a1) | B.27 + B.26 | D.10 |
| a1.1188 | a1) | B.28 + B.26 | D.10 |
| a1.1189 | a1) | B.29 + B.26 | D.10 |
| a1.1190 | a1) | B.30 + B.26 | D.10 |
| a1.1191 | a1) | B.31 + B.26 | D.10 |
| a1.1192 | a1) | B.32 + B.26 | D.10 |
| a1.1193 | a1) | B.33 + B.26 | D.10 |
| a1.1194 | a1) | B.34 + B.26 | D.10 |
| a1.1195 | a1) | B.35 + B.26 | D.10 |
| a1.1196 | a1) | B.36 + B.26 | D.10 |
| a1.1197 | a1) | B.37 + B.26 | D.10 |
| a1.1198 | a1) | B.38 + B.26 | D.10 |
| a1.1199 | a1) | B.39 + B.26 | D.10 |
| a1.1200 | a1) | B.1 + B.26 | D.11 |
| a1.1201 | a1) | B.2 + B.26 | D.11 |
| a1.1202 | a1) | B.3 + B.26 | D.11 |
| a1.1203 | a1) | B.4 + B.26 | D.11 |
| a1.1204 | a1) | B.5 + B.26 | D.11 |
| a1.1205 | a1) | B.6 + B.26 | D.11 |
| a1.1206 | a1) | B.7 + B.26 | D.11 |
| a1.1207 | a1) | B.8 + B.26 | D.11 |
| a1.1208 | a1) | B.9 + B.26 | D.11 |
| a1.1209 | a1) | B.10 + B.26 | D.11 |
| a1.1210 | a1) | B.11 + B.26 | D.11 |
| a1.1211 | a1) | B.12 + B.26 | D.11 |
| a1.1212 | a1) | B.13 + B.26 | D.11 |
| a1.1213 | a1) | B.14 + B.26 | D.11 |
| a1.1214 | a1) | B.15 + B.26 | D.11 |
| a1.1215 | a1) | B.16 + B.26 | D.11 |
| a1.1216 | a1) | B.17 + B.26 | D.11 |
| a1.1217 | a1) | B.18 + B.26 | D.11 |
| a1.1218 | a1) | B.19 + B.26 | D.11 |
| a1.1219 | a1) | B.20 + B.26 | D.11 |
| a1.1220 | a1) | B.21 + B.26 | D.11 |
| a1.1221 | a1) | B.22 + B.26 | D.11 |
| a1.1222 | a1) | B.23 + B.26 | D.11 |
| a1.1223 | a1) | B.24 + B.26 | D.11 |
| a1.1224 | a1) | B.25 + B.26 | D.11 |
| a1.1225 | a1) | B.27 + B.26 | D.11 |
| a1.1226 | a1) | B.28 + B.26 | D.11 |
| a1.1227 | a1) | B.29 + B.26 | D.11 |
| a1.1228 | a1) | B.30 + B.26 | D.11 |
| a1.1229 | a1) | B.31 + B.26 | D.11 |
| a1.1230 | a1) | B.32 + B.26 | D.11 |
| a1.1231 | a1) | B.33 + B.26 | D.11 |
| a1.1232 | a1) | B.34 + B.26 | D.11 |
| a1.1233 | a1) | B.35 + B.26 | D.11 |
| a1.1234 | a1) | B.36 + B.26 | D.11 |
| a1.1235 | a1) | B.37 + B.26 | D.11 |
| a1.1236 | a1) | B.38 + B.26 | D.11 |
| a1.1237 | a1) | B.39 + B.26 | D.11 |
| a1.1238 | a1) | B.1 + B.26 | D.12 |
| a1.1239 | a1) | B.2 + B.26 | D.12 |
| a1.1240 | a1) | B.3 + B.26 | D.12 |
| a1.1241 | a1) | B.4 + B.26 | D.12 |
| a1.1242 | a1) | B.5 + B.26 | D.12 |
| a1.1243 | a1) | B.6 + B.26 | D.12 |
| a1.1244 | a1) | B.7 + B.26 | D.12 |
| a1.1245 | a1) | B.8 + B.26 | D.12 |
| a1.1246 | a1) | B.9 + B.26 | D.12 |
| a1.1247 | a1) | B.10 + B.26 | D.12 |
| a1.1248 | a1) | B.11 + B.26 | D.12 |
| a1.1249 | a1) | B.12 + B.26 | D.12 |
| a1.1250 | a1) | B.13 + B.26 | D.12 |
| a1.1251 | a1) | B.14 + B.26 | D.12 |
| a1.1252 | a1) | B.15 + B.26 | D.12 |
| a1.1253 | a1) | B.16 + B.26 | D.12 |
| a1.1254 | a1) | B.17 + B.26 | D.12 |
| a1.1255 | a1) | B.18 + B.26 | D.12 |
| a1.1256 | a1) | B.19 + B.26 | D.12 |
| a1.1257 | a1) | B.20 + B.26 | D.12 |
| a1.1258 | a1) | B.21 + B.26 | D.12 |
| a1.1259 | a1) | B.22 + B.26 | D.12 |
| a1.1260 | a1) | B.23 + B.26 | D.12 |
| a1.1261 | a1) | B.24 + B.26 | D.12 |
| a1.1262 | a1) | B.25 + B.26 | D.12 |
| a1.1263 | a1) | B.27 + B.26 | D.12 |
| a1.1264 | a1) | B.28 + B.26 | D.12 |
| a1.1265 | a1) | B.29 + B.26 | D.12 |
| a1.1266 | a1) | B.30 + B.26 | D.12 |
| a1.1267 | a1) | B.31 + B.26 | D.12 |
| a1.1268 | a1) | B.32 + B.26 | D.12 |
| a1.1269 | a1) | B.33 + B.26 | D.12 |
| a1.1270 | a1) | B.34 + B.26 | D.12 |
| a1.1271 | a1) | B.35 + B.26 | D.12 |
| a1.1272 | a1) | B.36 + B.26 | D.12 |
| a1.1273 | a1) | B.37 + B.26 | D.12 |
| a1.1274 | a1) | B.38 + B.26 | D.12 |
| a1.1275 | a1) | B.39 + B.26 | D.12 |
| a1.1276 | a1) | B.15 | D3 + D8 |
| a1.1277 | a1) | B.16 | D3 + D8 |
| a1.1278 | a1) | B.17 | D3 + D8 |
| a1.1279 | a1) | B.18 | D3 + D8 |
| a1.1280 | a1) | B.19 | D3 + D8 |
| a1.1281 | a1) | B.20 | D3 + D8 |
| a1.1282 | a1) | B.21 | D3 + D8 |
| a1.1283 | a1) | B.22 | D3 + D8 |
| a1.1284 | a1) | B.23 | D3 + D8 |
| a1.1285 | a1) | B.24 | D3 + D8 |
| a1.1286 | a1) | B.25 | D3 + D8 |
| a1.1287 | a1) | B.15 | D3 + D9 |
| a1.1288 | a1) | B.16 | D3 + D9 |
| a1.1289 | a1) | B.17 | D3 + D9 |
| a1.1290 | a1) | B.18 | D3 + D9 |
| a1.1291 | a1) | B.19 | D3 + D9 |
| a1.1292 | a1) | B.20 | D3 + D9 |
| a1.1293 | a1) | B.21 | D3 + D9 |
| a1.1294 | a1) | B.22 | D3 + D9 |
| a1.1295 | a1) | B.23 | D3 + D9 |
| a1.1296 | a1) | B.24 | D3 + D9 |
| a1.1297 | a1) | B.25 | D3 + D9 |
| a1.1298 | a1) | B.15 | D3 + D10 |
| a1.1299 | a1) | B.16 | D3 + D10 |
| a1.1300 | a1) | B.17 | D3 + D10 |
| a1.1301 | a1) | B.18 | D3 + D10 |
| a1.1302 | a1) | B.19 | D3 + D10 |
| a1.1303 | a1) | B.20 | D3 + D10 |
| a1.1304 | a1) | B.21 | D3 + D10 |
| a1.1305 | a1) | B.22 | D3 + D10 |
| a1.1306 | a1) | B.23 | D3 + D10 |
| a1.1307 | a1) | B.24 | D3 + D10 |
| a1.1308 | a1) | B.25 | D3 + D10 |
| a1.1309 | a1) | B.15 | D3 + D11 |
| a1.1310 | a1) | B.16 | D3 + D11 |
| a1.1311 | a1) | B.17 | D3 + D11 |
| a1.1312 | a1) | B.18 | D3 + D11 |
| a1.1313 | a1) | B.19 | D3 + D11 |
| a1.1314 | a1) | B.20 | D3 + D11 |
| a1.1315 | a1) | B.21 | D3 + D11 |
| a1.1316 | a1) | B.22 | D3 + D11 |
| a1.1317 | a1) | B.23 | D3 + D11 |
| a1.1318 | a1) | B.24 | D3 + D11 |
| a1.1319 | a1) | B.25 | D3 + D11 |
| a1.1320 | a1) | B.15 | D3 + D20 |
| a1.1321 | a1) | B.16 | D3 + D20 |
| a1.1322 | a1) | B.17 | D3 + D20 |
| a1.1323 | a1) | B.18 | D3 + D20 |
| a1.1324 | a1) | B.19 | D3 + D20 |
| a1.1325 | a1) | B.20 | D3 + D20 |
| a1.1326 | a1) | B.21 | D3 + D20 |
| a1.1327 | a1) | B.22 | D3 + D20 |
| a1.1328 | a1) | B.23 | D3 + D20 |
| a1.1329 | a1) | B.24 | D3 + D20 |
| a1.1330 | a1) | B.25 | D3 + D20 |
| a1.1331 | a1) | B.15 | D4 + D8 |
| a1.1332 | a1) | B.16 | D4 + D8 |
| a1.1333 | a1) | B.17 | D4 + D8 |
| a1.1334 | a1) | B.18 | D4 + D8 |
| a1.1335 | a1) | B.19 | D4 + D8 |
| a1.1336 | a1) | B.20 | D4 + D8 |
| a1.1337 | a1) | B.21 | D4 + D8 |
| a1.1338 | a1) | B.22 | D4 + D8 |
| a1.1339 | a1) | B.23 | D4 + D8 |
| a1.1340 | a1) | B.24 | D4 + D8 |
| a1.1341 | a1) | B.25 | D4 + D8 |
| a1.1342 | a1) | B.15 | D4 + D9 |
| a1.1343 | a1) | B.16 | D4 + D9 |
| a1.1344 | a1) | B.17 | D4 + D9 |
| a1.1345 | a1) | B.18 | D4 + D9 |
| a1.1346 | a1) | B.19 | D4 + D9 |
| a1.1347 | a1) | B.20 | D4 + D9 |
| a1.1348 | a1) | B.21 | D4 + D9 |
| a1.1349 | a1) | B.22 | D4 + D9 |
| a1.1350 | a1) | B.23 | D4 + D9 |
| a1.1351 | a1) | B.24 | D4 + D9 |
| a1.1352 | a1) | B.25 | D4 + D9 |
| a1.1353 | a1) | B.15 | D4 + D10 |
| a1.1354 | a1) | B.16 | D4 + D10 |
| a1.1355 | a1) | B.17 | D4 + D10 |
| a1.1356 | a1) | B.18 | D4 + D10 |
| a1.1357 | a1) | B.19 | D4 + D10 |
| a1.1358 | a1) | B.20 | D4 + D10 |
| a1.1359 | a1) | B.21 | D4 + D10 |
| a1.1360 | a1) | B.22 | D4 + D10 |
| a1.1361 | a1) | B.23 | D4 + D10 |
| a1.1362 | a1) | B.24 | D4 + D10 |
| a1.1363 | a1) | B.25 | D4 + D10 |
| a1.1364 | a1) | B.15 | D4 + D11 |
| a1.1365 | a1) | B.16 | D4 + D11 |
| a1.1366 | a1) | B.17 | D4 + D11 |
| a1.1367 | a1) | B.18 | D4 + D11 |
| a1.1368 | a1) | B.19 | D4 + D11 |
| a1.1369 | a1) | B.20 | D4 + D11 |
| a1.1370 | a1) | B.21 | D4 + D11 |
| a1.1371 | a1) | B.22 | D4 + D11 |
| a1.1372 | a1) | B.23 | D4 + D11 |
| a1.1373 | a1) | B.24 | D4 + D11 |
| a1.1374 | a1) | B.25 | D4 + D11 |
| a1.1375 | a1) | B.15 | D4 + D20 |
| a1.1376 | a1) | B.16 | D4 + D20 |
| a1.1377 | a1) | B.17 | D4 + D20 |
| a1.1378 | a1) | B.18 | D4 + D20 |
| a1.1379 | a1) | B.19 | D4 + D20 |
| a1.1380 | a1) | B.20 | D4 + D20 |
| a1.1381 | a1) | B.21 | D4 + D20 |
| a1.1382 | a1) | B.22 | D4 + D20 |
| a1.1383 | a1) | B.23 | D4 + D20 |
| a1.1384 | a1) | B.24 | D4 + D20 |
| a1.1385 | a1) | B.25 | D4 + D20 |
| a1.1386 | a1) | B.15 | D5 + D8 |
| a1.1387 | a1) | B.16 | D5 + D8 |
| a1.1388 | a1) | B.17 | D5 + D8 |
| a1.1389 | a1) | B.18 | D5 + D8 |
| a1.1390 | a1) | B.19 | D5 + D8 |
| a1.1391 | a1) | B.20 | D5 + D8 |
| a1.1392 | a1) | B.21 | D5 + D8 |
| a1.1393 | a1) | B.22 | D5 + D8 |
| a1.1394 | a1) | B.23 | D5 + D8 |
| a1.1395 | a1) | B.24 | D5 + D8 |
| a1.1396 | a1) | B.25 | D5 + D8 |
| a1.1397 | a1) | B.15 | D5 + D9 |
| a1.1398 | a1) | B.16 | D5 + D9 |
| a1.1399 | a1) | B.17 | D5 + D9 |
| a1.1400 | a1) | B.18 | D5 + D9 |
| a1.1401 | a1) | B.19 | D5 + D9 |
| a1.1402 | a1) | B.20 | D5 + D9 |
| a1.1403 | a1) | B.21 | D5 + D9 |
| a1.1404 | a1) | B.22 | D5 + D9 |
| a1.1405 | a1) | B.23 | D5 + D9 |
| a1.1406 | a1) | B.24 | D5 + D9 |
| a1.1407 | a1) | B.25 | D5 + D9 |
| a1.1408 | a1) | B.15 | D5 + D10 |
| a1.1409 | a1) | B.16 | D5 + D10 |
| a1.1410 | a1) | B.17 | D5 + D10 |
| a1.1411 | a1) | B.18 | D5 + D10 |
| a1.1412 | a1) | B.19 | D5 + D10 |
| a1.1413 | a1) | B.20 | D5 + D10 |
| a1.1414 | a1) | B.21 | D5 + D10 |
| a1.1415 | a1) | B.22 | D5 + D10 |
| a1.1416 | a1) | B.23 | D5 + D10 |
| a1.1417 | a1) | B.24 | D5 + D10 |
| a1.1418 | a1) | B.25 | D5 + D10 |
| a1.1419 | a1) | B.15 | D5 + D11 |
| a1.1420 | a1) | B.16 | D5 + D11 |
| a1.1421 | a1) | B.17 | D5 + D11 |
| a1.1422 | a1) | B.18 | D5 + D11 |
| a1.1423 | a1) | B.19 | D5 + D11 |
| a1.1424 | a1) | B.20 | D5 + D11 |
| a1.1425 | a1) | B.21 | D5 + D11 |
| a1.1426 | a1) | B.22 | D5 + D11 |
| a1.1427 | a1) | B.23 | D5 + D11 |
| a1.1428 | a1) | B.24 | D5 + D11 |
| a1.1429 | a1) | B.25 | D5 + D11 |
| a1.1430 | a1) | B.15 | D5 + D20 |
| a1.1431 | a1) | B.16 | D5 + D20 |
| a1.1432 | a1) | B.17 | D5 + D20 |
| a1.1433 | a1) | B.18 | D5 + D20 |
| a1.1434 | a1) | B.19 | D5 + D20 |
| a1.1435 | a1) | B.20 | D5 + D20 |
| a1.1436 | a1) | B.21 | D5 + D20 |
| a1.1437 | a1) | B.22 | D5 + D20 |
| a1.1438 | a1) | B.23 | D5 + D20 |
| a1.1439 | a1) | B.24 | D5 + D20 |
| a1.1440 | a1) | B.25 | D5 + D20 |
| a1.1441 | a1) | B.15 | D6 + D8 |
| a1.1442 | a1) | B.16 | D6 + D8 |
| a1.1443 | a1) | B.17 | D6 + D8 |
| a1.1444 | a1) | B.18 | D6 + D8 |
| a1.1445 | a1) | B.19 | D6 + D8 |
| a1.1446 | a1) | B.20 | D6 + D8 |
| a1.1447 | a1) | B.21 | D6 + D8 |
| a1.1448 | a1) | B.22 | D6 + D8 |
| a1.1449 | a1) | B.23 | D6 + D8 |
| a1.1450 | a1) | B.24 | D6 + D8 |
| a1.1451 | a1) | B.25 | D6 + D8 |
| a1.1452 | a1) | B.15 | D6 + D9 |
| a1.1453 | a1) | B.16 | D6 + D9 |
| a1.1454 | a1) | B.17 | D6 + D9 |
| a1.1455 | a1) | B.18 | D6 + D9 |
| a1.1456 | a1) | B.19 | D6 + D9 |
| a1.1457 | a1) | B.20 | D6 + D9 |
| a1.1458 | a1) | B.21 | D6 + D9 |
| a1.1459 | a1) | B.22 | D6 + D9 |
| a1.1460 | a1) | B.23 | D6 + D9 |
| a1.1461 | a1) | B.24 | D6 + D9 |
| a1.1462 | a1) | B.25 | D6 + D9 |
| a1.1463 | a1) | B.15 | D6 + D10 |
| a1.1464 | a1) | B.16 | D6 + D10 |
| a1.1465 | a1) | B.17 | D6 + D10 |
| a1.1466 | a1) | B.18 | D6 + D10 |
| a1.1467 | a1) | B.19 | D6 + D10 |
| a1.1468 | a1) | B.20 | D6 + D10 |
| a1.1469 | a1) | B.21 | D6 + D10 |
| a1.1470 | a1) | B.22 | D6 + D10 |
| a1.1471 | a1) | B.23 | D6 + D10 |
| a1.1472 | a1) | B.24 | D6 + D10 |
| a1.1473 | a1) | B.25 | D6 + D10 |
| a1.1474 | a1) | B.15 | D6 + D11 |
| a1.1475 | a1) | B.16 | D6 + D11 |
| a1.1476 | a1) | B.17 | D6 + D11 |
| a1.1477 | a1) | B.18 | D6 + D11 |
| a1.1478 | a1) | B.19 | D6 + D11 |
| a1.1479 | a1) | B.20 | D6 + D11 |
| a1.1480 | a1) | B.21 | D6 + D11 |
| a1.1481 | a1) | B.22 | D6 + D11 |
| a1.1482 | a1) | B.23 | D6 + D11 |
| a1.1483 | a1) | B.24 | D6 + D11 |
| a1.1484 | a1) | B.25 | D6 + D11 |
| a1.1485 | a1) | B.15 | D6 + D20 |
| a1.1486 | a1) | B.16 | D6 + D20 |
| a1.1487 | a1) | B.17 | D6 + D20 |
| a1.1488 | a1) | B.18 | D6 + D20 |
| a1.1489 | a1) | B.19 | D6 + D20 |
| a1.1490 | a1) | B.20 | D6 + D20 |
| a1.1491 | a1) | B.21 | D6 + D20 |
| a1.1492 | a1) | B.22 | D6 + D20 |
| a1.1493 | a1) | B.23 | D6 + D20 |
| a1.1494 | a1) | B.24 | D6 + D20 |
| a1.1495 | a1) | B.25 | D6 + D20 |
| a1.1496 | a1) | B.15 | D7 + D8 |
| a1.1497 | a1) | B.16 | D7 + D8 |
| a1.1498 | a1) | B.17 | D7 + D8 |
| a1.1499 | a1) | B.18 | D7 + D8 |
| a1.1500 | a1) | B.19 | D7 + D8 |
| a1.1501 | a1) | B.20 | D7 + D8 |
| a1.1502 | a1) | B.21 | D7 + D8 |
| a1.1503 | a1) | B.22 | D7 + D8 |
| a1.1504 | a1) | B.23 | D7 + D8 |
| a1.1505 | a1) | B.24 | D7 + D8 |
| a1.1506 | a1) | B.25 | D7 + D8 |
| a1.1507 | a1) | B.15 | D7 + D9 |
| a1.1508 | a1) | B.16 | D7 + D9 |
| a1.1509 | a1) | B.17 | D7 + D9 |
| a1.1510 | a1) | B.18 | D7 + D9 |
| a1.1511 | a1) | B.19 | D7 + D9 |
| a1.1512 | a1) | B.20 | D7 + D9 |
| a1.1513 | a1) | B.21 | D7 + D9 |
| a1.1514 | a1) | B.22 | D7 + D9 |
| a1.1515 | a1) | B.23 | D7 + D9 |
| a1.1516 | a1) | B.24 | D7 + D9 |
| a1.1517 | a1) | B.25 | D7 + D9 |
| a1.1518 | a1) | B.15 | D7 + D10 |
| a1.1519 | a1) | B.16 | D7 + D10 |
| a1.1520 | a1) | B.17 | D7 + D10 |
| a1.1521 | a1) | B.18 | D7 + D10 |
| a1.1522 | a1) | B.19 | D7 + D10 |
| a1.1523 | a1) | B.20 | D7 + D10 |
| a1.1524 | a1) | B.21 | D7 + D10 |
| a1.1525 | a1) | B.22 | D7 + D10 |
| a1.1526 | a1) | B.23 | D7 + D10 |
| a1.1527 | a1) | B.24 | D7 + D10 |
| a1.1528 | a1) | B.25 | D7 + D10 |
| a1.1529 | a1) | B.15 | D7 + D11 |
| a1.1530 | a1) | B.16 | D7 + D11 |
| a1.1531 | a1) | B.17 | D7 + D11 |
| a1.1532 | a1) | B.18 | D7 + D11 |
| a1.1533 | a1) | B.19 | D7 + D11 |
| a1.1534 | a1) | B.20 | D7 + D11 |
| a1.1535 | a1) | B.21 | D7 + D11 |
| a1.1536 | a1) | B.22 | D7 + D11 |
| a1.1537 | a1) | B.23 | D7 + D11 |
| a1.1538 | a1) | B.24 | D7 + D11 |
| a1.1539 | a1) | B.25 | D7 + D11 |
| a1.1540 | a1) | B.15 | D7 + D20 |
| a1.1541 | a1) | B.16 | D7 + D20 |
| a1.1542 | a1) | B.17 | D7 + D20 |
| a1.1543 | a1) | B.18 | D7 + D20 |
| a1.1544 | a1) | B.19 | D7 + D20 |
| a1.1545 | a1) | B.20 | D7 + D20 |
| a1.1546 | a1) | B.21 | D7 + D20 |
| a1.1547 | a1) | B.22 | D7 + D20 |
| a1.1548 | a1) | B.23 | D7 + D20 |
| a1.1549 | a1) | B.24 | D7 + D20 |
| a1.1550 | a1) | B.25 | D7 + D20 |

Table A1. Compositions a1.1.c1 to a1.1550.c1 differing from the respective compositions a1.1 to a1.1550 of Table A0 only in that they each additionally comprise benoxacor C.1.
Table A2. Compositions a1.1.c2 to a1.1550.c2 differing from the respective compositions a1.1 to a1.1550 of Table A0 only in that they each additionally comprise cloquintocet C.2.
Table A3. Compositions a1.1.c3 to a1.1550.c3 differing from the respective compositions a1.1 to a1.1550 of Table A0 only in that they each additionally comprise cyprosulfamide C.3.
Table A4. Compositions a1.1.c4 to a1.1550.c4 differing from the respective compositions a1.1 to a1.1550 of Table A0 only in that they each additionally comprise dichlormid C.4.
Table A5. Compositions a1.1.c5 to a1.1550.c5 differing from the respective compositions a1.1 to a1.1550 of Table A0 only in that they each additionally comprise fenclorim C.5.
Table A6. Compositions a1.1.c6 to a1.1550.c6 differing from the respective compositions a1.1 to a1.1550 of Table A0 only in that they each additionally comprise fenchlorazole C.6.
Table A7. Compositions a1.1.c7 to a1.1550.c7 differing from the respective compositions a1.1 to a1.1550 of Table A0 only in that they each additionally comprise furilazole C.7.
Table A8. Compositions a1.1.c8 to a1.1550.c8 differing from the respective compositions a1.1 to a1.1550 of Table A0 only in that they each additionally comprise isoxadifen C.8.
Table A9. Compositions a1.1.c9 to a1.1550.c9 differing from the respective compositions a1.1 to a1.1550 of Table A0 only in that they each additionally comprise mefenpyr C.9.
Table A10. Compositions a1.1.c10 to a1.1550.c10 differing from the respective compositions a1.1 to a1.1550 of Table A0 only in that they each additionally comprise 4-(dichloroacetyl)-1-oxa-4-azaspiro[4.5]decane C.10.
Table A11. Compositions a1.1.c11 to a1.1550.c1.1 differing from the respective compositions a1.1 to a1.1550 of Table A0 only in that they each additionally comprise 2,2,5-trimethyl-3-(dichloroacetyl)-1,3-oxazolidine C.11.
Table B0. Compositions a2.1 to a2.1550 differing from the respective compositions a.1.1 to 1a.1550 of Table A0 only in that in each case component a1) is replaced by a2).
Table B1. Compositions a2.1.c1 to a2.1550.c1 differing from the respective compositions a1.1.c1 to a1.1550.c1 of Table A1 only in that in each case component a1) is replaced by a2).
Table B2. Compositions a2.1.c2 to a2.1550.c2 differing from the respective compositions a1.1.c2 to a1.1550.c2 of Table A2 only in that in each case component a1) is replaced by a2).
Table B3. Compositions a2.1.c3 to a2.1550.c3 differing from the respective compositions a1.1.c3 to a1.1550.c3 of Table A3 only in that in each case component a1) is replaced by a2).
Table B4. Compositions a2.1.c4 to a2.1550.c4 differing from the respective compositions a1.1.c4 to a1.1550.c4 of Table A4 only in that in each case component a1) is replaced by a2).
Table B5. Compositions a2.1.c5 to a2.1550.c5 differing from the respective compositions a1.1.c5 to a1.1550.c5 of Table A5 only in that in each case component a1) is replaced by a2).
Table B6. Compositions a2.1.c6 to a2.1550.c6 differing from the respective compositions a1.1.c6 to a1.1550.c6 of Table A6 only in that in each case component a1) is replaced by a2).
Table B7. Compositions a2.1.c7 to a2.1550.c7 differing from the respective compositions a1.1.c7 to a1.1550.c7 of Table A7 only in that in each case component a1) is replaced by a2).
Table B8. Compositions a2.1.c8 to a2.1550.c8 differing from the respective compositions a1.1.c8 to a1.1550.c8 of Table A8 only in that in each case component a1) is replaced by a2).
Table B9. Compositions a2.1.c9 to a2.1550.c9 differing from the respective compositions a1.1.c9 to a1.1550.c9 of Table A9 only in that in each case component a1) is replaced by a2).
Table B10. Compositions a2.1.c10 to a2.1550.c10 differing from the respective compositions a1.1.c10 to a1.1550.c10 of Table A10 only in that in each case component a1) is replaced by a2).
Table B11. Compositions a2.1.c11 to a2.1550.c11 differing from the respective compositions a1.1.c11 to a1.1550.c11 of Table A11 only in that in each case component a1) is replaced by a2).
Table C0. Compositions a3.1 to a3.1550 differing from the respective compositions a1.1 to a1.1550 of Table A0 only in that in each case component a1) is replaced by a3).
Table C1. Compositions a3.1.c1 to a3.1550.c1 differing from the respective compositions a1.1.c1 to a1.1550.c1 of Table A1 only in that in each case component a1) is replaced by a3).
Table C2. Compositions a3.1.c2 to a3.1550.c2 differing from the respective compositions a1.1.c2 to a1.1550.c2 of Table A2 only in that in each case component a1) is replaced by a3).
Table C3. Compositions a3.1.c3 to a3.1550.c3 differing from the respective compositions a1.1.c3 to a1.1550.c3 of Table A3 only in that in each case component a1) is replaced by a3).
Table C4. Compositions a3.1.c4 to a3.1550.c4 differing from the respective compositions a1.1.c4 to a1.1550.c4 of Table A4 only in that in each case component a1) is replaced by a3).
Table C5. Compositions a3.1.c5 to a3.1550.c5 differing from the respective compositions a1.1.c5 to a1.1550.c5 of Table A5 only in that in each case component a1) is replaced by a3).
Table C6. Compositions a3.1.c6 to a3.1550.c6 differing from the respective compositions a1.1.c6 to a1.1550.c6 of Table A6 only in that in each case component a1) is replaced by a3).
Table C7. Compositions a3.1.c7 to a3.1550.c7 differing from the respective compositions a1.1.c7 to a1.1550.c7 of Table A7 only in that in each case component a1) is replaced by a3).
Table C8. Compositions a3.1.c8 to a3.1550.c8 differing from the respective compositions a1.1.c8 to a1.1550.c8 of Table A8 only in that in each case component a1) is replaced by a3).
Table C9. Compositions a3.1.c9 to a3.1550.c9 differing from the respective compositions a1.1.c9 to a1.1550.c9 of Table A9 only in that in each case component a1) is replaced by a3).
Table C10. Compositions a3.1.c10 to a3.1550.c10 differing from the respective compositions a1.1.c10 to a1.1550.c10 of Table A10 only in that in each case component a1) is replaced by a3).
Table C11. Compositions a3.1.c11 to a3.1550.c11 differing from the respective compositions a1.1.c1 to a1.1550.c11 of Table A11 only in that in each case component a1) is replaced by a3).
Table D0. Compositions a4.1 to a4.1550 differing from the respective compositions a1.1 to a1.1550 of Table A0 only in that in each case component a1) is replaced by a4).
Table D1. Compositions a4.1.c1 to a4.1550.c1 differing from the respective compositions a1.1.c1 to a1.1550.c1 of Table A1 only in that in each case component a1) is replaced by a4).
Table D2. Compositions a4.1.c2 to a4.1550.c2 differing from the respective compositions a1.1.c2 to a1.1550.c2 of Table A2 only in that in each case component a1) is replaced by a4).
Table D3. Compositions a4.1.c3 to a4.1550.c3 differing from the respective compositions a1.1.c3 to a1.1550.c3 of Table A3 only in that in each case component a1) is replaced by a4).
Table D4. Compositions a4.1.c4 to a4.1550.c4 differing from the respective compositions a1.1.c4 to a1.1550.c4 of Table A4 only in that in each case component a1) is replaced by a4).
Table D5. Compositions a4.1.c5 to a4.1550.c5 differing from the respective compositions a1.1.c5 to a1.1550.c5 of Table A5 only in that in each case component a1) is replaced by a4).
Table D6. Compositions a4.1.c6 to a4.1550.c6 differing from the respective compositions a1.1.c6 to a1.1550.c6 of Table A6 only in that in each case component a1) is replaced by a4).
Table D7. Compositions a4.1.c7 to a4.1550.c7 differing from the respective compositions a1.1.c7 to a1.1550.c7 of Table A7 only in that in each case component a1) is replaced by a4).
Table D8. Compositions a4.1.c8 to a4.1550.c8 differing from the respective compositions a1.1.c8 to a1.1550.c8 of Table A8 only in that in each case component a1) is replaced by a4).
Table D9. Compositions a4.1.c9 to a4.1550.c9 differing from the respective compositions a1.1.c9 to a1.1550.c9 of Table A9 only in that in each case component a1) is replaced by a4).
Table D10. Compositions a4.1.c10 to a4.1550.c10 differing from the respective compositions a1.1.c10 to a1.1550.c10 of Table A10 only in that in each case component a1) is replaced by a4).
Table D11. Compositions a4.1.c11 to a4.1550.c11 differing from the respective compositions a1.1.c1 to a1.1550.c11 of Table A11 only in that in each case component a1) is replaced by a4).
Table E0. Compositions a5.1 to a5.1550 differing from the respective compositions a1.1 to a1.1550 of Table A0 only in that in each case component a1) is replaced by a5).
Table E1. Compositions a5.1.c1 to a5.1550.c1 differing from the respective compositions a1.1.c1 to a1.1550.c1 of Table A1 only in that in each case component a1) is replaced by a5).
Table E2. Compositions a5.1.c2 to a5.1550.c2 differing from the respective compositions a1.1.c2 to a1.1550.c2 of Table A2 only in that in each case component a1) is replaced by a5).
Table E3. Compositions a5.1.c3 to a5.1550.c3 differing from the respective compositions a1.1.c3 to a1.1550.c3 of Table A3 only in that in each case component a1) is replaced by a5).
Table E4. Compositions a5.1.c4 to a5.1550.c4 differing from the respective compositions a1.1.c4 to a1.1550.c4 of Table A4 only in that in each case component a1) is replaced by a5).
Table E5. Compositions a5.1.c5 to a5.1550.c5 differing from the respective compositions a1.1.c5 to a1.1550.c5 of Table A5 only in that in each case component a1) is replaced by a5).
Table E6. Compositions a5.1.c6 to a5.1550.c6 differing from the respective compositions a1.1.c6 to a1.1550.c6 of Table A6 only in that in each case component a1) is replaced by a5).
Table E7. Compositions a5.1.c7 to a5.1550.c7 differing from the respective compositions a1.1.c7 to a1.1550.c7 of Table A7 only in that in each case component a1) is replaced by a5).
Table E8. Compositions a5.1.c8 to a5.1550.c8 differing from the respective compositions a1.1.c8 to a1.1550.c8 of Table A8 only in that in each case component a1) is replaced by a5).
Table E9. Compositions a5.1.c9 to a5.1550.c9 differing from the respective compositions a1.1.c9 to a1.1550.c9 of Table A9 only in that in each case component a1) is replaced by a5).
Table E10. Compositions a5.1.c10 to a5.1550.c10 differing from the respective compositions a1.1.c10 to a1.1550.c10 of Table A10 only in that in each case component a1) is replaced by a5).
Table E11. Compositions a5.1.c11 to a5.1550.c11 differing from the respective compositions a1.1.c1 to a1.1550.c11 of Table A11 only in that in each case component a1) is replaced by a5).
Table F0. Compositions a6.1 to a6.1550 differing from the respective compositions a1.1 to a1.1550 of Table A0 only in that in each case component a1) is replaced by a6).
Table F1. Compositions a6.1.c1 to a6.1550.c1 differing from the respective compositions a1.1.c1 to a1.1550.c1 of Table A1 only in that in each case component a1) is replaced by a6).
Table F2. Compositions a6.1.c2 to a6.1550.c2 differing from the respective compositions a1.1.c2 to a1.1550.c2 of Table A2 only in that in each case component a1) is replaced by a6).
Table F3. Compositions a6.1.c3 to a6.1550.c3 differing from the respective compositions a1.1.c3 to a1.1550.c3 of Table A3 only in that in each case component a1) is replaced by a6).
Table F4. Compositions a6.1.c4 to a6.1550.c4 differing from the respective compositions a1.1.c4 to a1.1550.c4 of Table A4 only in that in each case component a1) is replaced by a6).
Table F5. Compositions a6.1.c5 to a6.1550.c5 differing from the respective compositions a1.1.c5 to a1.1550.c5 of Table A5 only in that in each case component a1) is replaced by a6).
Table F6. Compositions a6.1.c6 to a6.1550.c6 differing from the respective compositions a1.1.c6 to a1.1550.c6 of Table A6 only in that in each case component a1) is replaced by a6).
Table F7. Compositions a6.1.c7 to a6.1550.c7 differing from the respective compositions a1.1.c7 to a1.1550.c7 of Table A7 only in that in each case component a1) is replaced by a6).
Table F8. Compositions a6.1.c8 to a6.1550.c8 differing from the respective compositions a1.1.c8 to a1.1550.c8 of Table A8 only in that in each case component a1) is replaced by a6).
Table F9. Compositions a6.1.c9 to a6.1550.c9 differing from the respective compositions a1.1.c9 to a1.1550.c9 of Table A9 only in that in each case component a1) is replaced by a6).
Table F10. Compositions a6.1.c10 to a6.1550.c differing from the respective compositions a1.1.c10 to a1.1550.c10 of Table A10 only in that in each case component a1) is replaced by a6).
Table F11. Compositions a6.1.c11 to a6.1550.c11 differing from the respective compositions a1.1.c1 to a1.1550.c11 of Table A11 only in that in each case component a1) is replaced by a6).
Table G0. Compositions a7.1 to a7.1550 differing from the respective compositions a1.1 to a1.1550 of Table A0 only in that in each case component a1) is replaced by a7).
Table G1. Compositions a7.1.c1 to a7.1550.c1 differing from the respective compositions a1.1.c1 to a1.1550.c1 of Table A1 only in that in each case component a1) is replaced by a7).
Table G2. Compositions a7.1.c2 to a7.1550.c2 differing from the respective compositions a1.1.c2 to a1.1550.c2 of Table A2 only in that in each case component a1) is replaced by a7).
Table G3. Compositions a7.1.c3 to a7.1550.c3 differing from the respective compositions a1.1.c3 to a1.1550.c3 of Table A3 only in that in each case component a1) is replaced by a7).
Table G4. Compositions a7.1.c4 to a7.1550.c4 differing from the respective compositions a1.1.c4 to a1.1550.c4 of Table A4 only in that in each case component a1) is replaced by a7).
Table G5. Compositions a7.1.c5 to a7.1550.c5 differing from the respective compositions a1.1.c5 to a1.1550.c5 of Table A5 only in that in each case component a1) is replaced by a7).
Table G6. Compositions a7.1.c6 to a7.1550.c6 differing from the respective compositions a1.1.c6 to a1.1550.c6 of Table A6 only in that in each case component a1) is replaced by a7).
Table G7. Compositions a7.1.c7 to a7.1550.c7 differing from the respective compositions a1.1.c7 to a1.1550.c7 of Table A7 only in that in each case component a1) is replaced by a7).
Table G8. Compositions a7.1.c8 to a7.1550.c8 differing from the respective compositions a1.1.c8 to a1.1550.c8 of Table A8 only in that in each case component a1) is replaced by a7).
Table G9. Compositions a7.1.c9 to a7.1550.c9 differing from the respective compositions a1.1.c9 to a1.1550.c9 of Table A9 only in that in each case component a1) is replaced by a7).
Table G10. Compositions a7.1.c10 to a7.1550.c differing from the respective compositions a1.1.c10 to a1.1550.c10 of Table A10 only in that in each case component a1) is replaced by a7).
Table G11. Compositions a7.1.c11 to a7.1550.c11 differing from the respective compositions a1.1.c1 to a1.1550.c11 of Table A11 only in that in each case component a1) is replaced by a7).
Table H0. Compositions a8.1 to a8.1550 differing from the respective compositions a1.1 to a1.1550 of Table A0 only in that in each case component a1) is replaced by a8).
Table H1. Compositions a8.1.c1 to a8.1550.c1 differing from the respective compositions a1.1.c1 to a1.1550.c1 of Table A1 only in that in each case component a1) is replaced by a8).
Table H2. Compositions a8.1.c2 to a8.1550.c2 differing from the respective compositions a1.1.c2 to a1.1550.c2 of Table A2 only in that in each case component a1) is replaced by a8).
Table H3. Compositions a8.1.c3 to a8.1550.c3 differing from the respective compositions a1.1.c3 to a1.1550.c3 of Table A3 only in that in each case component a1) is replaced by a8).
Table H4. Compositions a8.1.c4 to a8.1550.c4 differing from the respective compositions a1.1.c4 to a1.1550.c4 of Table A4 only in that in each case component a1) is replaced by a8).
Table H5. Compositions a8.1.c5 to a8.1550.c5 differing from the respective compositions a1.1.c5 to a1.1550.c5 of Table A5 only in that in each case component a1) is replaced by a8).
Table H6. Compositions a8.1.c6 to a8.1550.c6 differing from the respective compositions a1.1.c6 to a1.1550.c6 of Table A6 only in that in each case component a1) is replaced by a8).
Table H7. Compositions a8.1.c7 to a8.1550.c7 differing from the respective compositions a1.1.c7 to a1.1550.c7 of Table A7 only in that in each case component a1) is replaced by a8).
Table H8. Compositions a8.1.c8 to a8.1550.c8 differing from the respective compositions a1.1.c8 to a1.1550.c8 of Table A8 only in that in each case component a1) is replaced by a8).
Table H9. Compositions a8.1.c9 to a8.1550.c9 differing from the respective compositions a1.1.c9 to a1.1550.c9 of Table A9 only in that in each case component a1) is replaced by a8).
Table H10. Compositions a8.1.c10 to a8.1550.c differing from the respective compositions a1.1.c10 to a1.1550.c10 of Table A10 only in that in each case component a1) is replaced by a8).
Table H11. Compositions a8.1.c11 to a8.1550.c11 differing from the respective compositions a1.1.c1 to a1.1550.c11 of Table A11 only in that in each case component a1) is replaced by a8).
Table I0. Compositions a9.1 to a9.1550 differing from the respective compositions a1.1 to a1.1550 of Table A0 only in that in each case component a1) is replaced by a9).
Table I1. Compositions a9.1.c1 to a9.1550.c1 differing from the respective compositions a1.1.c1 to a1.1550.c1 of Table A1 only in that in each case component a1) is replaced by a9).
Table I2. Compositions a9.1.c2 to a9.1550.c2 differing from the respective compositions a1.1.c2 to a1.1550.c2 of Table A2 only in that in each case component a1) is replaced by a9).
Table 13. Compositions a9.1.c3 to a9.1550.c3 differing from the respective compositions a1.1.c3 to a1.1550.c3 of Table A3 only in that in each case component a1) is replaced by a9).
Table I4. Compositions a9.1.c4 to a9.1550.c4 differing from the respective compositions a1.1.c4 to a1.1550.c4 of Table A4 only in that in each case component a1) is replaced by a9).
Table I5. Compositions a9.1.c5 to a9.1550.c5 differing from the respective compositions a1.1.c5 to a1.1550.c5 of Table A5 only in that in each case component a1) is replaced by a9).
Table I6. Compositions a9.1.c6 to a9.1550.c6 differing from the respective compositions a1.1.c6 to a1.1550.c6 of Table A6 only in that in each case component a1) is replaced by a9).
Table I7. Compositions a9.1.c7 to a9.1550.c7 differing from the respective compositions a1.1.c7 to a1.1550.c7 of Table A7 only in that in each case component a1) is replaced by a9).
Table I8. Compositions a9.1.c8 to a9.1550.c8 differing from the respective compositions a1.1.c8 to a1.1550.c8 of Table A8 only in that in each case component a1) is replaced by a9).
Table I9. Compositions a9.1.c9 to a9.1550.c9 differing from the respective compositions a1.1.c9 to a1.1550.c9 of Table A9 only in that in each case component a1) is replaced by a9).
Table I10. Compositions a9.1.c10 to a9.1550.c differing from the respective compositions a1.1.c10 to a1.1550.c10 of Table A10 only in that in each case component a1) is replaced by a9).
Table I11. Compositions a9.1.c11 to a9.1550.c11 differing from the respective compositions a1.1.c1 to a1.1550.c11 of Table A11 only in that in each case component a1) is replaced by a9).
Table J0. Compositions a10.1 to a10.1550 differing from the respective compositions a1.1 to a1.1550 of Table A0 only in that in each case component a1) is replaced by a10).
Table J1. Compositions a10.1.c1 to a10.1550.c1 differing from the respective compositions a1.1.c1 to a1.1550.c1 of Table A1 only in that in each case component a1) is replaced by a10).
Table J2. Compositions a10.1.c2 to a10.1550.c2 differing from the respective compositions a1.1.c2 to a1.1550.c2 of Table A2 only in that in each case component a1) is replaced by a10).
Table J3. Compositions a10.1.c3 to a10.1550.c3 differing from the respective compositions a1.1.c3 to a1.1550.c3 of Table A3 only in that in each case component a1) is replaced by a10).
Table J4. Compositions a10.1.c4 to a10.1550.c4 differing from the respective compositions a1.1.c4 to a1.1550.c4 of Table A4 only in that in each case component a1) is replaced by a10).
Table J5. Compositions a10.1.c5 to a10.1550.c5 differing from the respective compositions a1.1.c5 to a1.1550.c5 of Table A5 only in that in each case component a1) is replaced by a10).
Table J6. Compositions a10.1.c6 to a10.1550.c6 differing from the respective compositions a1.1.c6 to a1.1550.c6 of Table A6 only in that in each case component a1) is replaced by a10).
Table J7. Compositions a10.1.c7 to a10.1550.c7 differing from the respective compositions a1.1.c7 to a1.1550.c7 of Table A7 only in that in each case component a1) is replaced by a10).
Table J8. Compositions a10.1.c8 to a10.1550.c8 differing from the respective compositions a1.1.c8 to a1.1550.c8 of Table A8 only in that in each case component a1) is replaced by a10).
Table J9. Compositions a10.1.c9 to a10.1550.c9 differing from the respective compositions a1.1.c9 to a1.1550.c9 of Table A9 only in that in each case component a1) is replaced by a10).
Table J10. Compositions a10.1.c10 to a10.1550.c differing from the respective compositions a1.1.c10 to a1.1550.c10 of Table A10 only in that in each case component a1) is replaced by a10).
Table J11. Compositions a10.1.c11 to a10.1550.c11 differing from the respective compositions a1.1.c1 to a1.1550.c11 of Table A11 only in that in each case component a1) is replaced by a10).
Table K0. Compositions a11.1 to a11.1550 differing from the respective compositions a1.1 to a1.1550 of Table A0 only in that in each case component a1) is replaced by a11).
Table K1. Compositions a11.1.c1 to a11.1550.c1 differing from the respective compositions a1.1.c1 to a1.1550.c1 of Table A1 only in that in each case component a1) is replaced by a11).
Table K2. Compositions a11.1.c2 to a11.1550.c2 differing from the respective compositions a1.1.c2 to a1.1550.c2 of Table A2 only in that in each case component a1) is replaced by a11).
Table K3. Compositions a11.1.c3 to a11.1550.c3 differing from the respective compositions a1.1.c3 to a1.1550.c3 of Table A3 only in that in each case component a1) is replaced by a11).
Table K4. Compositions a11.1.c4 to a11.1550.c4 differing from the respective compositions a1.1.c4 to a1.1550.c4 of Table A4 only in that in each case component a1) is replaced by a11).
Table K5. Compositions a10.1.c5 to a11.1550.c5 differing from the respective compositions a1.1.c5 to a1.1550.c5 of Table A5 only in that in each case component a1) is replaced by a11).
Table K6. Compositions a11.1.c6 to a11.1550.c6 differing from the respective compositions a1.1.c6 to a1.1550.c6 of Table A6 only in that in each case component a1) is replaced by a11).
Table K7. Compositions a11.1.c7 to a11.1550.c7 differing from the respective compositions a1.1.c7 to a1.1550.c7 of Table A7 only in that in each case component a1) is replaced by a11).
Table K8. Compositions a11.1.c8 to a11.1550.c8 differing from the respective compositions a1.1.c8 to a1.1550.c8 of Table A8 only in that in each case component a1) is replaced by a11).
Table K9. Compositions a11.1.c9 to a11.1550.c9 differing from the respective compositions a1.1.c9 to a1.1550.c9 of Table A9 only in that in each case component a1) is replaced by a11).
Table K10. Compositions a11.1.c10 to a11.1550.c differing from the respective compositions a1.1.c10 to a1.1550.c10 of Table A10 only in that in each case component a1) is replaced by a11).
Table K11. Compositions a11.1.c11 to a11.1550.c11 differing from the respective compositions a1.1.c11 to a1.1550.c11 of Table A11 only in that in each case component a1) is replaced by a11).

The invention also relates to agrochemical compositions comprising an auxiliary and at least one composition according to the invention.

An agrochemical composition comprises a pesticidally effective amount of at least one composition according to the invention. The term “effective amount” denotes an amount of the active ingredients, which is sufficient for controlling unwanted plants, especially for controlling unwanted plants in cultivated plants and which does not result in a substantial damage to the treated plants. Such an amount can vary in a broad range and is dependent on various factors, such as the plants to be controlled, the treated cultivated plant or material, the climatic conditions and the specific composition according to the invention used.

The compounds A and B and optionally C and D, their salts or derivatives can be converted into customary types of agrochemical compositions, e.g. solutions, emulsions, suspensions, dusts, powders, pastes, granules, pressings, capsules, and mixtures thereof. Examples for agrochemical composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further agrochemical compositions types are defined in the “Catalogue of pesticide formulation types and international coding system”, Technical Monograph No. 2, 6^{th} Ed. May 2008, CropLife International.

The agrochemical compositions are prepared in a known manner, such as described by Mollet and Grubemann, Formulation technology, Wiley V C H, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents; oils of vegetable or animal origin; aliphatic, cyclic and aromatic hydrocarbons; alcohols; glycols; DMSO; ketones; esters; fatty acids; phosphonates; amines; amides; and mixtures thereof.

Suitable solid carriers or fillers are mineral earths; polysaccharides; fertilizers; products of vegetable origin, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides, anorganic clays, polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds.

Methods for applying the compositions, respectively, on to plant propagation material, especially seeds include dressing, coating, pelleting, dusting, soaking and in-furrow application methods of the propagation material. Preferably, the compositions, respectively, are applied on to the plant propagation material by a method such that germination is not induced, e. g. by seed dressing, pelleting, coating and dusting.

Various types of oils, wetters, adjuvants, fertilizer, or micronutrients, and further pesticides (e.g. insecticides, fungicides, growth regulators, safeners) may be added to the active ingredients or the compositions comprising them as premix or, if appropriate not until immediately prior to use (tank mix). These agents can be admixed with the compositions according to the invention in a weight ratio of 1:100 to 100:1.

The user applies an agrochemical composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters of the ready-to-use spray liquor are applied per hectare of agricultural useful area.

According to one embodiment, either individual components of the agrochemical composition according to the invention or partially premixed components, e. g. agrochemical components comprising the herbicide A and active compounds from the groups B and optionally C and/or D may be mixed by the user in a spray tank and further auxiliaries and additives may be added, if appropriate.

In a further embodiment, individual components of the agrochemical composition according to the invention such as parts of a kit or parts of a binary or ternary mixture may be mixed by the user himself in a spray tank and further auxiliaries may be added, if appropriate.

In a further embodiment, either individual components of the agrochemical composition according to the invention or partially premixed components, e. g. components comprising the herbicide A and active compounds from the groups B and optionally C and/or D, can be applied jointly (e.g. after tank mix) or consecutively.

Accordingly, one embodiment of the invention relates to 1-component agrochemical compositions comprising at least one herbicide A and at least one further active compound selected from the herbicides B and optionally the safeners C and optionally herbicides D and also a solid or liquid carrier and, if appropriate, one or more surfactants.

Accordingly, another embodiment of the invention relates to 2-component agrochemical compositions comprising a first component comprising the at least one herbicide A, a solid or liquid carrier and, if appropriate, one or more surfactants, and a second component comprising at least one herbicide B, optionally safeners C and/or herbicide D, a solid or liquid carrier and, if appropriate, one or more surfactants.

The herbicides A and the at least one further active compound B and/or C can be formulated and applied jointly or separately, simultaneously or in succession, before, during or after the emergence of the plants. In case of separate application, the order of the application of the active compounds A, B, C and D is of minor importance. The only thing that is important is that the at least one active compound A and the at least one further active compound B and optionally C and/or D are present simultaneously at the site of action, i.e. are at the same time in contact with or taken up by the plant to be controlled.

The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

The compositions according to the invention are applied to the plants mainly by spraying the leaves. Here, the application can be carried out using, for example, water as carrier by customary spraying techniques using spray liquor amounts of from about 50 to 1000 l/ha (for example from 300 to 400 l/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence or together with the seed of a crop plant. It is also possible to apply the compounds and compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (postdirected, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula I according to the invention or the compositions prepared therefrom. Here, the herbicidal compositions can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

When employed in plant protection, the amounts of active compounds applied, i.e. herbicides A and B and, if appropriate, herbicides D and safenets C without formulation auxiliaries, are, depending on the kind of effect desired, from 0.001 to 2 kg per ha, preferably from 0.005 to 2 kg per ha, more preferably from 0.05 to 0.9 kg per ha and in particular from 0.1 to 0.75 kg per ha.

In another embodiment of the invention, the application rate of herbicides A and B and, if appropriate, herbicides D and safenets C, is from 0.001 to 3 kg/ha, preferably from 0.005 to 2.5 kg/ha and in particular from 0.01 to 2 kg/ha of active ingredient (a.i.).

In another preferred embodiment of the invention, the rates of application of herbicides A are from 0.1 g/ha to 3000 g/ha, preferably 10 g/ha to 1000 g/ha, depending on the control target, the season, the target plants and the growth stage.

In another preferred embodiment of the invention, the application rates of herbicides A are in the range from 0.1 g/ha to 5000 g/ha and preferably in the range from 1 g/ha to 2500 g/ha or from 5 g/ha to 2000 g/ha.

In another preferred embodiment of the invention, the application rate of herbicides A is 0.1 to 1000 g/ha, preferably 1 to 750 g/ha, more preferably 5 to 500 g/ha.

The required application rates of herbicides compounds B and optionally D are generally in the range of from 0.0005 kg/ha to 2.5 kg/ha and preferably in the range of from 0.005 kg/ha to 2 kg/ha or 0.01 kg/ha to 1.5 kg/h of a.i.

The required application rates of safeners C are generally in the range of from 0.0005 kg/ha to 2.5 kg/ha and preferably in the range of from 0.005 kg/ha to 2 kg/ha or 0.01 kg/ha to 1.5 kg/h of a.i.

In treatment of plant propagation materials such as seeds, e. g. by dusting, coating or drenching seed, amounts of active compound of from 0.1 to 1000 g, preferably from 1 to 1000 g, more preferably from 1 to 100 g and most preferably from 5 to 100 g, per 100 kilogram of plant propagation material (preferably seeds) are generally required.

In another embodiment of the invention, to treat the seed, the amounts of active compounds applied, i.e. herbicides A and B and, if appropriate, safenets C and/or herbicides D are generally employed in amounts of from 0.001 to 10 kg per 100 kg of seed.

When used in the protection of materials or stored products, the amount of active compound applied depends on the kind of application area and on the desired effect. Amounts customarily applied in the protection of materials are 0.001 g to 2 kg, preferably 0.005 g to 1 kg, of active compound per cubic meter of treated material.

In the methods of the invention it is immaterial whether the herbicide A, and the further herbicide B and optionally the safener C and herbicide D are formulated and applied jointly or separately.

In the case of separate application it is of minor importance, in which order the application takes place. It is only necessary, that the herbicide A and the herbicide B, optionally the herbicide D, and optionally, the safener C are applied in a time frame that allows simultaneous action of the active ingredients on the plants, preferably within a time-frame of at most 14 days, in particular at most 7 days.

Depending on the application method in question, the compositions according to the invention can additionally be employed in a further number of crop plants for eliminating undesirable plants. Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (S. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N.rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays

Especially preferred crops are crops of cereals, corn, soybeans, rice, oilseed rape, cotton, potatoes, peanuts or permanent crops.

The compositions according to the invention can also be used in genetically modified plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted posttranslational modification of protein(s), oligo- or polypeptides. e. g., by inclusion therein of amino acid mutation(s) that permit, decrease, or promote glycosylation or polymer additions such as prenylation, acetylation farnesylation, or PEG moiety attachment.

Plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetylCoA carboxylase (ACCase) inhibitors; or oxynil (i. e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutgenesis and conventional methods of breeding, e. g., Clearfield® summer rape (Canola, BASF SE, Germany) being tolerant to imidazolinones, e. g., imazamox, or ExpressSun® sunflowers (DuPont, USA) being tolerant to sulfonyl ureas, e. g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as delta-endotoxins, e. g., CryIA(b), CryIA(c), CryIF, CryIF(a2), CryIIA(b), CryIIIA, CryIIIB(b1) or Cry9c; vegetative insecticidal proteins (VIP), e. g., VIP1, VIP2, VIP3 or VIP3A; insecticidal proteins of bacteria colonizing nematodes, e. g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoAreductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e. g., WO 02/015701). Further examples of such toxins or genetically modified plants capable of synthesizing such toxins are disclosed, e. g., in EP-A 374 753, WO 93/007278, WO 95/34656, EP-A 427 529, EP-A 451 878, WO 03/18810 und WO 03/52073. The methods for producing such genetically modified plants are generally known to the person skilled in the art and are described, e. g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIPtoxin); NewLeaf® (potato cultivars producing the Cry3A toxin); Bt-Xtra®, NatureGard®, KnockOut®, BiteGard®, Protecta®, Btl 1 (e. g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e. g., potato culti-vars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above.

Furthermore, plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of ingredients or new ingredients, specifically to improve human or animal nutrition, e. g., oil crops that produce health-promoting long-chain omega-3 fatty acids or unsaturated omega-9 fatty acids (e. g., Nexera® rape, Dow AgroSciences, Canada).

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The following examples serve to illustrate the invention.

### EXAMPLES

The herbicidal action of the compositions according to the invention was demonstrated by the following greenhouse experiments:

The culture containers used were plastic pots containing loamy sand with approximately 2-3.0% of organic matter. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly, and grown in the same containers, or they were first grown separately as seedlings and transplanted into the test containers a few days prior to treatment.

Depending on the species, the plants were kept at 10-25° C. and 20-35° C., respectively. The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85.

In the examples below, using the method of S. R. Colby (1967) “Calculating synergistic and antagonistic responses of herbicide combinations”, Weeds 15, p. 22ff., the value E, which is expected if the activity of the individual active compounds is only additive, was calculated.

For the Binary Compositions:

E=X+Y−(X·Y/100)

where
X=percent activity using active compound A at an application rate a;
Y=percent activity using active compound B at an application rate b;
E=expected activity (in %) by A+B at application rates a+b.

For the ternary compositions:

$$E = X + Y + Z - \frac{X \cdot Y + X \cdot Z + Y \cdot Z}{100} + \frac{X \cdot Y \cdot Z}{10000}$$

where
X=percent activity using active compound A at an application rate a;
Y=percent activity using active compound B at an application rate b;
Z=percent activity using active compound D at an application rate d;
E=expected activity (in %) by A+B+D at application rates a+b+d.

If the value found experimentally is higher than the value E calculated according to Colby, a synergistic effect is present.

The plants used in the greenhouse experiments were of the following species:

| Bayer code | Scientific name |
|---|---|
| ABUTH | Abutilon theophrasti |
| AMBEL | Ambrosia artemisiifolia |
| BRADC | Brachiaria decumbens |
| BRAPP | Urochloa platyphylla |
| CHEAL | Chenopodium album |
| COMBE | Commelina benghalensis |
| CYPES | Cyperus esculentus |
| DIGSA | Digitaria sanguinales |
| ECHCG | Echinochloa crus-galli |
| ERBVI | Eriochloa villosa |
| ERICA | Erigeron canadensis |
| HELAN | Helianthus annuus |
| PANDI | Panicum dichotomiflorun |
| PHACA | Phalaris canariensis L. |
| PHBPU | Pharbitis purpurea |
| POLPE | Polygonum persicaria |

note:
100-90%: “very good”;
90-80% “good”.

The results of these tests are given below in the use examples and demonstrate the synergistic effect of the mixtures comprising at least one herbicide A selected from a1) to a6) and at least one herbicide B. In this context, a.i. means active ingredient, based on 100% active ingredient.

For preparation of the mixtures herbicides A were used in form of an aqueous solution comprising 22.5% by weight of the respective herbicide A. The herbicides B and D were used in form of the respective commercially available formulations as identified below. 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (B.14) was used in form of 10% by weight suspension concentrate. If appropriate, the adjuvant DASH® HC was added to the mixtures.

DASH® HC is an emulsifiable concentrate containing fatty acid esters and alkoxylated alcohols-phosphate esters.

The respective mixtures of active ingredients were introduced into the spray liquor used for applying the active compound. In the examples, the solvent used was water.

### Example 1

### Post-Emergence Treatment by the Mixture of Cornexistin (a1))+Glyphosate in from of Isopropylammonium Salt (B.26) (Roundup®)

| application | | | | | |
|---|---|---|---|---|---|
| rate | | herbicidal activity against | | | |
| a.i. in g/ha | | BRADC | | POLPE | |
| a1) | B.26 | found | calculated | found | calculated |
| 125 | — | 50 | — | 60 | — |
| — | 135 | 80 | — | 60 | — |
| 125 | 135 | 95 | 90 | 100 | 84 |

### Example 2

### Post-Emergence Treatment by the Mixture of Cornexistin (a1)+Topramezone (B.25) (CLIO®)

| application | | | | | | | | | |
|---|---|---|---|---|---|---|---|---|---|
| rate a.i. | | herbicidal activity against | | | | | | | |
| in g/ha | | HELAN | | DIGSA | | COMBE | | POLPE | |
| a1) | B.25 | found | calculated | found | calculated | found | calculated | found | calculated |
| 125 | — | 20 | — | 90 | — | 60 | — | 60 | — |
| — | 12.5 | 80 | — | 65 | — | 60 | — | 75 | — |
| 125 | 12.5 | 98 | 84 | 100 | 96.5 | 98 | 84 | 100 | 90 |

### Example 3

### Post-Emergence Treatment by the Mixture of Cornexistin (a1))+Dicamba in Form of its Dimethylammonium Salt (B.32) (BANVEL®)

| application | | | | | | | |
|---|---|---|---|---|---|---|---|
| rate a.i. in | | herbicidal activity against | | | | | |
| g/ha | | HELAN | | ERICA | | AMBEL | |
| a1) | B.32 | found | calculated | found | calculated | found | calculated |
| 125 | — | 20 | — | 40 | — | 65 | — |
| — | 60 | 80 | — | 95 | — | 85 | — |
| 125 | 60 | 100 | 84 | 100 | 97 | 100 | 94.8 |

### Example 4

### Post-Emergence Treatment by the Mixture of Cornexistin (a1))+Saflufenacil (B.12) (KIXOR®)+1% by Weight DASH® HC

| application | | | |
|---|---|---|---|
| rate | herbicidal activity against | | |
| a.i. in g/ha | | PANDI | ERBVI |

| a1) | B.12 | found | calculated | found | calculated |
|---|---|---|---|---|---|
| 62.5 | — | 95 | — | 90 | — |
| — | 6.25 | 95 | — | 80 | — |
| 62.5 | 6.25 | 100 | 99.8 | 100 | 98 |

### Example 5

### Post-Emergence Treatment by the Mixture of Cornexistin (a1))+Indaziflam (B.28) (ALION®)+1% by Weight DASH® HC

| application | | | |
|---|---|---|---|
| rate | herbicidal activity against | | |
| a.i. in g/ha | | PANDI | PHBPU |

| a1) | B.28 | found | calculated | found | calculated |
|---|---|---|---|---|---|
| 31.25 | — | 90 | — | 70 | — |
| — | 31.25 | 80 | — | 98 | — |
| 31.25 | 31.25 | 100 | 98 | 100 | 99.4 |

### Example 6

### Post-Emergence Treatment by the Mixture of Cornexistin (a1))+1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (B.14)+1% by Weight DASH® HC

| application | | | |
|---|---|---|---|
| rate | herbicidal activity against | | |
| a.i. in g/ha | | PANDI | CYPES |

| a1) | B.28 | found | calculated | found | calculated |
|---|---|---|---|---|---|
| 62.5 | — | 95 | — | 0 | — |
| — | 6.25 | 60 | — | 55 | — |
| 62.5 | 6.25 | 100 | 98 | 60 | 55 |

### Example 7

### Post-Emergence Treatment by the Mixture of Cornexistin (a1))+Paraquat in Form of its Dichloride (B.6) (GRAMOXONE®)+1% by Weight DASH® HC

| application | | | |
|---|---|---|---|
| rate | herbicidal activity against | | |
| a.i. in g/ha | | ERICA | PHBPU |

| a1) | B.28 | found | calculated | found | calculated |
|---|---|---|---|---|---|
| 31.25 | — | 40 | — | 70 | — |
| — | 75 | 75 | — | 65 | — |
| 31.25 | 75 | 100 | 85 | 90 | 89.5 |

### Example 8

### Post-Emergence Treatment by the Mixture of Cornexistin (a1))+Glufosinate in Form of its Ammonium Salt (B.27) (BASTA®)+1% by Weight DASH® HC

| | |
|---|---|
| application | herbicidal activity |
| rate | against |
| a.i. in g/ha | ERICA |

| a1) | B.27 | found | calculated |
|---|---|---|---|
| 31.25 | — | 20 | — |
| — | 100 | 65 | — |
| 31.25 | 100 | 75 | 72 |

### Example 9

### Post-Emergence Treatment by the Mixture of Cornexistin (a1))+Topramezone (B.25) (CLIO®)+Atrazine (D.3) (ATRAZINE 4L®)

| | | | herbicidal activity against | | | | | |
|---|---|---|---|---|---|---|---|---|
| application rate | | | ECHCG | | DIGSA | | CHEAL | |
| a.i. in g/ha | | | | cal- | | cal- | | cal- |
| a1) | B.25 | D.3 | found | culated | found | culated | found | culated |
| 31.25 | — | — | 30 | — | 25 | — | 0 | — |
| — | 12.5 | — | 40 | — | 70 | — | 25 | — |
| — | — | 150 | 0 | — | 0 | — | 35 | — |
| 31.25 | 12.5 | 150 | 100 | 58 | 98 | 78 | 100 | 51 |

| | |
|---|---|
| | herbicidal activity against |
| application rate a.i. in g/ha | ABUTH |

| a1) | B.25 | D.3 | found | calculated |
|---|---|---|---|---|
| 31.25 | — | — | 60 | — |
| — | 25 | — | 90 | — |
| — | — | 150 | 60 | — |
| 31.25 | 25 | 150 | 98 | 98 |

### Example 10

### Post-Emergence Treatment by the Mixture of Cornexistin (a1))+Clodinafop-Propargyl (B.2)+Cloquinocet-Mexyl (C2) (Topik®)

| application | | | herbicidal activity against | | | |
|---|---|---|---|---|---|---|
| rate a.i. in g/ha | | | PHACA | | BRAPP | |
| a1) | B.2 | C.2 | found | calculated | found | calculated |
| 31.25 | — | — | 25 | — | 25 | — |
| — | 20 | 5 | 95 | — | 85 | — |
| 31.25 | 20 | 5 | 98 | 96 | 90 | 89 |

### Example 11

### Post-Emergence Treatment by the Mixture of Cornexistin (a1))+Carfentrazone-Ethyl (B.7) (Oratio®)

| | |
|---|---|
| application | herbicidal activity |
| rate | against |
| a.i. in g/ha | AMBEL |

| a1) | B.7 | found | calculated |
|---|---|---|---|
| 62.5 | — | 90 | — |
| — | 15 | 75 | — |
| 62.5 | 15 | 98 | 98 |

### Example 12

### Post-Emergence Treatment by the Mixture of Cornexistin (a1))+Carfentrazone-Ethyl (B.7) (Oratio®)+Glyphosate (B.26) in from of Isopropylammonium Salt (Roundup®)

| | |
|---|---|
| application | herbicidal activity |
| rate | against |
| a.i. in g/ha | AMBEL |

| a1) | B.7 | B.26 | found | calculated |
|---|---|---|---|---|
| 15 | — | — | 35 | — |
| — | 68 | — | 70 | — |
| — | — | 15 | 75 | — |
| 15 | 68 | 15 | 98 | 95 |

1-12. (canceled)

13. A herbicidal composition comprising:
A) at least one compound of formula I (herbicide A) 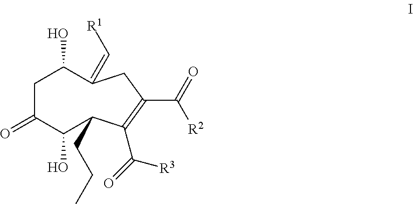
wherein
R¹ is CH₃ or CH₂OH; and
R² and R³ together with the neighboring carbon atoms form a dihydro-2,5-dioxofuran ring or
R² and R³ are OH;
or an agriculturally acceptable salt or derivative thereof;
and
B) at least one active compound selected from herbicides of groups b1) to b15) (herbicide B):
b1) ACC lipid biosynthesis inhibitors;
b3) photosynthesis inhibitors PS I,
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methiozolin (CAS 403640-27-7), methyl azide, methyl bromide, methyl-daimuron, methyl iodide, MSMA, oleic acid, oxaziclomefone, pelargonic acid, pyributicarb, quinoclamine and 6-chloro-3-(2-cyclopropyl-6-methylphenoxy)-4-pyridazinol (CAS 499223-49-3);
including agriculturally acceptable salts and derivatives thereof.

14. The composition of claim 13, wherein at least one compound of formula I is selected from
a1) cornexistin (I.a1) 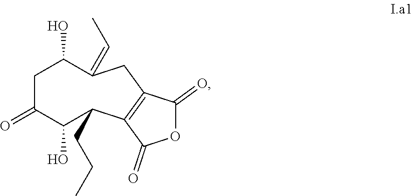 [SMILES: C/C=C1/CC2=C(C(=O)OC2=O)[C@H](CCC)[C@H](O)C(=O)C[C@@H]1O]
a2) the dibasic acid of cornexistin (I.a2) 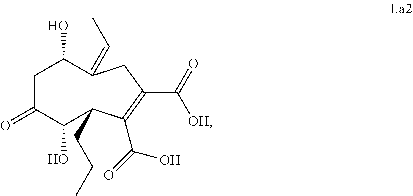 [SMILES: C/C=C1/C/C(C(=O)O)=C(/C(=O)O)[C@H](CCC)[C@H](O)C(=O)C[C@@H]1O]
a3) hydroxycornexistin (I.a3), 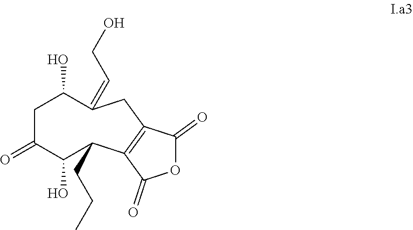 [SMILES: CCC[C@H]1C2=C(C/C(=C/CO)[C@@H](O)CC(=O)[C@H]1O)C(=O)OC2=O]
a4) the dibasic acid of hydroxycornexistin (I.a4), 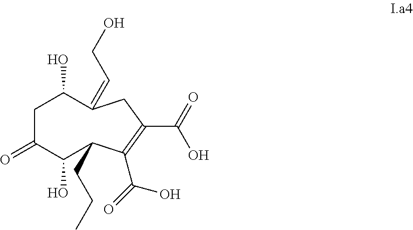 [SMILES: CCC[C@H]1/C(C(=O)O)=C(/C(=O)O)C/C(=C/CO)[C@@H](O)CC(=O)[C@H]1O]
or agriculturally acceptable salt or derivative thereof.

15. The composition of claim 13, comprising as active ingredient A) at least two compounds of formula I selected from
a5) mixtures of cornexistin (I.a1) and the dibasic acid of cornexistin (I.a2),
a6) mixtures of hydroxycornexistin (I.a3) and the dibasic acid of hydroxycornexistin (I.a4),
a7) mixtures of cornexistin (I.a1) and hydroxycornexistin (I.a3),
a8) mixtures of cornexistin (I.a1) and the dibasic acid of hydroxycornexistin (I.a4),
a9) mixtures of the dibasic acid of cornexistin (I.a2) and hydroxycornexistin (I.a3) and
a10) mixtures of the dibasic acid of cornexistin (I.a2) and the dibasic acid of hydroxycornexistin (I.a4)
including agriculturally acceptable salts and derivatives thereof.

16. The composition of claim 13, wherein the herbicide B is selected from the group consisting of
b1) ACC lipid biosynthesis inhibitors: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5);
b3) PS I photosynthesis inhibitors: diquat, diquat-dibromide, paraquat, paraquat-dichloride and paraquat-dimetilsulfate;
b4) protoporphyrinogen-IX oxidase inhibitors: acifluorfen, acifluorfen-sodium, azafenidin, bencarbazone, benzfendizone, bifenox, butafenacil, carfentrazone, carfentrazone-ethyl, chlomethoxyfen, cinidon-ethyl, ethoxyfen-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, N-ethyl-3-(2,6-dichloro-4-trifluoromethylphenoxy)-5-methyl-1H-pyrazole-1-carboxamide, N-tetrahydrofurfuryl-3-(2,6-dichloro-4-trifluoromethylphenoxy)-5-methyl-1H-pyrazole-1-carboxamide, N-ethyl-3-(2-chloro-6-fluoro-4-trifluoromethylphenoxy)-5-methyl-1H-pyrazole-1-carboxamide, N-tetrahydrofurfuryl-3-(2-chloro-6-fluoro-4-trifluoromethylphenoxy)-5-methyl-1H-pyrazole-1-carboxamide, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione and (Z)-4-[2-Chloro-5-(4-chloro-5-difluoromethoxy-1-methyl-1H-pyrazol-3-yl)-4-fluoro-phenoxy]-3-methyl-but-2-enoic acid methyl ester;
b5) bleacher herbicides: PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine, HPPD inhibitors: benzobicyclon, benzofenap, clomazone, isoxaflutole, mesotrione, pyrasulfotole, pyrazolynate, pyrazoxyfen, sulcotrione, tefuryltrione, tembotrione, topramezone and bicyclopyrone, bleacher, unknown target: aclonifen, amitrole and flumeturon;
b6) EPSP synthase inhibitors: glyphosate, glyphosate-isopropylammonium, glyposate-potassium and glyphosate-trimesium (sulfosate);
b7) glutamine synthase inhibitors: bilanaphos (bialaphos), bilanaphos-sodium, glufosinate, glufosinate-P and glufosinate-ammonium;
b8) DHP synthase inhibitors: asulam;
b11) cellulose biosynthesis inhibitors: chlorthiamid, dichlobenil, flupoxam, indaziflam, isoxaben, triaziflam, triazolocarboxamide and 1-cyclohexyl-5-pentafluorphenyloxy-1⁴-[1,2,4,6]thiatriazin-3-ylamine;
b12) decoupler herbicides: dinoseb, dinoterb and DNOC and its salts;
b13) auxinic herbicides: 2,4-D and its salts and esters such as clacyfos, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyr-meptyl, halauxifen and its salts and esters; MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters and triclopyr and its salts and esters;
b14) auxin transport inhibitors: diflufenzopyr, diflufenzopyr-sodium, naptalam and naptalam-sodium; and
b15) other herbicides: bromobutide, chlorflurenol, chlorflurenol-methyl, cinmethylin, cumyluron, cyclopyrimorate (CAS 499223-49-3 Mitsui; SW-065; H-965) and its salts and esters, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine and 6-Chloro-3-(2-cyclopropyl-6-methylphenoxy)-pyrazin-2-ol
including agriculturally acceptable salts and derivatives thereof.

17. The composition of claim 13, wherein the herbicide B is selected from the group consisting of
b1) lipid biosynthesis inhibitors: clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one; 4-(2′,4′-Dichloro-4-cyclopropyl[1,1′-biphenyl]-3-yl)-5-hydroxy-2,2,6,6-tetramethyl-2H-pyran-3(6H)-one; 4-(4′-Chloro-4-ethyl-2′-fluoro[1,1′-biphenyl]-3-yl)-5-hydroxy-2,2,6,6-tetramethyl-2H-pyran-3(6H)-one; 4-(2′,4′-Dichloro-4-ethyl[1,1′-biphenyl]-3-yl)-2,2,6,6-tetramethyl-2H-pyran-3,5(4H,6H)-dione; 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one; 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one; 5-(Acetyloxy)-4-(2′,4′-dichloro-4-ethyl[1,1′-biphenyl]-3-yl)-3,6-dihydro-2,2,6,6-tetramethyl-2H-pyran-3-one; 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester; 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester; 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester;
b3) PS I photosynthesis inhibitors: diquat, diquat-dibromide, paraquat and paraquat-dichloride, paraquat dimetilsulfate;
b4) protoporphyrinogen-IX oxidase inhibitors: acifluorfen-sodium, bencarbazone, benzfendizone, butafenacil, carfentrazone-ethyl, cinidon-ethyl, ethoxyfen-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, N-ethyl-3-(2,6-dichloro-4-trifluoromethylphenoxy)-5-methyl-1H-pyrazole-1-carboxamide, N-tetrahydrofurfuryl-3-(2,6-dichloro-4-trifluoromethylphenoxy)-5-methyl-1H-pyrazole-1-carboxamide, N-ethyl-3-(2-chloro-6-fluoro-4-trifluoromethylphenoxy)-5-methyl-1H-pyrazole-1-carboxamide, N-tetrahydrofurfuryl-3-(2-chloro-6-fluoro-4-trifluoromethylphenoxy)-5-methyl-1H-pyrazole-1-carboxamide, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
b5) bleacher herbicides: aclonifen, beflubutamid, benzobicyclon, clomazone, diflufenican, flurochloridone, flurtamone, isoxaflutole, mesotrione, norflurazon, picolinafen, pyrasulfotole, pyrazolynate, sulcotrione, tefuryltrione, tembotrione, topramezone, bicyclopyrone, 4-(3-trifluoromethylphenoxy)-2-(4-trifluoromethylphenyl)pyrimidine, amitrole and flumeturon;
b6) EPSP synthase inhibitors: glyphosate, glyphosate-isopropylammonium, glyphosate-potassium and glyphosate-trimesium (sulfosate);
b7) glutamine synthase inhibitors: glufosinate, glufosinate-P, glufosinate-ammonium;
b8) DHP synthase inhibitors: asulam;
b11) cellulose biosynthesis inhibitors: dichlobenil, flupoxam, indaziflam, isoxaben, triaziflam and 1-cyclohexyl-5-pentafluorphenyloxy-1⁴-[1,2,4,6]thiatriazin-3-ylamine;
b12) decoupler herbicides: dinoseb;
b13) auxinic herbicides: 2,4-D and its salts and esters, aminocyclopyrachlor and its salts and esters, aminopyralid and its salts such as aminopyralid-tris(2-hydroxypropyl)ammonium and its esters, clopyralid and its salts and esters, dicamba and its salts and esters, dichlorprop-P and its salts and esters, fluroxypyr-meptyl, halauxifen and its salts and esters, MCPA and its salts and esters, MCPB and its salts and esters, mecoprop-P and its salts and esters, picloram and its salts and esters, quinclorac, quinmerac and triclopyr and its salts and esters;
b14) auxin transport inhibitors: diflufenzopyr and diflufenzopyr-sodium; and
b15) other herbicides: bromobutide, cinmethylin, cumyluron, cyclopyrimorate and its salts and esters, dalapon, difenzoquat, difenzoquat-metilsulfate, DSMA, dymron (=daimuron), flamprop, flamprop-isopropyl, flamprop-methyl, flamprop-M-isopropyl, flamprop-M-methyl, indanofan, metam, methylbromide, MSMA, oxaziclomefone, pelargonic acid and pyributicarb
including agriculturally acceptable salts and derivatives thereof.

18. The composition of claim 13, wherein the herbicide B is selected from the group consisting of
b1) lipid biosynthesis inhibitors: clethodim, clodinafop-propargyl, cycloxydim, pinoxaden and sethoxydim;
b3) PS I photosynthesis inhibitors: paraquat and paraquat-dichloride, paraquat dimetilsulfate;
b4) protoporphyrinogen-IX oxidase inhibitors: carfentrazone-ethyl, flumioxazin, lactofen, oxadiargyl, oxyfluorfen, saflufenacil, sulfentrazone and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione;
b5) bleacher herbicides: benzobicyclone, clomazone, diflufenican, isoxaflutole, mesotrione, norflurazon, picolinafen, sulcotrione, tembotrione, topramezone and bicyclopyrone;
b6) EPSP synthase inhibitors: glyphosate, glyphosate-isopropylammonium, glyphosate-potassium and glyphosate-trimesium (sulfosate);
b7) glutamine synthase inhibitors: glufosinate, glufosinate-P, glufosinate-ammonium;
b11) cellulose biosynthesis inhibitors: indaziflam and isoxaben;
b12) decoupler herbicides: dinoseb;
b13) auxinic herbicides: 2,4-D and its salts and esters, dicamba and its salts and esters, fluroxypyr-meptyl, MCPA and its salts and esters, quinclorac and quinmerac;
b14) auxin transport inhibitors: diflufenzopyr and diflufenzopyr-sodium; and
b15) other herbicides: dymron (=daimuron) and pelargonic acid including agriculturally acceptable salts and derivatives thereof.

19. The composition of claim 13, comprising at least two herbicides B, wherein the first herbicide B is selected from herbicides of groups b1), b3), b4), b5), b8), b11), b12, b13), b14 and b15) and the second herbicide B is selected from herbicides of groups b6) and b7).

20. The composition of claim 13, additionally comprising at least one further herbicide D, which is different from herbicides A and B.

21. The composition of claim 13, additionally comprising at least one safener C.

22. An agrochemical composition comprising a herbicidally active amount of the composition of claim 13 and at least one inert liquid and/or solid carrier and, if appropriate, at least one surface-active substance.

23. A process for the preparation of the agrochemical composition of claim 22, which comprises mixing a herbicidally active amount of the herbicidal composition and at least one inert liquid and/or solid carrier and, if appropriate, at least one surface-active substance.

24. A method for controlling unwanted vegetation, which comprises allowing a herbicidally active amount of the herbicidal composition of claim 13 to act on plants, their environment or on seed.

25. A method for controlling unwanted vegetation, which comprises allowing a herbicidally active amount of the agrochemical composition of claim 22 to act on plants, their environment or on seed.

26. The method of claim 24, wherein the composition comprises at least one compound of formula I selected from
a1) cornexistin (I.a1) 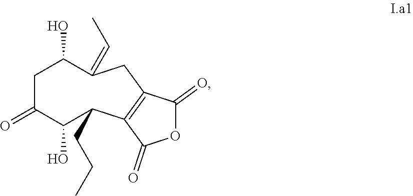 [SMILES: C/C=C1/CC2=C(C(=O)OC2=O)[C@H](CCC)[C@H](O)C(=O)C[C@@H]1O]
a2) the dibasic acid of cornexistin (I.a2) 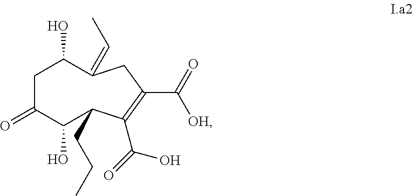 [SMILES: C/C=C1/C/C(C(=O)O)=C(/C(=O)O)[C@H](CCC)[C@H](O)C(=O)C[C@@H]1O]
a3) hydroxycornexistin (I.a3), 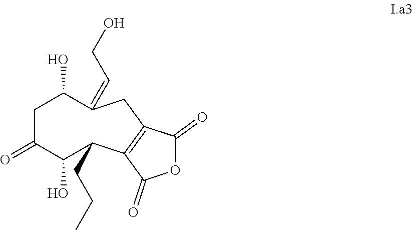 [SMILES: CCC[C@H]1C2=C(C/C(=C/CO)[C@@H](O)CC(=O)[C@H]1O)C(=O)OC2=O]
a4) the dibasic acid of hydroxycornexistin (I.a4), 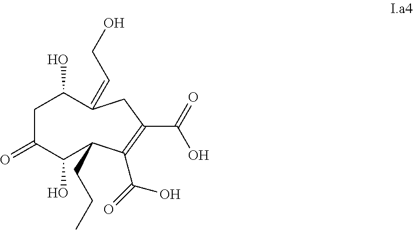 [SMILES: CCC[C@H]1/C(C(=O)O)=C(/C(=O)O)C/C(=C/CO)[C@@H](O)CC(=O)[C@H]1O]
or agriculturally acceptable salt or derivative thereof.

27. The method of claim 24, wherein the composition comprises as active ingredient A) at least two compounds of formula I selected from
a5) mixtures of cornexistin (I.a1) and the dibasic acid of cornexistin (I.a2),
a6) mixtures of hydroxycornexistin (I.a3) and the dibasic acid of hydroxycornexistin (I.a4),
a7) mixtures of cornexistin (I.a1) and hydroxycomexistin (I.a3),
a8) mixtures of cornexistin (I.a1) and the dibasic acid of hydroxycornexistin (I.a4),
a9) mixtures of the dibasic acid of cornexistin (I.a2) and hydroxycornexistin (I.a3) and
a10) mixtures of the dibasic acid of cornexistin (I.a2) and the dibasic acid of hydroxycornexistin (I.a4)
including agriculturally acceptable salts and derivatives thereof.

28. The method of claim 24, wherein the composition comprises a herbicide B selected from the group consisting of
b1) ACC lipid biosynthesis inhibitors: alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5);
b3) PS I photosynthesis inhibitors: diquat, diquat-dibromide, paraquat, paraquat-dichloride and paraquat-dimetilsulfate;
b4) protoporphyrinogen-IX oxidase inhibitors: acifluorfen, acifluorfen-sodium, azafenidin, bencarbazone, benzfendizone, bifenox, butafenacil, carfentrazone, carfentrazone-ethyl, chlomethoxyfen, cinidon-ethyl, ethoxyfen-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, N-ethyl-3-(2,6-dichloro-4-trifluoromethylphenoxy)-5-methyl-1H-pyrazole-1-carboxamide, N-tetrahydrofurfuryl-3-(2,6-dichloro-4-trifluoromethylphenoxy)-5-methyl-1H-pyrazole-1-carboxamide, N-ethyl-3-(2-chloro-6-fluoro-4-trifluoromethylphenoxy)-5-methyl-1H-pyrazole-1-carboxamide, N-tetrahydrofurfuryl-3-(2-chloro-6-fluoro-4-trifluoromethylphenoxy)-5-methyl-1H-pyrazole-1-carboxamide, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione and (Z)-4-[2-Chloro-5-(4-chloro-5-difluoromethoxy-1-methyl-1H-pyrazol-3-yl)-4-fluoro-phenoxy]-3-methyl-but-2-enoic acid methyl ester;
b5) bleacher herbicides: PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine, HPPD inhibitors: benzobicyclon, benzofenap, clomazone, isoxaflutole, mesotrione, pyrasulfotole, pyrazolynate, pyrazoxyfen, sulcotrione, tefuryltrione, tembotrione, topramezone and bicyclopyrone, bleacher, unknown target: aclonifen, amitrole and flumeturon;
b6) EPSP synthase inhibitors: glyphosate, glyphosate-isopropylammonium, glyposate-potassium and glyphosate-trimesium (sulfosate);
b7) glutamine synthase inhibitors: bilanaphos (bialaphos), bilanaphos-sodium, glufosinate, glufosinate-P and glufosinate-ammonium;
b8) DHP synthase inhibitors: asulam;
b11) cellulose biosynthesis inhibitors: chlorthiamid, dichlobenil, flupoxam, indaziflam, isoxaben, triaziflam, triazolocarboxamide and 1-cyclohexyl-5-pentafluorphenyloxy-1⁴-[1,2,4,6]thiatriazin-3-ylamine;
b12) decoupler herbicides: dinoseb, dinoterb and DNOC and its salts;
b13) auxinic herbicides: 2,4-D and its salts and esters such as clacyfos, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluroxypyr, fluroxypyr-butometyl, fluroxypyr-meptyl, halauxifen and its salts and esters; MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters and triclopyr and its salts and esters;
b14) auxin transport inhibitors: diflufenzopyr, diflufenzopyr-sodium, naptalam and naptalam-sodium; and
b15) other herbicides: bromobutide, chlorflurenol, chlorflurenol-methyl, cinmethylin, cumyluron, cyclopyrimorate (CAS 499223-49-3 Mitsui; SW-065; H-965) and its salts and esters, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine and 6-Chloro-3-(2-cyclopropyl-6-methylphenoxy)-pyrazin-2-ol
including agriculturally acceptable salts and derivatives thereof.

29. The method of claim 24, wherein the composition comprises herbicide B selected from the group consisting of b1) lipid biosynthesis inhibitors: clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one; 4-(2′,4′-Dichloro-4-cyclopropyl[1,1′-biphenyl]-3-yl)-5-hydroxy-2,2,6,6-tetramethyl-2H-pyran-3(6H)-one; 4-(4′-Chloro-4-ethyl-2′-fluoro[1,1′-biphenyl]-3-yl)-5-hydroxy-2,2,6,6-tetramethyl-2H-pyran-3(6H)-one; 4-(2′,4′-Dichloro-4-ethyl[1,1′-biphenyl]-3-yl)-2,2,6,6-tetramethyl-2H-pyran-3,5(4H,6H)-dione; 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one; 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one; 5-(Acetyloxy)-4-(2′,4′-dichloro-4-ethyl[1,1′-biphenyl]-3-yl)-3,6-dihydro-2,2,6,6-tetramethyl-2H-pyran-3-one; 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester; 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester; 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester;
b3) PS I photosynthesis inhibitors: diquat, diquat-dibromide, paraquat and paraquat-dichloride, paraquat dimetilsulfate;
b4) protoporphyrinogen-IX oxidase inhibitors: acifluorfen-sodium, bencarbazone, benzfendizone, butafenacil, carfentrazone-ethyl, cinidon-ethyl, ethoxyfen-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, N-ethyl-3-(2,6-dichloro-4-trifluoromethylphenoxy)-5-methyl-1H-pyrazole-1-carboxamide, N-tetrahydrofurfuryl-3-(2,6-dichloro-4-trifluoromethylphenoxy)-5-methyl-1H-pyrazole-1-carboxamide, N-ethyl-3-(2-chloro-6-fluoro-4-trifluoromethylphenoxy)-5-methyl-1H-pyrazole-1-carboxamide, N-tetrahydrofurfuryl-3-(2-chloro-6-fluoro-4-trifluoromethylphenoxy)-5-methyl-1H-pyrazole-1-carboxamide, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione;
b5) bleacher herbicides: aclonifen, beflubutamid, benzobicyclon, clomazone, diflufenican, flurochloridone, flurtamone, isoxaflutole, mesotrione, norflurazon, picolinafen, pyrasulfotole, pyrazolynate, sulcotrione, tefuryltrione, tembotrione, topramezone, bicyclopyrone, 4-(3-trifluoromethylphenoxy)-2-(4-trifluoromethylphenyl)pyrimidine, amitrole and flumeturon;
b6) EPSP synthase inhibitors: glyphosate, glyphosate-isopropylammonium, glyphosate-potassium and glyphosate-trimesium (sulfosate);
b7) glutamine synthase inhibitors: glufosinate, glufosinate-P, glufosinate-ammonium;
b8) DHP synthase inhibitors: asulam;
b11) cellulose biosynthesis inhibitors: dichlobenil, flupoxam, indaziflam, isoxaben, triaziflam and 1-cyclohexyl-5-pentafluorphenyloxy-1⁴-[1,2,4,6]thiatriazin-3-ylamine;
b12) decoupler herbicides: dinoseb;
b13) auxinic herbicides: 2,4-D and its salts and esters, aminocyclopyrachlor and its salts and esters, aminopyralid and its salts such as aminopyralid-tris(2-hydroxypropyl)ammonium and its esters, clopyralid and its salts and esters, dicamba and its salts and esters, dichlorprop-P and its salts and esters, fluroxypyr-meptyl, halauxifen and its salts and esters, MCPA and its salts and esters, MCPB and its salts and esters, mecoprop-P and its salts and esters, picloram and its salts and esters, quinclorac, quinmerac and triclopyr and its salts and esters;
b14) auxin transport inhibitors: diflufenzopyr and diflufenzopyr-sodium; and
b15) other herbicides: bromobutide, cinmethylin, cumyluron, cyclopyrimorate and its salts and esters, dalapon, difenzoquat, difenzoquat-metilsulfate, DSMA, dymron (=daimuron), flamprop, flamprop-isopropyl, flamprop-methyl, flamprop-M-isopropyl, flamprop-M-methyl, indanofan, metam, methylbromide, MSMA, oxaziclomefone, pelargonic acid and pyributicarb
including agriculturally acceptable salts and derivatives thereof.

30. The method of claim 24, wherein the composition comprises herbicide B selected from the group consisting of
b1) lipid biosynthesis inhibitors: clethodim, clodinafop-propargyl, cycloxydim, pinoxaden and sethoxydim;
b3) PS I photosynthesis inhibitors: paraquat and paraquat-dichloride, paraquat dimetilsulfate;
b4) protoporphyrinogen-IX oxidase inhibitors: carfentrazone-ethyl, flumioxazin, lactofen, oxadiargyl, oxyfluorfen, saflufenacil, sulfentrazone and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione;
b5) bleacher herbicides: benzobicyclone, clomazone, diflufenican, isoxaflutole, mesotrione, norflurazon, picolinafen, sulcotrione, tembotrione, topramezone and bicyclopyrone;
b6) EPSP synthase inhibitors: glyphosate, glyphosate-isopropylammonium, glyphosate-potassium and glyphosate-trimesium (sulfosate);
b7) glutamine synthase inhibitors: glufosinate, glufosinate-P, glufosinate-ammonium;
b11) cellulose biosynthesis inhibitors: indaziflam and isoxaben;
b12) decoupler herbicides: dinoseb;
b13) auxinic herbicides: 2,4-D and its salts and esters, dicamba and its salts and esters, fluroxypyr-meptyl, MCPA and its salts and esters, quinclorac and quinmerac;
b14) auxin transport inhibitors: diflufenzopyr and diflufenzopyr-sodium; and
b15) other herbicides: dymron (=daimuron) and pelargonic acid
including agriculturally acceptable salts and derivatives thereof.

31. The method of claim 24, wherein the composition comprises at least two herbicides B, wherein the first herbicide B is selected from herbicides of groups b1), b3), b4), b5), b8), b11), b12, b13), b14 and b15) and the second herbicide B is selected from herbicides of groups b6) and b7).

32. The method of claim 24, wherein the composition additionally comprises at least one further herbicide D, which is different from herbicides A and B.

33. The method of claim 24, wherein the composition additionally comprising at least one safener C.
